(19) United States
(12) Patent Application Publication
(10) Pub. No.: US 2024/0397526 A1
(43) Pub. Date: Nov. 28, 2024

(54) DATA TRANSMITTING METHOD, DATA RECEIVING METHOD AND APPARATUS

(71) Applicant: FUJITSU LIMITED, Kawasaki-shi Kanagawa (JP)

(72) Inventors: Qinyan JIANG, Beijing (CN); Lei ZHANG, Beijing (CN)

(73) Assignee: FUJITSU LIMITED, Kawasaki-shi Kanagawa (JP)

(21) Appl. No.: 18/795,139

(22) Filed: Aug. 5, 2024

Related U.S. Application Data
(63) Continuation of application No. PCT/CN2022/075936, filed on Feb. 10, 2022.

(51) Int. Cl. H04W 72/232; H04L 1/1812; H04W 72/11

(52) U.S. Cl. CPC H04W 72/232; H04L 1/1812; H04W 72/11

(57) ABSTRACT

A data receiving and transmitting apparatus, configured in a terminal equipment, includes: a first receiver configured to receive first downlink control information and/or third downlink control information, the first downlink control information being used to schedule PDSCHs (Physical downlink shared channel), the third downlink control information being used to schedule PUSCH (Physical uplink shared channel) s; and a second receiver configured to receive one or more than one PDSCH in the PDSCHs scheduled by the first downlink control information, and/or, a transmitter configured to transmit one or more than one PUSCH in the PUSCHs scheduled by the third downlink control information, and a third receiver configured to receive a PDSCH configuration including a first configuration parameter used for configuring the number of repetitions and/or a SPS (Semi-persistent scheduling) configuration including a second configuration parameter used for configuring the number of repetitions.

### CROSS-REFERENCE TO RELATED APPLICATION

This application is a continuation application of International Application PCT/CN2022/075936 filed on Feb. 10, 2022, and designated the U.S., the entire contents of which are incorporated herein by reference.

### FIELD

The embodiments of the present disclosure relate to the field of communications.

### BACKGROUND

A Physical Downlink Shared Channel (PDSCH) is one of physical downlink channels in wireless communication systems, and is used to carry downlink data. A Physical Uplink Shared Channel (PUSCH) is one of physical uplink channels in wireless communication systems, and is used to carry uplink data.

The PDSCH and the PUSCH may be scheduled via downlink control information (DCI). The DCI used to schedule the PDSCH or PUSCH at least includes an information field (or field) for indicating a resource of the PDSCH. In a current new radio (NR) system, a plurality of DCI formats used to schedule the PDSCH or PUSCH are defined, such as DCI format 1_0 (for scheduling the PDSCH), DCI format 0_0 (for scheduling the PUSCH), DCI format 1_1 (for scheduling the PDSCH), DCI format 0_1 (for scheduling the PUSCH), DCI format 1_2 (for scheduling the PDSCH), and DCI format 0_2 (for scheduling the PUSCH), etc., which are not limited to these. Specific information and/or size included in DCI with different DCI formats is/are different to meet different scheduling demands.

The PDSCH and PUSCH may further be semi-statically configured (or semi-statically scheduled) or semi-persistently scheduled. In the NR, the semi-statically configured or semi-persistently scheduled PDSCH e.g. is called an SPS PDSCH. The semi-statically configured or semi-persistently scheduled PUSCH e.g. is called a CG PUSCH. In some cases, after a network device provides SPS or CG configuration via RRC signaling, the SPS or CG configuration needs to be activated via DCI, then a terminal equipment may receive the SPS PDSCH or transmit the CG PUSCH accordingly.

It should be noted that the above introduction to the technical background is just to facilitate a clear and complete description of the technical solutions of the present disclosure, and is elaborated to facilitate the understanding of persons skilled in the art. It cannot be considered that the above technical solutions are known by persons skilled in the art just because these solutions are elaborated in the Background of the present disclosure.

### SUMMARY

The inventor finds that the technique of scheduling more than one PDSCH/PUSCH via one DCI is still under discussion. Moreover, the related art assumes that one DCI can only schedule one PDSCH/PUSCH, thereby to support semi-static scheduling or semi-persistent scheduling of the PDSCH or PUSCH and support dynamic retransmission for data corresponding to the semi-static scheduling or semi-persistent scheduling, based on such DCI, thus, how to support semi-static scheduling or semi-persistent scheduling of the PDSCH or PUSCH and dynamic retransmission for data corresponding to the semi-statically scheduling or semi-persistently scheduling in a case where one DCI (or DCI format) may schedule more than one PDSCH/PUSCH is not taken into account.

For the above problem, embodiments of the present disclosure provide a data transmitting method, a data receiving method and apparatus, to support scheduling of more than one PDSCH/PUSCH via one DCI, further, semi-static scheduling or semi-persistent scheduling of the PDSCH or PUSCH in a case where one DCI (or DCI format) may schedule more than one PDSCH/PUSCH, and support dynamic retransmission for data corresponding to the semi-statically scheduling or semi-persistently scheduling.

According to an aspect of the embodiments of the present disclosure, a data receiving apparatus is provided, configured in a terminal equipment, the apparatus includes:
a first receiving unit configured to receive first downlink control information, the first downlink control information being used to schedule PDSCHs; and
a second receiving unit configured to receive one or more than one PDSCH in the PDSCHs scheduled by the first downlink control information.

According to another aspect of the embodiments of the present disclosure, a data receiving apparatus is provided, configured in a terminal equipment, the apparatus further includes:
a first receiving unit configured to receive PDSCH configuration including a first configuration parameter used for configuring the number of repetitions; and
a second receiving unit configured to receive second downlink control information used for activating SPS configuration,
the first configuration parameter being applied to the second downlink control information, and one or more than one row in a TDRA table to which the second downlink control information corresponds including more than one SLIV.

According to a further aspect of the embodiments of the present disclosure, a data transmitting apparatus is provided, configured in a terminal equipment, the apparatus includes:
a first receiving unit configured to receive third downlink control information, the third downlink control information being used to schedule PUSCHs; and
a transmitting unit configured to transmit one or more than one PUSCH in the PUSCHs scheduled by the third downlink control information.

One of advantageous effects of the embodiments of the present disclosure lies in: according to the embodiments of the present disclosure, scheduling of more than one PDSCH/PUSCH via one DCI can be supported, further, semi-static scheduling or semi-persistent scheduling of the PDSCH or PUSCH in a case where one DCI (or DCI format) may schedule more than one PDSCH/PUSCH can be supported, and dynamic retransmission for data corresponding to the semi-static scheduling or semi-persistent scheduling is supported. Further, in a case where one DCI format (such as DCI format 1_1 or DCI format 0_1) is configured to be capable of scheduling more than one PDSCH or PUSCH, such DCI format may be used to activate/deactivate SPS or CG configuration, or such DCI format may be used to schedule dynamic retransmission for data corresponding to the semi-statically scheduling or semi-persistently scheduling. That is, this DCI format may be used to support semi-static scheduling or semi-persistent scheduling, and also support dynamic scheduling of the PDSCH or PUSCH. Thus, in a case where SPS or CG is configured and said DCI format is configured to be capable of scheduling more than one PDSCH or PUSCH, for uplink or downlink, a UE only needs to blindly check this DCI format and has no need to blindly check another DCI format for supporting semi-static scheduling or semi-persistent scheduling of the PDSCH or PUSCH and/or dynamic retransmission for data corresponding semi-statically scheduling or semi-persistently scheduling, other than this DCI format. Thereby, the complexity for the UE to detect and receive a PDCCH can be reduced, and power consumption is reduced. On the other hand, for a network device, the flexibility of configuration and resource scheduling may also be improved.

Referring to the later description and drawings, specific implementations of the present disclosure are disclosed in detail, indicating a manner that the principle of the present disclosure can be adopted. It should be understood that the implementations of the present disclosure are not limited in terms of the scope. Within the scope of the terms of the appended claims, the implementations of the present disclosure include many changes, modifications and equivalents.

Features that are described and/or shown with respect to one implementation can be used in the same way or in a similar way in one or more other implementations, can be combined with or replace features in the other implementations.

It should be emphasized that the term “comprise/include” when being used herein refers to the presence of a feature, a whole piece, a step or a component, but does not exclude the presence or addition of one or more other features, whole pieces, steps or components.

### BRIEF DESCRIPTION OF DRAWINGS

An element and a feature described in a drawing or an implementation of the present embodiments of the present disclosure can be combined with an element and a feature shown in one or more other drawings or implementations. In addition, in the drawings, similar labels represent corresponding components in several drawings and may be used to indicate corresponding components used in more than one implementation.

FIG. 1 is a schematic diagram of a communication system in the embodiments of the present disclosure;

FIG. 2 is a schematic diagram of a data receiving method in the embodiments of the present disclosure;

FIG. 3 is a schematic diagram of a data scheduling method in the embodiments of the present disclosure;

FIG. 4 is a schematic diagram of a data transmitting method in the embodiments of the present disclosure;

FIG. 5 is a schematic diagram of a data scheduling method in the embodiments of the present disclosure;

FIG. 6 is a schematic diagram of a data receiving apparatus in the embodiments of the present disclosure;

FIG. 7 is another schematic diagram of a data receiving apparatus in the embodiments of the present disclosure;

FIG. 8 is a further schematic diagram of a data receiving apparatus in the embodiments of the present disclosure;

FIG. 9 is a schematic diagram of a data scheduling apparatus in the embodiments of the present disclosure;

FIG. 10 is another schematic diagram of a data scheduling apparatus in the embodiments of the present disclosure;

FIG. 11 is a further schematic diagram of a data scheduling apparatus in the embodiments of the present disclosure;

FIG. 12 is a schematic diagram of a data transmitting apparatus in the embodiments of the present disclosure;

FIG. 13 is a schematic diagram of a data scheduling apparatus in the embodiments of the present disclosure;

FIG. 14 is another schematic diagram of a data scheduling apparatus in the embodiments of the present disclosure;

FIG. 15 is another schematic diagram of a data scheduling apparatus in the embodiments of the present disclosure;

FIG. 16 is a further schematic diagram of a data scheduling apparatus in the embodiments of the present disclosure;

FIG. 17 is another schematic diagram of a data scheduling apparatus in the embodiments of the present disclosure;

FIG. 18 is a schematic diagram of a terminal equipment in the embodiments of the present disclosure;

FIG. 19 is a schematic diagram of composition of a network device in the embodiments of the present disclosure;

FIG. 20 is a schematic diagram of a slot structure;

FIG. 21 is a schematic diagram of a frame structure;

FIG. 22 is a schematic diagram of a time domain resource where a PDCCH/DCI for activating an SPS is located and a time domain resource of a PDSCH indicated by a PDCCH/DCI for activating an SPS;

FIG. 23 is a schematic diagram of a time domain resource where DCI format 1_1 for activating an SPS is located and a PDSCH activated by the DCI;

FIG. 24 is a schematic diagram of DCI format 1_1 for scheduling retransmission for an SPS and a PDSCH scheduled by the DCI;

FIG. 25 is a schematic diagram of a slot where DCI format 1_1 for activating an SPS is located, a slot where an SPS PDSCH activated by DCI format 1_1 is located, and a corresponding HARQ process ID;

FIG. 26 is another schematic diagram of a HARQ process ID corresponding to an SPS PDSCH;

FIG. 27 is a schematic diagram of a time domain resource where a PDCCH/DCI for activating a CG is located and a time domain resource of a PUSCH indicated by a PDCCH/DCI for activating a CG;

FIG. 28 is a schematic diagram of a time domain resource where DCI format 1_1 for activating a CG is located and a PUSCH activated by the DCI;

FIG. 29 is a schematic diagram of DCI format 1_1 for scheduling retransmission for a CG and a PUSCH scheduled by the DCI;

FIG. 30 is a schematic diagram of a slot where DCI format 1_1 for activating a CG is located, a slot where a CG PUSCH activated by DCI format 1_1 is located, and a corresponding HARQ process ID;

FIG. 31 is another schematic diagram of a HARQ process ID corresponding to a CG PUSCH.

### DETAILED DESCRIPTION

Referring to the drawings, through the following Specification, the aforementioned and other features of the present disclosure will become obvious. The Specification and the drawings specifically disclose particular implementations of the present disclosure, showing partial implementations which can adopt the principle of the present disclosure. It should be understood that the present disclosure is not limited to the described implementations, on the contrary, the present disclosure includes all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

In the embodiments of the present disclosure, the term “a communication network” or “a wireless communication network” may refer to a network that meets any of the following communication standards, such as Long Term Evolution (LTE), LTE-Advanced (LTE-A), Wideband Code Division Multiple Access (WCDMA), High-Speed Packet Access (HSPA) and so on.

And, communication between devices in a communication system can be carried out according to a communication protocol at any stage, for example may include but be not limited to the following communication protocols: 1G (generation), 2G, 2.5G, 2.75G, 3G, 4G, 4.5G, 5G, New Radio (NR) and so on, and/or other communication protocols that are currently known or will be developed in the future.

In the embodiments of the present disclosure, the term “a network device” refers to, for example, a device that accesses a terminal equipment in a communication system to a communication network and provides services to the terminal equipment. The network device may include but be not limited to the following devices: a Base Station (BS), an Access Point (AP), a Transmission Reception Point (TRP), a broadcast transmitter, a Mobile Management Entity (MME), a gateway, a server, a Radio Network Controller (RNC), a Base Station Controller (BSC) and so on.

The base station may include but be not limited to: node B (NodeB or NB), evolution node B (eNodeB or eNB) and a 5G base station (gNB), etc., and may further includes Remote Radio Head (RRH), Remote Radio Unit (RRU), a relay or a low power node (such as femeto, pico, etc.), Integrated Access and Backhaul (IAB) node or IAB-DU or IAB-donor. And the term “base station” may include their some or all functions, each base station may provide communication coverage to a specific geographic region. The term “a cell” may refer to a base station and/or its coverage area, which depends on the context in which this term is used. Where there is no confusion, the terms “cell” and “base station” are interchangeable.

In the embodiments of the present disclosure, the term “User Equipment (UE)” or “Terminal Equipment (TE) or Terminal Device” refers to, for example, a device that accesses a communication network and receives network services through a network device. The terminal equipment can be fixed or mobile, and can also be referred to as Mobile Station (MS), a terminal, Subscriber Station (SS), Access Terminal (AT), IAB-MT, a station and so on.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera and so on.

For another example, under a scenario such as Internet of Things (IoT), the terminal equipment may also be a machine or apparatus for monitoring or measurement, for example may include but be not limited to: a Machine Type Communication (MTC) terminal, a vehicle-mounted communication terminal, a Device to Device (D2D) terminal, a Machine to Machine (M2M) terminal and so on.

Moreover, the term “a network side” or “a network device side” refers to a side of a network, may be a base station, and may include one or more network devices as described above. The term “a user side” or “a terminal side” or “a terminal equipment side” refers to a side of a user or terminal, may be a UE, and may include one or more terminal equipment as described above. If it is not specifically mentioned herein, “a device” may refer to a network device, or may refer to a terminal equipment.

In the following description, without causing confusion, the terms “uplink control signal” and “Uplink Control Information (UCI)” or “Physical Uplink Control Channel (PUCCH)” may be interchangeable, the terms “uplink data signal” and “uplink data information” or “Physical Uplink Shared Channel (PUSCH)” may be interchangeable; the terms “downlink control signal” and “Downlink Control Information (DCI)” or “Physical Downlink Control Channel (PDCCH)” may be interchangeable, the terms “downlink data signal” and “downlink data information” or “Physical Downlink Shared Channel (PDSCH)” may be interchangeable.

Moreover, transmitting or receiving a PUSCH may be understood as transmitting or receiving uplink data carried by a PUSCH, transmitting or receiving a PUCCH may be understood as transmitting or receiving uplink information (such as UCI) carried by a PUCCH, transmitting or receiving a PDSCH may be understood as transmitting or receiving downlink data carried by a PDSCH, transmitting or receiving a PDCCH may be understood as transmitting or receiving downlink information (such as DCI) carried by a PDCCH.

In the embodiments of the present disclosure, high layer signaling may be e.g. radio resource control (RRC) signaling; the RRC signaling includes, for example, an RRC message, for example includes a master information block (MIB), system information, and a dedicated RRC message; or an RRC information element (RRC IE); or an information field (or an information field included in the information field) included in an RRC message or an RRC information element. The high layer signaling, for example, may further be Medium Access Control (MAC) signaling; or called a MAC control element (MAC CE). However, the present disclosure is not limited to this.

The scenarios of the embodiments of the present disclosure are described through the following examples, however the present disclosure is not limited to these.

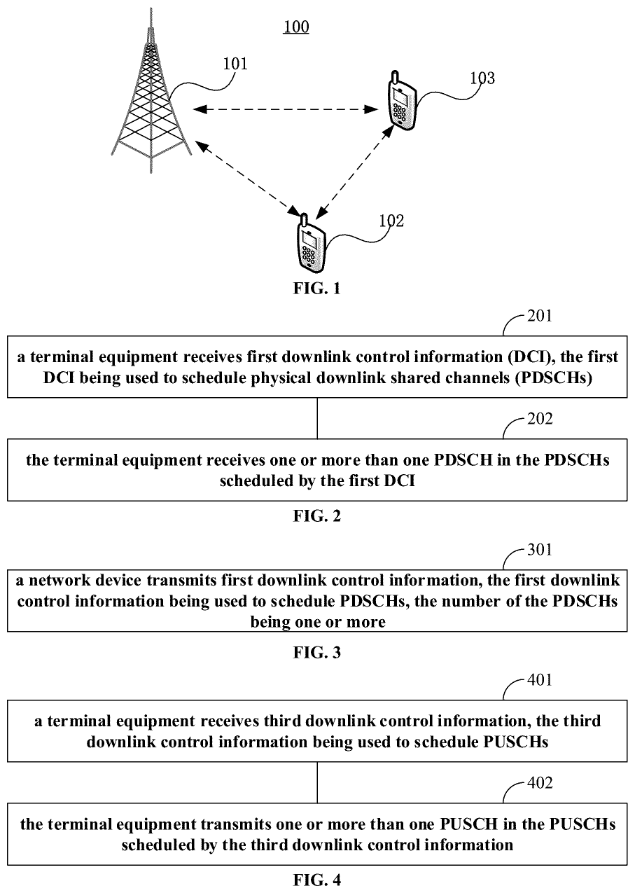

FIG. 1 is a schematic diagram of a communication system in the embodiments of the present disclosure, schematically describes situations by taking a terminal equipment and a network device as examples, as shown in FIG. 1, a communication system 100 may include a network device 101 and terminal equipments 102, 103. For simplicity, FIG. 1 only takes two terminal equipments and one network device as examples for description, however the embodiments of the present disclosure are not limited to this.

In the embodiments of the present disclosure, transmission of existing or further implementable services can be carried out between the network device 101 and the terminal equipments 102, 103. For example, these services may include but be not limited to: enhanced Mobile Broadband (eMBB), massive Machine Type Communication (mMTC), Ultra-Reliable, Low-Latency Communication (URLLC) and relevant communication of a terminal equipment with reduced capacities, etc.

It is worth noting that FIG. 1 shows that two terminal equipments 102 and 103 are within the coverage of network device 101, but the present disclosure is not limited to this. The two terminal equipments 102 and 103 may be outside the coverage of the network device 101, or one terminal equipment 102 may be within the coverage of the network device 101 and the other terminal equipment 103 may be outside the coverage of the network device 101.

In a related art, SPS and CG may support aggregation/repetition. For an SPS PDSCH, if SPS configuration (sps-Config) includes pdsch-AggregationFactor, repetition is performed according to the number of times configured by pdsch-AggregationFactor; if the SPS configuration (sps-Config) does not include pdsch-AggregationFactor, but PDSCH configuration (pdsch-Config) includes pdsch-AggregationFactor, repetition is performed according to the number of times configured by pdsch-AggregationFactor in the PDSCH configuration. For a CG PUSCH, if TDRA (Time Domain Resource Assignment) configuration indicated by DCI for activating the CG PUSCH includes memberOfRepetitions, repetition is performed according to the number of times configured by memberOfRepetitions. if the TDRA configuration indicated by DCI for activating the CG does not include memberOfRepetitions (including a case in which there is no need to activate DCI), but CG configuration (ConfiguredGrantConfig) includes repK, repetition is performed according to the number of times configured by repK.

On the other hand, retransmission of the SPS and CG may also support aggregation/repetition. The retransmission is scheduled via DCI. CRC of the DCI is scrambled by a CS-RNTI, and NDI=1. For retransmission of the SPS, if the PDSCH configuration (pdsch-Config) includes pdsch-AggregationFactor, repetition is performed according to the number of times configured by pdsch-AggregationFactor in the PDSCH configuration. For retransmission of the CG, if the TDRA configuration indicated by DCI includes memberOfRepetitions, repetition is performed according to the number of times configured by numberOfRepetitions; if the TDRA configuration indicated by DCI does not include numberOfRepetitions, but PUSCH configuration (pusch-Config) includes pusch-AggregationFactor, repetition is performed according to the number of times configured by pusch-AggregationFactor.

However, the above related art assumes that one DCI may only schedule one PDSCH/PUSCH, and a case where one DCI can schedule more than one PDSCH/PUSCH is not taken into account.

On the other hand, in Rel-17 (version 17), according to the current discussion, in order to support scheduling of multiple PDSCHs via one DCI, a TDRA table may be configured for DCI format 1_1, one or more rows in the TDRA table include(s) multiple SLIVs respectively, SLIVs correspond to the PDSCHs one by one. In this way, multiple PDSCHs may be scheduled by indicating a row including multiple SLIVs via DCI format 1_1. In this case, if PDSCH configuration (pdsch-Config) includes pdsch-AggregationFactor, this pdsch-AggregationFactor is not used for DCI format 1_1.

Similarly, in order to support scheduling of multiple PUSCHs via one DCI, a TDRA table may be configured for DCI format 0_1, one or more rows of the TDRA table include(s) multiple SLIVs respectively, SLIVs correspond to the PUSCHs one by one. In this way, multiple PUSCHs may be scheduled by indicating a row including multiple SLIVs via DCI format 0_1. In this case, if PUSCH configuration (pusch-Config) includes pdsch-AggregationFactor, this pdsch-AggregationFactor is not used for DCI format 1_1.

However, in the above discussion, there is no case where DCI format 1_1 and DCI format 0_1 may be used for activation and retransmission of an SPS and activation and retransmission of a CG, respectively. According to the above related art and discussion, whether to support aggregation/repetition for an SPS PDSCH activated by DCI format 1_1 and DCI format 0_1 (or a PDSCH corresponding to an activated SPS) cannot be determined.

The inventor finds that in a case where DCI format 1_1 and DCI format 0_1 are configured with the TDRA table, on one hand, at present, there is no method in which DCI format 1_1 and DCI format 0_1 are used for retransmission of an SPS and retransmission of a CG respectively; on the other hand, assuming that DCI format 1_1 and DCI format 0_1 are used for activation and retransmission of the SPS and activation and retransmission of the CG respectively, according to the above related art and discussion, whether/how to support aggregation/repetition for an SPS PDSCH activated by DCI format 1_1 and DCI format 0_1 (or a PDSCH corresponding to an activated SPS) or data retransmission (carried by a dynamically scheduled PDSCH and PUSCH respectively) of a corresponding SPS or CG scheduled by DCI format 1_1 and DCI format 0_1 cannot be determined. That is, under the assumption, currently, there is no deterministic solution on whether/how to support aggregation/repetition, a terminal equipment will not be able to determine whether an aggregation/repetition method has been adopted, thus may not receive or transmit data correctly.

For the above problems, the present disclosure is proposed.

In the embodiments of the present disclosure, DCI needs to indicate a time domain resource of a PDSCH/PUSCH when scheduling the PDSCH/PUSCH or when activating SPS/CG. Generally, the DCI includes an information field for indicating time domain resources of a PDSCH/PUSCH, the information field indicates time domain resources of the PDSCH/PUSCH based on an applied (or corresponding) time domain resource assignment (TDRA) table (or called a PDSCH/PUSCH TDRA table, or simply referred to as a TDRA table). The information field is, for example, a time domain resource assignment field. Specifically, the information field may indicate an index of a time-domain resource assignment configuration (or simply referred to as a TDRA configuration) in a TDRA table. For example, if the above TDRA table is a TDRA table applied by the DCI, this information field indicates time domain resources of a PDSCH by indicating an index (a row index, for example, a value of the row index is greater than or equal to 1) of a TDRA configuration in the TDRA table applied by the DCI, in other words, the DCI schedules the PDSCH by indicating the TDRA configuration applied by it in the TDRA table. For example, the value m (assuming that m is an integer greater than or equal to 0) of an information field in the DCI corresponds to indicating a TDRA configuration with an index being m+1 (that is, row m+1) in the TDRA table applied by the DCI. The time domain resource assignment table is predefined, or is configured via RRC signaling. In a case where the TDRA table is configured via RRC signaling, for example, an index value of the m+1th TDRA configuration configured via RRC signaling, is m+1, that is, when a value of the information field is m, it corresponds to the m+1th TDRA configuration configured via RRC signaling.

In the embodiments of the present disclosure, the time domain resource assignment table includes at least one row. In the following text, for ease of description, a row is called a TDRA configuration, that is, the TDRA table includes at least one TDRA configuration. One TDRA configuration includes at least one time domain resource configuration (or called a PDSCH/PUSCH time domain resource configuration), which at least includes a configuration of position of symbol in a slot (starting symbol+length); moreover, one PDSCH/PUSCH TDRA configuration may further include at least one slot offset (for example, called K0) configuration, K0 represents a slot offset between a PDSCH/PUSCH and a PDCCH/PUCCH, and the K0 configuration is included or not included in the PDSCH/PUSCH time domain resource configuration; the one TDRA configuration may further include other information, and such other information is included or not included in the PDSCH/PUSCH time domain resource configuration, the embodiments of the present disclosure is not limited to this. Regarding the configuration of position of symbol in the slot, it includes, for example, a start and length indicator (SLIV), the SLIV corresponds to a valid combination of a starting symbol(S) and a length (L), or, for example, it corresponds to a starting symbol configuration and a length configuration, the starting symbol configuration and the length configuration are a valid combination.

In some embodiments, in order to support scheduling of multiple PDSCHs/PUSCHs via one DCI, configuring a time domain resource assignment table for scheduling multiple (i.e., more than one) PDSCHs/PUSCHs via one DCI is supported via new RRC signalling (such as pdsch-TimeDomainAllocationListForMultiPDSCH or pdsch-TimeDomainAllocationListForMultiPDSCH-r17 for a PDSCH; pusch-TimeDomainAllocationListForMultiPUSCH or pusch-TimeDomainAllocationListForMultiPUSCH-r17 for a PUSCH), the time domain resource assignment table includes at least one time domain resource assignment configuration for scheduling multiple (i.e., more than one) PDSCHs/PUSCHs, the time domain resource assignment configuration e.g. includes multiple SLIVs, each SLIV corresponds to one PDSCH/PUSCH respectively.

In some embodiments, the time domain resource assignment configuration includes one time domain offset K0 configuration, K0 represents a slot offset between a first PDSCH/PUSCH and a PDCCH/PUCCH carrying a DCI scheduling the PDSCH/PUSCH.

In some embodiments, the time domain resource assignment configuration includes multiple (that is, more than one) K0 configurations. For example, the configuration includes multiple KOs, each K0 corresponds to one PDSCH/PUSCH respectively, respectively representing a slot offset between a corresponding PDSCH/PUSCH and a PDCCH/PUCCH for scheduling the PDSCH/PUSCH. Optionally, the K0 may be included in a PDSCH/PUSCH time domain resource configuration, and corresponds to each SLIV one by one, thereby slot positions of multiple PDSCHs/PUSCHs can be determined successively.

In some embodiments, if one time domain resource assignment configuration is used to schedule multiple PDSCHs/PUSCHs in multiple consecutive slots, the configuration includes one time domain offset K0 configuration, K0 for example represents a slot offset between the first PDSCH/PUSCH and a PDCCH/PUCCH carrying a DCI scheduling the PDSCH/PUSCH. If one time domain resource assignment configuration is used to schedule multiple PDSCHs/PUSCHs in multiple discontinuous slots, the time domain resource assignment configuration includes multiple (that is, more than one) time domain offset K0 configurations. For example, the configuration includes multiple KOs, each K0 corresponds to one PDSCH/PUSCH respectively, respectively representing a slot offset between a corresponding PDSCH/PUSCH and a PDCCH/PUCCH for scheduling the PDSCH/PUSCH. Optionally, the K0 may be included in a PDSCH/PUSCH time domain resource configuration, and corresponds to each SLIV one by one, thereby slot positions of multiple PDSCHs/PUSCHs can be determined successively.

In some embodiments, for downlink, in a case where the TDRA table is configured, the TDRA table is applied to/corresponds to DCI format 1_1; for uplink, in a case where the TDRA table is configured, the TDRA table is applied to/corresponds to DCI format 0_1. The TDRA table is configured for downlink and uplink respectively.

In some embodiments, the terminal equipment determines a time domain resource assignment table applied by a DCI (or DCI with DL grant/assignment). The terminal equipment may further determine a time domain resource assignment table applied by a DCI according to a first list, a column of the first list corresponds to the aforementioned indication information (such as pdsch-TimeDomainAllocationListForMultiPDSCH or pdsch-TimeDomainAllocationListForMultiPDSCH-r17 for a PDSCH; pusch-TimeDomainAllocationListForMultiPUSCH or pusch-TimeDomainAllocationListForMultiPUSCH-r17 for a PUSCH) used for configuring a TDRA table for supporting scheduling of multiple PDSCHs/PUSCHs via one DCI. The indication information is for example included in PDSCH/PUSCH-Config. That is, the terminal equipment determines a PDSCH/PUSCH time domain resource assignment table applied by a DCI used for scheduling a PDSCH/PUSCH, from a PDSCH/PUSCH time domain resource assignment (TDRA) table that is predefined or configured via high layer signaling, according to the first list. Taking DCI being DCI format 1_0 and 1_1 as an example, Table 1 below is an example table for the first list.

TABLE 1
Applicable PDSCH Time Domain Resource Assignment for DCI format 1_0 and DCI format 1_1

| | | SS/PBCH | PDSCH- | | PDSCH-Config | |
|---|---|---|---|---|---|---|
| | | block and | ConfigCommon | PDSCH-Config | includes pdsch- | PDSCH time |
| | PDCCH | CORESET | includes pdsch- | includes pdsch- | TimeDomainAlloca- | domain resource |
| | search | multiplexing | TimeDomainAl- | TimeDomainAl- | tionListForMultiPDSCH- | allocation to |
| RNTI | space | pattern | locationList | locationList | r17 | apply |
| SI-RNTI | Type0 | 1 | — | — | — | Default A for |
| | common | | | | | normal CP |
| | | 2 | — | — | — | Default B |
| | | 3 | — | — | — | Default C |
| SI-RNTI | Type0A | 1 | No | — | — | Default A |
| | common | 2 | No | — | — | Default B |
| | | 3 | No | — | — | Default C |
| | | 1, 2, 3 | Yes | — | — | pdsch- |
| | | | | | | TimeDomainAl- |
| | | | | | | locationList |
| | | | | | | provided in |
| | | | | | | PDSCH- |
| | | | | | | ConfigCommon |
| RA-RNTI, | Type1 | 1, 2, 3 | No | — | — | Default A |
| MSGB- | common | 1, 2, 3 | Yes | — | — | pdsch- |
| RNTI, TC- | | | | | | TimeDomainAl- |
| RNTI | | | | | | locationList |
| | | | | | | provided in |
| | | | | | | PDSCH- |
| | | | | | | ConfigCommon |
| P-RNTI | Type2 | 1 | No | — | — | Default A |
| | common | 2 | No | — | — | Default B |
| | | 3 | No | — | — | Default C |
| | | 1, 2, 3 | Yes | — | — | pdsch- |
| | | | | | | TimeDomainAl- |
| | | | | | | locationList |
| | | | | | | provided in |
| | | | | | | PDSCH- |
| | | | | | | ConfigCommon |
| C-RNTI, | Any | 1, 2, 3 | No | — | — | Default A |
| MCS-C- | common | 1, 2, 3 | Yes | — | — | pdsch- |
| RNTI, CS- | search | | | | | TimeDomainAl- |
| RNTI | space | | | | | locationList |
| | associated | | | | | provided in |
| | with | | | | | PDSCH- |
| | CORESET 0 | | | | | ConfigCommon |
| C-RNTI, | Any | 1, 2, 3 | No | No | — | Default A |
| MCS-C- | common | 1, 2, 3 | Yes | No | — | pdsch- |
| RNTI, CS- | search | | | | | TimeDomainAl- |
| RNTI | space not | | | | | locationList |
| | associated | | | | | provided in |
| | with | | | | | PDSCH- |
| | CORESET 0 | | | | | ConfigCommon |
| | UE | 1, 2, 3 | No/Yes | Yes | — | pdsch- |
| | specific | | | | | TimeDomainAl- |
| | search | | | | | locationList |
| | space | | | | | provided in |
| | | | | | | PDSCH-Config |
| | | 1, 2, 3 | No/Yes | — | Yes | pdsch- |
| | | | | | | TimeDomainAlloca- |
| | | | | | | tionListForMultiPDSCH- |
| | | | | | | r17 provided in |
| | | | | | | PDSCH-Config |

In the embodiments of the present disclosure, DCI indicates multiple (i.e., more than one) PDSCHs/PUSCHs, which means that the DCI (or a second information field in the DCI) indicates a time domain resource assignment configuration used to schedule more than one PDSCH/PUSCH. As for the time domain resource assignment configuration, which has been described in the preceding text, and will not be repeated here.

In the embodiments of the present disclosure, DCI schedules multiple (i.e., more than one) PDSCHs/PUSCHs, which means that the DCI indicates multiple PDSCHs/PUSCHs, or means that multiple PDSCHs/PUSCHs indicated in the DCI include more than one valid PDSCH/PUSCH, or means that there is a PDSCH/PUSCH with a corresponding HARQ process (or HARQ process ID) in multiple PDSCHs/PUSCHs indicated in the DCI. A valid PDSCH and/or a PDSCH with a corresponding HARQ process, for example, refer to a PDSCH that does not overlap with a semi-statically configured uplink symbol and/or a dynamically configured uplink symbol and/or a semi-statically configured symbol where uplink transmission is located and/or a reserved symbol and/or an interval symbol. A valid PUSCH and/or a PUSCH with a corresponding HARQ process, for example, refer to a PUSCH that does not overlap with a semi-statically configured downlink symbol and/or a symbol corresponding to an SSB and/or a symbol corresponding to CORSET #0 and/or a dynamically configured downlink symbol and/or a semi-statically configured symbol where downlink transmission is located and/or a reserved symbol and/or an interval symbol. A valid PDSCH/PUSCH is the same or different from a PDSCH/PUSCH with a corresponding HARQ process. For different cases, for example, a valid PDSCH e.g. refers to a PDSCH that does not overlap with a semi-statically configured uplink symbol, a valid PUSCH e.g. refers to a PUSCH that does not overlap with a semi-statically configured downlink symbol and/or a symbol corresponding to an SSB and/or a symbol corresponding to CORSET #0, a PDSCH with a corresponding HARQ process e.g. refers to a PDSCH that does not overlap with a semi-statically configured uplink symbol and/or a dynamically configured uplink symbol, a PUSCH with a corresponding HARQ process e.g. refers to a PUSCH that does not overlap with a semi-statically configured downlink symbol and/or a symbol corresponding to an SSB and/or a symbol corresponding to CORSET #0 and/or a dynamically configured downlink symbol. In other words, if a PDSCH indicated in the DCI overlaps with a semi-statically configured uplink symbol and/or a dynamically configured uplink symbol and/or a semi-statically configured symbol where uplink transmission is located and/or a reserved symbol and/or an interval symbol, the PDSCH is an invalid PDSCH, and/or the PDSCH does not have a corresponding HARQ process (or HARQ process ID). For another example, if a PUSCH indicated in the DCI overlaps with a semi-statically configured downlink symbol and/or a symbol corresponding to an SSB and/or a symbol corresponding to CORSET #0 and/or a dynamically configured downlink symbol and/or a semi-statically configured symbol where downlink transmission is located and/or a reserved symbol and/or an interval symbol, the PUSCH is an invalid PUSCH, and/or the PUSCH does not have a corresponding HARQ process (or HARQ process ID).

For example, assuming that a valid PDSCH and/or a PDSCH with a corresponding HARQ process refer(s) to a PDSCH that does not overlap with a semi-statically configured uplink symbol, if one PDSCH overlaps with/conflicts with the semi-statically configured uplink symbol, the PDSCH does not have a corresponding HARQ process (or HARQ process ID). Generally, a base station will not transmit this PDSCH, and a UE will not receive this PDSCH. On the contrary, if the PDSCH does not overlap with or conflict with the semi-statically configured uplink symbol, the PDSCH has a corresponding HARQ process (or HARQ process ID).

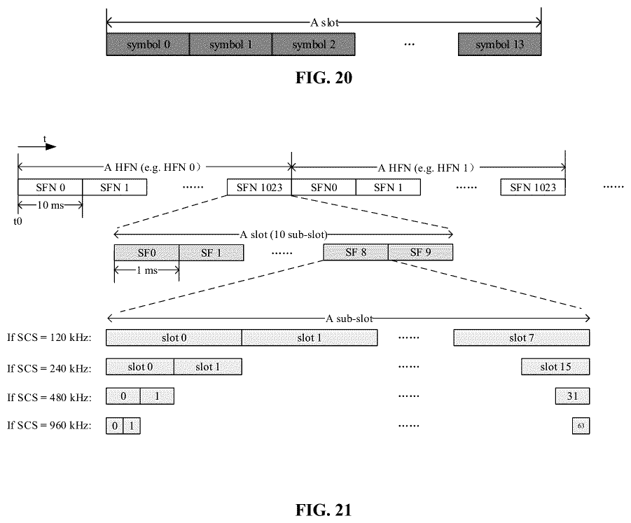

FIG. 20 is a schematic diagram of a slot structure, assuming that one slot includes 14 symbols. FIG. 21 is a schematic diagram of a frame structure, assuming that one frame includes 10 subframes, and one subframe includes a different number of slots depending on different subcarrier intervals (SCS). Subcarrier intervals in FIG. 21 serve as an example only and are not limited to this.

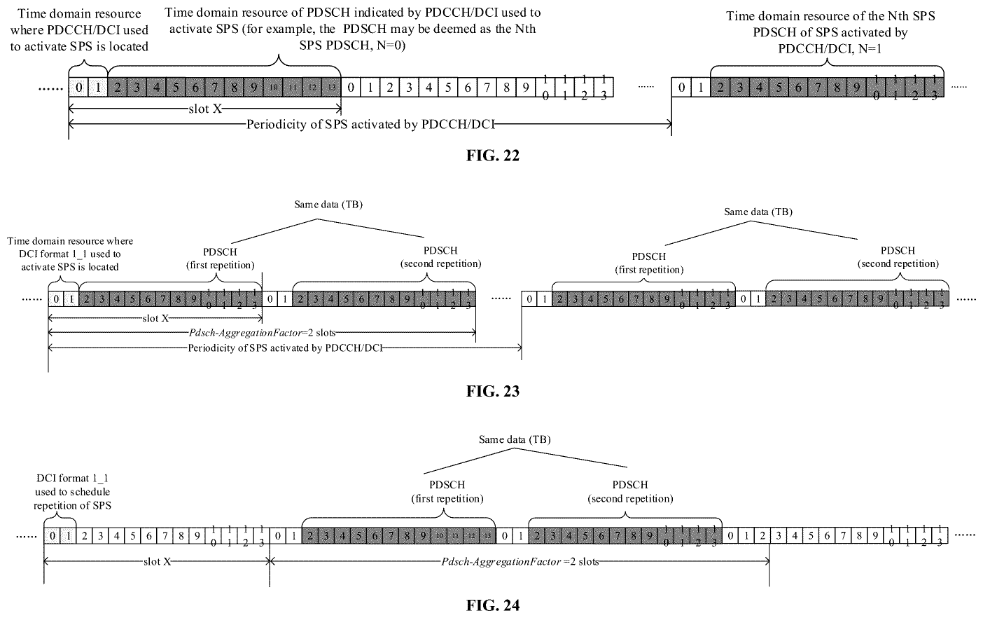

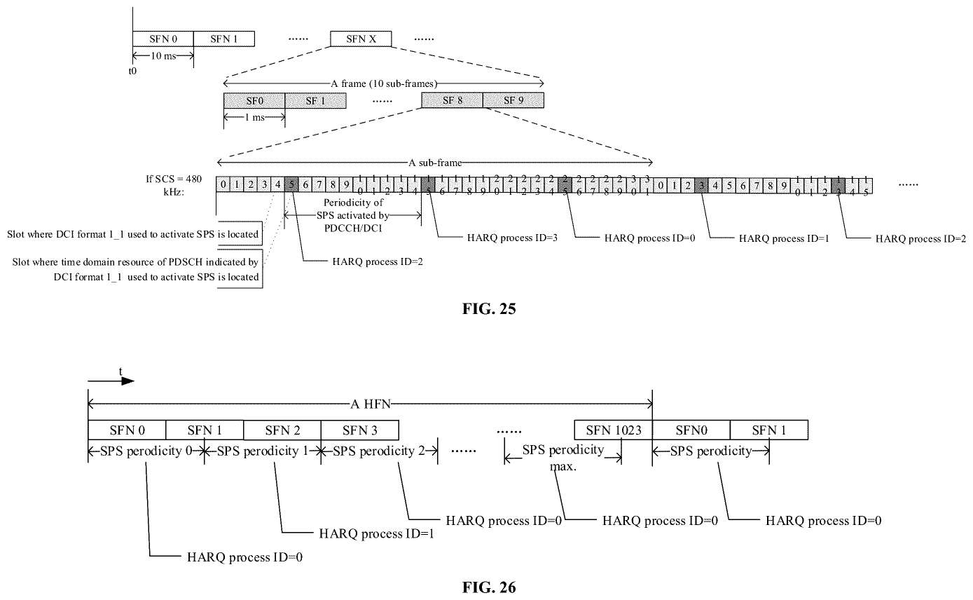

FIG. 22 is a schematic diagram of a time domain resource where a PDCCH/DCI for activating an SPS is located and a time domain resource of a PDSCH indicated by the PDCCH/DCI for activating an SPS, and in FIG. 22, assuming that the PDSCH is not repeated. FIG. 23 is a schematic diagram of a time domain resource where DCI format 1_1 for activating an SPS is located and a PDSCH activated by the DCI, and in FIG. 23, assuming that the PDSCH is repeated according to pdsch-AggregationFactor in pdsch-Config. FIG. 24 is a schematic diagram of DCI format 1_1 for scheduling retransmission for an SPS and a PDSCH scheduled by the DCI, and in FIG. 24, assuming that the PDSCH is repeated according to pdsch-AggregationFactor in pdsch-Config. FIG. 25 is a schematic diagram of a slot where DCI format 1_1 for activating an SPS is located, a slot where an SPS PDSCH activated by DCI format 1_1 is located, and a corresponding HARQ process ID. FIG. 26 is another schematic diagram of a HARQ process ID corresponding to an SPS PDSCH, and in FIG. 26, assuming that there is a sole SPS PDSCH (which is repeated or not repeated) in one period, different periods cyclically correspond to different HARQ process IDs.

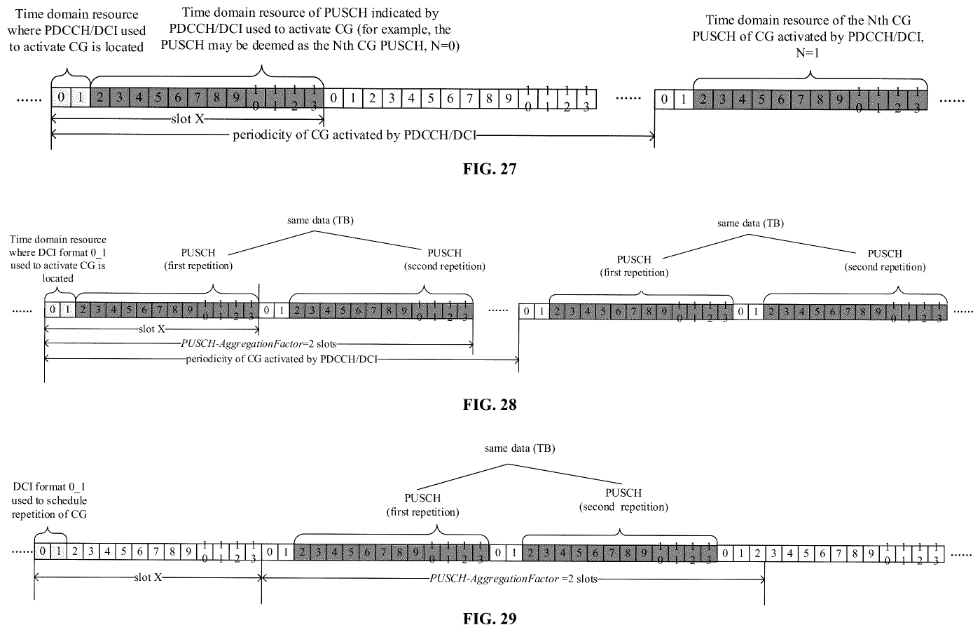

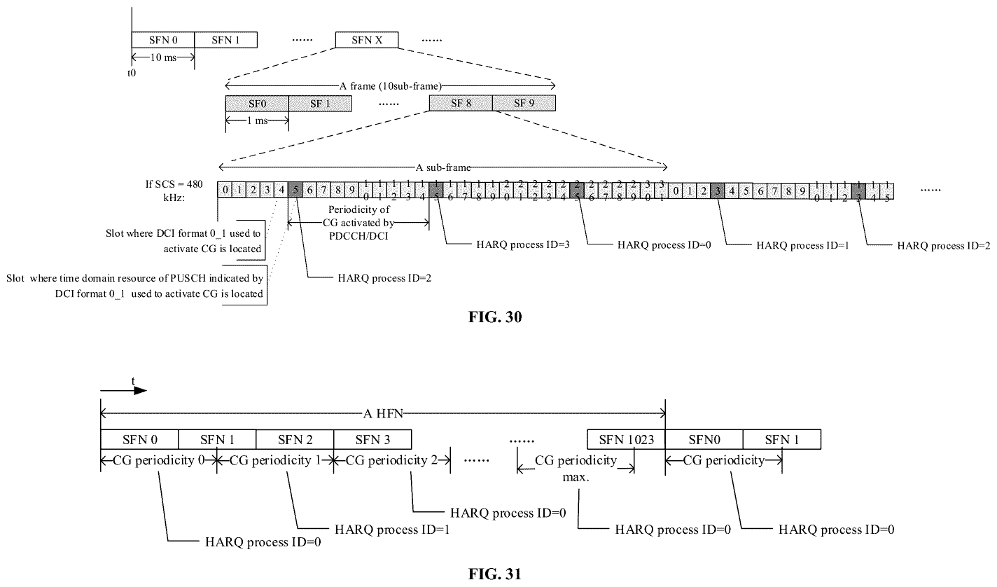

FIG. 27 is a schematic diagram of a time domain resource where a PDCCH/DCI for activating a CG is located and a time domain resource of a PUSCH indicated by the PDCCH/DCI for activating a CG, and in FIG. 27, assuming that the PUSCH is not repeated. FIG. 28 is a schematic diagram of a time domain resource where DCI format 1_1 for activating a CG is located and a PUSCH activated by the DCI, and in FIG. 28, assuming that the PUSCH is repeated according to pusch-AggregationFactor in pusch-Config. FIG. 29 is a schematic diagram of DCI format 1_1 for scheduling retransmission for a CG and a PUSCH scheduled by the DCI, and in FIG. 29, assuming that the PUSCH is repeated according to pusch-AggregationFactor in pusch-Config. FIG. 30 is a schematic diagram of a slot where DCI format 1_1 for activating a CG is located, a slot where a CG PUSCH activated by DCI format 1_1 is located, and a corresponding HARQ process ID. FIG. 31 is another schematic diagram of a HARQ process ID corresponding to a CG PUSCH, and in FIG. 31, assuming that there is a sole CG PUSCH (which is repeated or not repeated) in one period, different periods cyclically correspond to different HARQ process IDs.

The embodiments of the present disclosure are described below in conjunction with the drawings and the specific implementations.

In the embodiments of the present disclosure, “when . . . ”, “in a case where . . . ”, “for a situation in which . . . ” and “if . . . ” represent on the basis of one or more conditions or states, etc., in addition, these expressions are interchangeable. Moreover, “indicate” may explicitly contain certain information for notification, or may implicitly notify via certain features, etc. In addition, the expressions “DCI”, “DCI format” and “DCI formats” refer to the same meaning, they are interchangeable. In addition, the expressions “may schedule”, “can schedule” and “for scheduling” refer to the same meaning, they are interchangeable.

### Embodiments of a First Aspect

The embodiments of the present disclosure provide a data receiving method, which will be described from a terminal equipment side.

FIG. 2 is a schematic diagram of a data receiving method in the embodiments of the present disclosure, as shown in FIG. 2, the method includes:

201, a terminal equipment receives first downlink control information (DCI), the first DCI being used to schedule physical downlink shared channels (PDSCHs);

202, the terminal equipment receives one or more than one PDSCH in the PDSCHs scheduled by the first DCI.

According to the embodiments of the present disclosure, the terminal equipment receives one or more than one PDSCH scheduled by the first DCI, thereby scheduling of more than one PDSCH via one DCI can be supported, further, semi-static scheduling or semi-persistent scheduling of the PDSCH in a case where one DCI (or DCI format) may schedule more than one PDSCH can be supported, and dynamic retransmission for data corresponding to the semi-static scheduling or semi-persistent scheduling is supported.

In some embodiments, in a case where the terminal equipment receives more than one PDSCH in the PDSCHs scheduled by the first DCI, data (i.e., transport blocks (TBs)) carried by different PDSCHs in the more than one PDSCH are different. Thereby, indicating transmission of different transport blocks via one DCI can be supported.

In some embodiments, the first DCI is DCI format 1_1, i.e., a network device schedules multiple PDSCHs via DCI format 1_1.

In some embodiments, the first DCI includes one New Data Indication (NDI) field or two NDI fields, and in a case where the first DCI includes two NDI fields, each NDI field corresponds to one TB respectively. For example, the first DCI includes a first NDI field and/or a second NDI field; the first NDI field and the second NDI field corresponding respectively to a first one of TBs and a second one of TBs in a case where the first DCI includes the first NDI field and the second NDI field. Thereby, a TB may be indicated via an NDI field.

In the above embodiments, a value/values of the first NDI field and/or the second NDI field is/are 0 or 1.

In some embodiments, in a case where CRC of the first DCI is scrambled by a CS-RNTI, the number of bits included in the first NDI field and/or the second NDI field may be determined according to at least one of the following, i.e.:
the maximum number of PDSCHs which may be scheduled by the first DCI (i.e., the maximum number of SLIVs included in a row in a TDRA table corresponding to the first DCI);
the number of PDSCHs scheduled by the first DCI (i.e., the number of SLIVs included in a row indicated by the first DCI);
the number of valid PDSCHs scheduled by the first DCI (i.e., the number of valid SLIVs included in a row indicated by the first DCI).

Thereby, the first NDI field and/or the second NDI field may include one bit, or may also include more than one bit, which specifically depends on at least one of the above determining factors.

In some other embodiments, in a case where CRC of the first DCI is scrambled by a CS-RNTI, the first NDI field and/or the second NDI field only have/has one bit. For example, when two TBs are configured, the first DCI includes one NDI field which is of one bit; or the first DCI includes two NDI fields, and the number of bits of the NDI field corresponding to each TB is 1. In this embodiment, the number of bits of the NDI field does not depend on the determining factors in the preceding embodiments.

In some embodiments, one row or more than one row in a TDRA table corresponding to the first DCI includes more than one SLIV, the more than one SLIV corresponding to more than one PDSCH, thereby realizing scheduling of more than one PDSCH via the first DCI.

In the above embodiments, in some implementations, the first DCI is not used to schedule retransmission of an SPS, i.e., a terminal equipment does not expect CRC of this first DCI to be scrambled by a CS-RNTI; in some implementations, a value/values of the first NDI field and/or the second NDI field of the first DCI is/are 1; in some implementations, the first DCI schedules more than one PDSCH; in some implementations, the first DCI schedules more than one valid PDSCH; in some implementations, an NDI field (the first NDI field and/or the second NDI field) of the first DCI includes more than one bit with a value being 1; in some implementations, a HARQ process ID corresponding to more than one PDSCH scheduled by the first DCI is one of one or more than one HARQ process ID for SPS configuration; in some implementations, a HARQ process ID corresponding to one or more than one PDSCH scheduled by the first DCI is not one of one or more than one HARQ process ID for SPS configuration. The above implementations may be implemented separately or be combined arbitrarily.

In the above embodiments, a value/values of the first NDI field and/or the second NDI field is/are 1, which includes but is not limited to:
the first NDI field includes one bit, a value of the one bit is 1; or,
the first NDI field includes more than one bit, a value of one or more than one specific bit of
the first NDI field is 1, or, a value of at least one bit of the first NDI field is 1, or, values of all bits of the first NDI field are 1; or,
the second NDI field includes one bit, a value of the one bit is 1; or,
the second NDI field includes more than one bit, a value of one or more than one specific bit of the second NDI field is 1, or, a value of at least one bit of the second NDI field is 1, or, values of all bits of the second NDI field are 1.

In the embodiments of the present disclosure, in some embodiments, CRC of the first DCI is scrambled by a CS-RNTI, the first DCI schedules a sole PDSCH (i.e., the first DCI indicates row/rows including one SLIV in a corresponding TDRA table), and a terminal equipment only receives the one PDSCH.

For example, in a case where the TDRA table is configured for DCI format 1_1 (the first DCI), if a UE receives DCI format 1_1 with CRC scrambled by a CS-RNTI and NDI=1 (for a case of two TBs, each TB corresponds to one NDI field respectively, values of both NDI fields being 1 or a value of an NDI field corresponding to one of them (such as the first one of TBs) being 1), the DCI may only indicate row/rows including one SLIV, cannot indicate row/rows including multiple SLIVs. That is, the DCI may only indicate or schedule one PDSCH.

In this example, a HARQ process ID indicated in the DCI may correspond to this PDSCH. The HARQ process ID may be in a HARQ process group for SPS configuration, but the present disclosure is not limited to this, the HARQ process ID indicated in the DCI may further have other implementations, as described above for details, and the description is omitted here.

In the embodiments of the present disclosure, in some embodiments, CRC of the first DCI is scrambled by a CS-RNTI, the first DCI schedules more than one PDSCH (i.e., the first DCI indicates row/rows including more than one SLIV in a corresponding TDRA table).

In the above embodiments, a terminal equipment may determine whether to receive a PDSCH in more than one PDSCH scheduled by the first DCI according to at least one of the following:
a HARQ process ID to which the PDSCH corresponds;
a value of a bit to which the PDSCH corresponds in an NDI field; and
whether a PDSCH collides with a semi-statically configured uplink symbol.

For example, according to whether a PDSCH conflicts with a semi-statically configured uplink symbol, the terminal equipment only receives one PDSCH in the more than one PDSCH.

In this example, the one PDSCH may be a first PDSCH or a last PDSCH in said more than one PDSCH, or may be the a sole valid PDSCH in said more than one PDSCH, or may be the a sole PDSCH with a value of a corresponding NDI field being 1, in said more than one PDSCH, or may be the a sole PDSCH with corresponding HARQ process ID is one of one or more than one HARQ process ID for SPS configuration, in said more than one PDSCH. The present disclosure is not limited to this, said one PDSCH may also be other or any combination of the above.

This example is illustrated below via specific examples.

In a case where said TDRA table is configured for DCI format 1_1 (the first DCI), if a UE receives DCI format 1_1 with CRC scrambled by a CS-RNTI and NDI=1 or ‘1’s (in a case of two TBs, each TB corresponds to one NDI field respectively, values of both NDI fields being 1 or ‘1’s or a value of an NDI field corresponding to one of them (such as the first one of TBs) being 1 or ‘1’s) and row/rows including multiples SLIVs is/are indicated, the DCI may indicate/schedule more than one PDSCH. The UE only receives one of PDSCHs, such as a first PDSCH or a last PDSCH in a time sequence, and/or a sole valid PDSCH (such as a PDSCH that does not conflict with a semi-statically configured uplink symbol), and/or a sole PDSCH with corresponding NDI bit being 1, and/or a PDSCH with corresponding HARQ process ID being one of one or more than one HARQ process ID for SPS configuration.

In this example, a HARQ process ID indicated by the first DCI may correspond to said one PDSCH (regardless of whether this PDSCH is a first PDSCH); or the HARQ process ID indicated by the first DCI corresponds to a first valid PDSCH in said more than one PDSCH, and a terminal equipment determines a HARQ process ID corresponding to said one PDSCH according to the HARQ process ID (regardless of whether this PDSCH is a first PDSCH).

In this example, the HARQ process ID corresponding to said one PDSCH may be one of one or more than one HARQ process ID for SPS configuration, i.e., in a HARQ process ID group for the SPS configuration.

In this example, said one PDSCH may be a valid PDSCH.

In this example, said first PDSCH may be a first PDSCH scheduled by the first DCI or a first valid PDSCH scheduled by the first DCI; similarly, said last PDSCH may be a last PDSCH scheduled by the first DCI or a last valid PDSCH scheduled by the first DCI. The first PDSCH scheduled by the first DCI is a PDSCH (valid PDSCH) corresponding to a first SLIV in a row indicated by the first DCI, similarly, the last PDSCH scheduled by the first DCI is a PDSCH (valid PDSCH) corresponding to a last SLIV in a row indicated by the first DCI.

In this example, the a sole valid PDSCH is only received for a UE, i.e., a PDSCH indicated/scheduled by the DCI may only include one valid PDSCH, that is, the UE does not expect that the DCI indicates/schedules more than one valid PDSCH. The UE then only receives the one PDSCH.

In this example, the a sole PDSCH with corresponding NDI bit being 1 is only received for a UE, an NDI field in the DCI only includes one bit with a value being 1, that is, the UE does not expect that the NDI field in the DCI includes more than one bit with a value being 1. The UE then only receives the one PDSCH.

In this example, the UE does not receive an invalid PDSCH, and the invalid PDSCH does not have a corresponding HARQ process ID.

In this example, for other (valid) PDSCH (if any), the UE does not receive it, or cancels reception of other (valid) PDSCH. Other (valid) PDSCH corresponds to or does not correspond to a HARQ process ID (or, the UE determines or does not determine a HARQ process ID of other (valid) PDSCH).

For another example, according to a HARQ process ID corresponding to a PDSCH, the terminal equipment only receives a PDSCH with corresponding HARQ process ID being one of one or more than one HARQ process ID for SPS configuration.

This example is illustrated below via specific examples.

In a case where said TDRA table is configured for DCI format 1_1 (the first DCI), if a UE receives DCI format 1_1 with CRC scrambled by a CS-RNTI and NDI=1 or ‘1’s (in a case of two TBs, each TB corresponds to one NDI field respectively, values of both NDI fields being 1 or ‘1’s or a value of an NDI field corresponding to one of them (such as the first one of TBs) being 1 or ‘1’s) and row/rows including multiples SLIVs is/are indicated, the DCI may indicate/schedule more than one PDSCH. The UE only receives a PDSCH with corresponding HARQ process ID is in a HARQ process group configured for SPS configuration.

In this example, the HARQ process ID indicated in the DCI corresponds to a first valid PDSCH, and the UE determines a HARQ process ID of the valid PDSCH according to this indication.

In this example, the UE does not receive a PDSCH with corresponding HARQ process ID is not in a HARQ process group configured for SPS configuration.

In this example, the UE does not receive an invalid PDSCH, and the invalid PDSCH does not have a corresponding HARQ process ID.

For another example, according to a HARQ process ID corresponding to a PDSCH, the terminal equipment receives all valid PDSCHs in said more than one PDSCH.

In one example, a HARQ process ID corresponding to the all valid PDSCHs must be one of the one or more than one HARQ process ID for SPS configuration.

This example is illustrated below via specific examples.

In a case where said TDRA table is configured for DCI format 1_1 (the first DCI), if a UE receives DCI format 1_1 with CRC scrambled by a CS-RNTI and NDI=1 or ‘1’s (in a case of two TBs, each TB corresponds to one NDI field respectively, values of both NDI fields being 1 or ‘1’s or a value of an NDI field corresponding to one of them (such as the first one of TBs) being 1 or ‘1’s) and row/rows including multiples SLIVs is/are indicated, the DCI may indicate/schedule more than one PDSCH. HARQ process ID(s) corresponding to valid PDSCH(s) included in more than one PDSCH indicated/scheduled by the DCI must be in a HARQ process group configured for SPS configuration. That is, the UE does not expect that HARQ process ID(s) corresponding to any one valid PDSCH indicated/scheduled by the DCI is not in HARQ process group configured for SPS configuration.

In another example, a PDSCH with a corresponding HARQ process ID being not one of one or more than one HARQ process ID for SPS configuration and/or a value of a bit in a corresponding NDI field being 0, is initial transmission.

This example is illustrated below via specific examples.

In a case where said TDRA table is configured for DCI format 1_1 (the first DCI), if a UE receives DCI format 1_1 with CRC scrambled by a CS-RNTI and NDI=1 or ‘1’s and row/rows including multiples SLIVs is/are indicated, the DCI may indicate/schedule more than one PDSCH. The UE receives all valid PDSCHs, and for PDSCH(s) with corresponding HARQ process ID(s) being not in a HARQ process group configured for SPS configuration, the UE considers it/them as initial transmission.

In this example, a HARQ process ID corresponding to a sole or at least one PDSCH in all valid PDSCHs is one of one or more than one HARQ process ID for SPS configuration. That is, a sole or at least one HARQ process ID(s) corresponding to valid PDSCH(s) included in more than one PDSCH indicated/scheduled by the DCI is in a HARQ process group configured for SPS configuration. Valid PDSCH(s) corresponding to the HARQ process ID(s) is/are retransmission.

In the above two examples, the HARQ process ID indicated in the DCI corresponds to a first valid PDSCH, and the UE determines HARQ process IDs of the valid PDSCHs according to this indication.

In the above two examples, the UE receives all valid PDSCHs.

For another example, according to a value of a bit corresponding to a PDSCH in an NDI field, a terminal equipment only receives a PDSCH with a value of a bit in the corresponding NDI field being 1; or, the terminal equipment receives all valid PDSCHs, and for the PDSCH with a value of a bit in the corresponding NDI field being 1, it is considered as retransmission, and for a PDSCH with a value of a bit in the corresponding NDI field being 0, it is considered as initial transmission.

This example is illustrated below via specific examples.

In a case where said TDRA table is configured for DCI format 1_1 (the first DCI), if a UE receives DCI format 1_1 with CRC scrambled by a CS-RNTI and a row including multiple SLIVs is indicated, in which an NDI bit corresponding to one or more SLIVs is 1 (in a case of two TBs, each TB corresponds to one NDI field respectively, a corresponding bit of the one or more SLIVs in two NDI fields is 1, or a corresponding bit of one of them (such as the first one of TBs) is 1), i.e., the DCI may indicate/schedule more than one PDSCH, and an NDI bit corresponding to one or more PDSCHs is 1.

In this example, the UE only receives a PDSCH corresponding to NDI bit=1, or, the UE receives all valid PDSCHs, and for a PDSCH corresponding to NDI bit=0, the UE considers it as initial transmission.

In this example, in an NDI field, a value of a bit corresponding to a sole or at least one PDSCH in all valid PDSCHs is 1.

In the embodiments of the present disclosure, in some embodiments, the terminal equipment may further receive PDSCH configuration (pdsch-Config) including a first configuration parameter (such as pdsch-AggregationFactor) used for configuring the number of repetitions, and in a case where CRC of the first DCI is scrambled by a CS-RNTI, the first configuration parameter is applied to the first DCI. That is, in a case where the TDRA table is configured for DCI format 1_1 (the first DCI), when the UE receives a PDSCH scheduled by DCI format 1_1 with CRC scrambled by a CS-RNTI and NDI=1 or NDI=0, if the PDSCH configuration (pdsch-Config) includes pdsch-AggregationFactor, repetition is performed according to the number of times configured by pdsch-AggregationFactor.

In the above embodiments, that the first configuration parameter is applied to the first DCI refers to: the first configuration parameter is applied to one or more than one PDSCH in PDSCH(s) scheduled by the first DCI.

For example, each PDSCH scheduled by the first DCI is repeated according to the number of times configured by the first configuration parameter, and/or, each valid PDSCH scheduled by the first DCI is repeated according to the number of times configured by the first configuration parameter; and/or, each PDSCH in PDSCHs scheduled by the first DCI and needing to be received by a terminal equipment is repeated according to the number of times configured by the first configuration parameter; and/or, the first DCI only schedules one PDSCH and the one PDSCH is repeated according to the number of times configured by the first configuration parameter; and/or, the terminal equipment only receives one PDSCH in PDSCHs scheduled by the first DCI, and the one PDSCH is repeated according to the number of times configured by the first configuration parameter.

In the embodiments of the present disclosure, in some embodiments, the terminal equipment may further receive PDSCH configuration (pdsch-Config) including a first configuration parameter (such as pdsch-AggregationFactor) used for configuring the number of repetitions, and in a case where CRC of the first DCI is scrambled by a CS-RNTI, the first configuration parameter is not applied to the first DCI.

In the above embodiments, that the first configuration parameter is not applied to the first DCI refers to: the first configuration parameter is not applied to any one in PDSCHs scheduled by the first DCI.

For example, in a case where the TDRA table is configured for DCI format 1_1 (the first DCI), when the UE receives a PDSCH scheduled by DCI format 1_1 with CRC scrambled by a CS-RNTI and NDI=1 or NDI=0, if the PDSCH configuration (pdsch-Config) includes pdsch-AggregationFactor, repetition is not performed according to the number of times configured by pdsch-AggregationFactor. If the first DCI adopts other DCI format (a TDRA table corresponding to the other format and said TDRA table are different, for example, each row in the TDRA table corresponding to the other format only includes one SLIV), such as DCI format 1_0/1_2, etc., repetition is performed according to the number of times configured by pdsch-AggregationFactor.

In the above embodiments, in an implementation, a PDSCH scheduled by the first DCI is not repeated, regardless of whether the SPS configuration includes said pdsch-AggregationFactor.

In the above embodiments, in another implementation, if the SPS configuration includes said pdsch-AggregationFactor, a PDSCH scheduled by the first DCI is repeated according to this pdsch-AggregationFactor.

In this implementation, the terminal equipment may receive SPS configuration including a second configuration parameter (such as pdsch-AggregationFactor) used for configuring the number of repetitions; the second configuration parameter is applied to the first DCI.

In this implementation, that the second configuration parameter is applied to the first DCI refers to: the second configuration parameter is applied to one or more than one PDSCH in PDSCHs scheduled by the first DCI.

For example, each PDSCH scheduled by the first DCI is repeated according to the number of times configured by the second configuration parameter, and/or, each valid PDSCH scheduled by the first DCI is repeated according to the number of times configured by the second configuration parameter; and/or, each PDSCH in PDSCHs scheduled by the first DCI and needing to be received by a terminal equipment is repeated according to the number of times configured by the second configuration parameter; and/or, the first DCI only schedules one PDSCH and the one PDSCH is repeated according to the number of times configured by the second configuration parameter; and/or, the terminal equipment only receives one PDSCH in PDSCHs scheduled by the first DCI, and the one PDSCH is repeated according to the number of times configured by the second configuration parameter.

In this implementation, the SPS configuration (sps-config) is SPS configuration corresponding to the PDSCH (a corresponding SPS PDSCH). For example, the UE is only configured with one sps-config, this sps-config is SPS configuration corresponding to the PDSCH (a corresponding SPS PDSCH). For another example, if the UE is only configured with and activated more than one SPS configuration, the UE for example determines SPS configuration corresponding to the PDSCH (a corresponding SPS PDSCH) according to a HARQ process ID corresponding to the PDSCH. For a further example, in a case where the HARQ process ID corresponding to the PDSCH is shared by multiple SPS configurations, said pdsch-AggregationFactor for example refers to a maximum pdsch-AggregationFactor included in the multiple SPS configurations.

In the embodiments of the present disclosure, the SPS configuration may further include an information field (or field) for a base station to indicate/a UE to determine a range of a corresponding HARQ process ID, such as nrofHARQ-Processes, harq-ProcID-Offset, etc.

In the embodiments of the present disclosure, for aggregation/repetition of an SPS PDSCH, in some embodiments, the terminal equipment may further receive PDSCH configuration (pdsch-Config) including a first configuration parameter (such as pdsch-AggregationFactor) used for configuring the number of repetitions; moreover, the terminal equipment may further receive second DCI for activating SPS configuration, said first configuration parameter is applied to the second DCI, and one row or more than one row in a TDRA table corresponding to the second DCI include(s) more than one SLIV.

In the above embodiments, that the first configuration parameter is applied to the second DCI refers to: an SPS PDSCH corresponding to the second DCI is repeated according to said first configuration parameter. The SPS PDSCH corresponding to the second DCI e.g. refers to a PDSCH (SPS PDSCH) scheduled by SPS configuration activated by the second DCI, or an SPS PDSCH activated by the second DCI.

For example, in a case where the TDRA table is configured for DCI format 1_1 (the second DCI), for a PDSCH (i.e., an SPS PDSCH) scheduled by the SPS configuration and activated by DCI format 1_1, if the PDSCH configuration (pdsch-Config) includes pdsch-AggregationFactor, repetition is performed according to the number of times configured by this pdsch-AggregationFactor. The SPS PDSCH has no corresponding PDCCH which is a PDCCH carrying DCI for scheduling a PDSCH.

In the embodiments of the present disclosure, for aggregation/repetition of a SPS PDSCH, in some other embodiments, the terminal equipment may further receive PDSCH configuration (pdsch-Config) including a first configuration parameter (such as pdsch-AggregationFactor) used for configuring the number of repetitions; moreover, the terminal equipment may further receive second DCI for activating SPS configuration, said first configuration parameter is not applied to the second DCI, and one row or more than one row in a TDRA table corresponding to the second DCI include(s) more than one SLIV.

In the above embodiments, that the first configuration parameter is not applied to the second DCI refers to: the first configuration parameter is not applied to any one of SPS PDSCHs corresponding to the second DCI.

For example, in a case where the TDRA table is configured for DCI format 1_1 (the second DCI), for a PDSCH (i.e., an SPS PDSCH) scheduled by the SPS configuration and activated by DCI format 1_1, if the PDSCH configuration (pdsch-Config) includes pdsch-AggregationFactor, repetition is not performed according to the number of times configured by this pdsch-AggregationFactor. The SPS PDSCH has no corresponding PDCCH which is a PDCCH carrying DCI for scheduling a PDSCH. If the second DCI adopts other DCI format (a TDRA table corresponding to the other format and said TDRA table are different, for example, each row in the TDRA table corresponding to the other format only includes one SLIV), such as DCI format 1_0/1_2, etc., repetition is performed according to the number of times configured by pdsch-AggregationFactor.

In the above embodiments, in one implementation, an SPS PDSCH corresponding to the second DCI is not repeated, regardless of whether the SPS configuration includes said pdsch-AggregationFactor.

In the above embodiments, in another implementation, if the SPS configuration includes said pdsch-AggregationFactor, an SPS PDSCH corresponding to the second DCI is repeated according to this pdsch-AggregationFactor.

In this implementation, the terminal equipment may receive SPS configuration including a second configuration parameter (such as pdsch-AggregationFactor) used for configuring the number of repetitions; the second configuration parameter is applied to the second DCI.

In this implementation, that the second configuration parameter is applied to the second DCI refers to: the second configuration parameter is applied to one or more than one SPS PDSCH in SPS PDSCH(s) corresponding to the second DCI.

For example, each SPS PDSCH corresponding to the second DCI is repeated according to the number of times configured by the second configuration parameter, and/or, each valid SPS PDSCH corresponding to the second DCI is repeated according to the number of times configured by the second configuration parameter; and/or, each SPS PDSCH in SPS PDSCHs corresponding to the second DCI and needing to be received by a terminal equipment is repeated according to the number of times configured by the second configuration parameter; and/or, the second DCI only corresponds to one SPS PDSCH and the one SPS PDSCH is repeated according to the number of times configured by the second configuration parameter; and/or, the terminal equipment only receives one SPS PDSCH in SPS PDSCHs corresponding to the second DCI, and the one SPS PDSCH is repeated according to the number of times configured by the second configuration parameter.

The above embodiments are only illustrative for the embodiments of the present disclosure, but the present disclosure is not limited to this, appropriate modifications can be also made based on the above embodiments. For example, each of the above embodiments may be used individually, or one or more of the above embodiments may be combined.

In the embodiments of the present disclosure, the terminal equipment may further receive a PDCCH/DCI for activating/deactivating an SPS, for example, the terminal equipment may confirm the validity of the PDCCH/DCI according to one or more of the following:
1. being scrambled by a CS-RNTI (more specifically, CRC of a corresponding DCI format is scrambled by a CS-RNTI);
2. an NDI field is set to be ‘0’;
3. a DFI field is set to be ‘0’ if there is a DFI field;
4. for activation, if there is a PDSCH-to-HARQ feedback timing indicator field, this field cannot provide an inapplicable value (such as −1);
5. TDRA configuration/row/row index indicated by a time domain resource assignment field includes/corresponds to a sole PDSCH/SLIV (If a TDRA table applied by a corresponding DCI format includes at least one row of TDRA configuration including more than one SLIV configuration, or DCI format 1_1).

In the embodiments of the present disclosure, for SPS activation, if a sole configuration for an SPS PDSCH is provided, the validity of the DCI may further depend on a HARQ process number field and a RV field.

For the RV field, if a TDRA table applied by a DCI format (such as DCI format 1_1) corresponding to the DCI includes at least one row of TDRA configuration including more than one SLIV configuration, and in a case where the TDRA configuration indicated by a time domain resource assignment field only includes/corresponds to one PDSCH, a Redundancy version field corresponding to one TB in the DCI includes 2 bits. In a case where the DCI format configures one TB, the DCI only includes one Redundancy version field, bits of the Redundancy version field are all set to ‘0’ or ‘1’. In a case where the DCI format configures two TBs, the DCI includes Redundancy version fields corresponding to the two TBs respectively (one-to-one correspondence), bits of the Redundancy version fields corresponding to the two TBs respectively are all set to ‘0’ or ‘1’; or, bits of a Redundancy version field corresponding to one TB (such as a first one of TBs) are all set to ‘0’, bits of a Redundancy version field corresponding to the other TB (such as a second one of TBs) are all set to ‘1’. For example, (in a case where an SPS only supports one TB,) the first one of TBs is enabled, and the second one of TBs is disabled, bits of a Redundancy version field corresponding to the first one of TBs are all set to ‘0’, bits of a Redundancy version field corresponding to the second one of TBs are all set to ‘1’. For another example, (in a case where an SPS only supports two TBs,) bits of Redundancy version fields corresponding to the two TBs respectively are all set to ‘0’ or ‘1’. As shown in the following Table 2.

TABLE 2

| | DCI format | DCI format | |
|---|---|---|---|
| | 0_0/0_1/0_2 | 1_0/1_2 | DCI format 1_1 |
| HARQ process | set to all ′0′s | set to all ′0′s | set to all ′0′s |
| number | | | |
| Redundancy | set to all ′0′s | set to all ′0′s | For the enabled transport |
| version | | | block: set to all ′0′s |

In addition, if more than one configuration for the SPS PDSCH are provided, the validity of the DCI further depends on a RV field. Further explanation of the RV field settings is the same as the above-mentioned activation case of a sole configuration for the SPS PDSCH. As shown in the following Table 3.

TABLE 3

| | DCI format | DCI format | |
|---|---|---|---|
| | 0_0/0_1/0_2 | 1_0/1_2 | DCI format 1_1 |
| Redundancy version | set to all ′0′s | set to all ′0′s | For the enabled |
| | | | transport block: set to |
| | | | all ′0′s |

On the other hand, (for a case where more than one configuration for the SPS PDSCH are provided,) a HARQ process number field is used to indicate an SPS configuration index activated by the DCI. The SPS configuration index may associate with/correspond to one or more configurations for the SPS PDSCH.

In the embodiments of the present disclosure, for SPS deactivation, if a sole configuration for an SPS PDSCH is provided (or, a sole SPS PDSCH is configured), the validity of the DCI may further depend on a HARQ process number field, a RV field, a Modulation and coding scheme field and a Frequency domain resource assignment field.

For the RV field, if a TDRA table applied by a DCI format (such as DCI format 1_1) corresponding to the DCI includes at least one row of TDRA configuration including more than one SLIV configuration, and in a case where the TDRA configuration indicated in the DCI only includes/corresponds to one PDSCH, a Redundancy version field corresponding to one TB in the DCI includes 2 bits. In a case where the DCI format configures one TB, the DCI only includes one Redundancy version field, bits of the Redundancy version field are set to ‘0’ or ‘1’. In a case where the DCI format configures two TBs, the DCI includes Redundancy version fields corresponding to the two TBs respectively (one-to-one correspondence), bits of the Redundancy version fields corresponding to the two TBs respectively are set to ‘0’ or ‘1’. As shown in the following Table 4.

TABLE 4

| | DCI format | DCI format |
|---|---|---|
| | 0_0/0_1/0_2 | 1_0/1_2 |
| HARQ process number | set to all ′0′s | set to all ′0′s |
| Redundancy version | set to all ′0′s | set to all ′0′s |
| Modulation and coding | set to all ′1′s | set to all ′1′s |
| scheme | | |
| Frequency domain | set to all ′0′s for | set to all ′0′s for |
| resource assignment | FDRA Type 2 with | FDRA Type 0 or for |
| | μ = 1 | dynamicSwitch |
| | set to all ′1′s, | set to all ′1′s for |
| | otherwise | FDRA Type 1 |

If more than one configuration for the SPS PDSCH are provided, the validity of the DCI may further depend on a RV field, a Modulation and coding scheme field and a Frequency domain resource assignment field. Further explanation of the RV field settings is the same as the above-mentioned deactivation case of a sole configuration for the SPS PDSCH. As shown in the following Table 5.

TABLE 5

| | DCI format | DCI format |
|---|---|---|
| | 0_0/0_1/0_2 | 1_0/1_2 |
| Redundancy version | set to all ′0′s | set to all ′0′s |
| Modulation and coding | set to all ′1′s | set to all ′1′s |
| scheme | | |
| Frequency domain | set to all ′0′s for | set to all ′0′s for FDRA |
| resource assignment | FDRA Type 2 with | Type 0 or for |
| | μ = 1 | dynamicSwitch |
| | set to all ′1′s, | set to all ′1′s for FDRA |
| | otherwise | Type 1 |

On the other hand, (for a case where more than one configuration for the SPS PDSCH are provided,) a HARQ process number field is used to indicate an SPS configuration index deactivated by the DCI. The SPS configuration index may associate with/correspond to one or more configurations for the SPS PDSCH.

According to the method in the embodiments of the present disclosure, scheduling of more than one PDSCH via one DCI can be supported, further, semi-static scheduling or semi-persistent scheduling of the PDSCH in a case where one DCI (or DCI format) may schedule more than one PDSCH can be supported, and dynamic retransmission for data corresponding to the semi-static scheduling or semi-persistent scheduling is supported.

### Embodiments of a Second Aspect

The embodiments of the present disclosure provide a data scheduling method, which will be described from a network device side. The method relates to processing on a network device side corresponding to the method in the embodiments of the first aspect, wherein the same contents as the embodiments of the first aspect are not repeated.

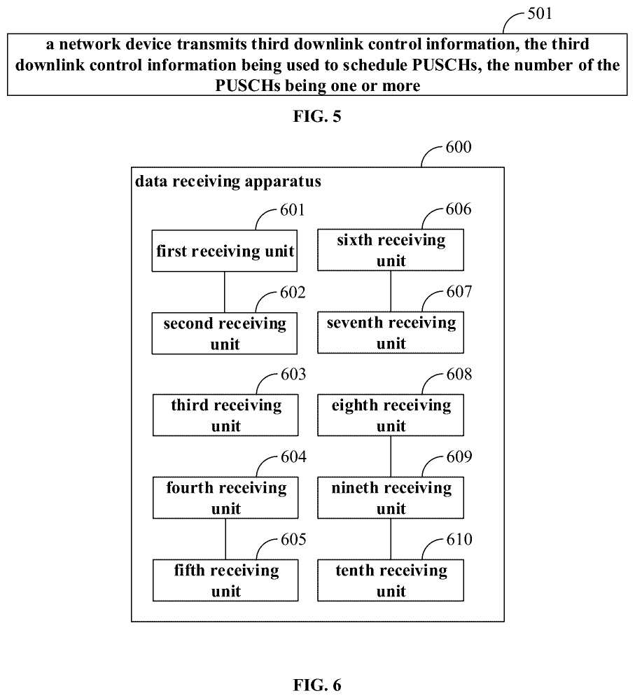

FIG. 3 is a schematic diagram of a data scheduling method in the embodiments of the present disclosure. As shown in FIG. 3, the method includes:

301: a network device transmits first downlink control information, the first downlink control information being used to schedule PDSCHs, the number of the PDSCHs being one or more.

In some embodiments, in a case where the network device transmits more than one PDSCH in the PDSCHs scheduled by the first downlink control information, data carried by different PDSCHs in the more than one PDSCH are different.

In some embodiments, the first downlink control information is DCI format 1_1.

In some embodiments, the first downlink control information includes a first NDI field and/or a second NDI field; the first NDI field and the second NDI field corresponding respectively to a first one of TBs and a second one of TBs in a case where the first downlink control information includes the first NDI field and the second NDI field.

In some embodiments, a value/values of the first NDI field and/or the second NDI field is/are 0 or 1.

In some embodiments, the number of bits included in the first NDI field and/or the second NDI field is determined according to at least one of the following:
the maximum number of PDSCHs that can be scheduled by the first downlink control information;
the number of PDSCHs scheduled by the first downlink control information;
the number of valid PDSCHs scheduled by the first downlink control information.

In some embodiments, in a case where CRC of the first downlink control information is scrambled by a CS-RNTI, the first NDI field and/or the second NDI field include(s) one bit, or the first NDI field and/or the second NDI field include(s) more than one bit; in a case where the first NDI field and/or the second NDI field include(s) more than one bit, a sole bit is valid, or more than one bit are valid, or all bits are valid.

In some embodiments, one or more than one row in a TDRA table to which the first downlink control information corresponds include(s) more than one SLIV.

In some embodiments, the first downlink control information schedules one PDSCH, and/or, a value/values of a first NDI field and/or a second NDI field of the first downlink control information is/are 1, and/or, the first downlink control information schedules more than one PDSCH, and/or, the first downlink control information schedules more than one valid PDSCH, and/or, an NDI field of the first downlink control information includes more than one bit with a value being 1, and/or, HARQ process ID(s) corresponding to more than one PDSCH scheduled by the first downlink control information is/are one of one or more than one HARQ process ID for SPS configuration, and/or, HARQ process ID(s) corresponding to one or more than one PDSCH scheduled by the first downlink control information is/are not one of one or more than one HARQ process ID for SPS configuration.

In some embodiments, CRC of the first downlink control information is scrambled by a CS-RNTI, and the first downlink control information only schedules one PDSCH.

In some embodiments, CRC of the first downlink control information is scrambled by a CS-RNTI, and the first downlink control information schedules more than one PDSCH, the network device transmits one PDSCH of the more than one PDSCH scheduled by the first downlink control information, or, the network device transmits a PDSCH whose corresponding HARQ process ID is one of one or more than one HARQ process ID for SPS configuration; or, the network device transmits all valid PDSCHs in more than one PDSCH scheduled by the first downlink control information; or, the network device transmits a PDSCH with a value of a bit in a corresponding NDI field being 1; or, the network device transmits all valid PDSCHs, for a PDSCH with a value of a bit in a corresponding NDI field being 1, it is considered as retransmission, and for a PDSCH with a value of a bit in a corresponding NDI field being 0, it is considered as initial transmission.

In some embodiments, the one PDSCH is a first PDSCH or a last PDSCH in the more than one PDSCH, and/or, the one PDSCH is the a sole valid PDSCH in the more than one PDSCH, and/or, the one PDSCH is the a sole PDSCH with a value of a corresponding NDI field being 1, in the more than one PDSCH, and/or, the one PDSCH is the a sole PDSCH whose corresponding HARQ process ID is one of one or more than one HARQ process ID for SPS configuration, in the more than one PDSCH.

In some embodiments, a HARQ process ID indicated by the first downlink control information corresponds to the one PDSCH; or, a HARQ process ID indicated by the first downlink control information corresponds to a first valid PDSCH in the more than one PDSCH, and the terminal equipment determines a HARQ process ID corresponding to the one PDSCH according to the HARQ process ID.

In some embodiments, the HARQ process ID corresponding to the one PDSCH is one of one or more than one HARQ process ID for SPS configuration.

In some embodiments, the one PDSCH is a valid PDSCH.

In some embodiments, the first PDSCH is a first PDSCH scheduled by the first downlink control information or a first valid PDSCH scheduled by the first downlink control information; the last PDSCH is a last PDSCH scheduled by the first downlink control information or a last valid PDSCH scheduled by the first downlink control information.

In some embodiments, a HARQ process ID corresponding to all valid PDSCHs must be one of one or more than one HARQ process ID for SPS configuration.

In some embodiments, a PDSCH with a corresponding HARQ process ID being not one of one or more than one HARQ process ID for SPS configuration and/or a value of a bit in a corresponding NDI field being 0, is initial transmission.

In some embodiments, a HARQ process ID corresponding to a sole or at least one PDSCH in the all valid PDSCHs is one of one or more than one HARQ process ID for SPS configuration.

In some embodiments, in an NDI field, a value of a bit corresponding to a sole or at least one PDSCH in all valid PDSCHs is 1.

In some embodiments, the method further includes:
the network device transmits PDSCH configuration including a first configuration parameter used for configuring the number of repetitions;
wherein, CRC of the first downlink control information is scrambled by a CS-RNTI, and the first configuration parameter is applied to the first downlink control information.

In some embodiments, that the first configuration parameter is applied to the first downlink control information includes: the first configuration parameter is applied to one or more than one PDSCH in PDSCH(s) scheduled by the first downlink control information.

In some embodiments, each PDSCH scheduled by the first downlink control information is repeated according to the number of times configured by the first configuration parameter, and/or, each valid PDSCH scheduled by the first downlink control information is repeated according to the number of times configured by the first configuration parameter; and/or, each PDSCH in PDSCHs scheduled by the first downlink control information and needing to be received by a terminal equipment is repeated according to the number of times configured by the first configuration parameter; and/or, the first downlink control information only schedules one PDSCH and the one PDSCH is repeated according to the number of times configured by the first configuration parameter; and/or, the terminal equipment only receives one PDSCH in PDSCHs scheduled by the first downlink control information, and the one PDSCH is repeated according to the number of times configured by the first configuration parameter.

In some embodiments, the method further includes:
the network device transmits PDSCH configuration including a first configuration parameter used for configuring the number of repetitions;
wherein, CRC of the first downlink control information is scrambled by a CS-RNTI, and the first configuration parameter is not applied to the first downlink control information.

In some embodiments, that the first configuration parameter is not applied to the first downlink control information includes: the first configuration parameter is not applied to any one of PDSCHs scheduled by the first downlink control information.

In some embodiments, the method further includes:
the network device transmits SPS configuration including a second configuration parameter used for configuring the number of repetitions;
wherein, the second configuration parameter is applied to the first downlink control information.

In some embodiments, that the second configuration parameter is applied to the first downlink control information includes: the second configuration parameter is applied to one or more than one PDSCH in PDSCH(s) scheduled by the first downlink control information.

In some embodiments, each PDSCH scheduled by the first downlink control information is repeated according to the number of times configured by the second configuration parameter, and/or, each valid PDSCH scheduled by the first downlink control information is repeated according to the number of times configured by the second configuration parameter; and/or, each PDSCH in PDSCHs scheduled by the first downlink control information and needing to be received by a terminal equipment is repeated according to the number of times configured by the second configuration parameter; and/or, the first downlink control information only schedules one PDSCH and the one PDSCH is repeated according to the number of times configured by the second configuration parameter; and/or, the terminal equipment only receives one PDSCH in PDSCHs scheduled by the first downlink control information, and the one PDSCH is repeated according to the number of times configured by the second configuration parameter.

In some embodiments, the method further includes:
the network device transmits PDSCH configuration including a first configuration parameter used for configuring the number of repetitions; and
the network device transmits second downlink control information for activating SPS configuration, the first configuration parameter being applied to the second downlink control information, and one or more than one row in a TDRA table to which the second downlink control information corresponds including more than one SLIV.

In some embodiments, that the first configuration parameter is applied to the second downlink control information includes: a SPS PDSCH corresponding to the second downlink control information is repeated according to the first configuration parameter.

In some embodiments, the method further includes:
the network device transmits PDSCH configuration including a first configuration parameter used for configuring the number of repetitions; and
the network device transmits second downlink control information for activating SPS configuration, the first configuration parameter being not applied to the second downlink control information, and one or more than one row in a TDRA table to which the second downlink control information corresponds including more than one SLIV.

In some embodiments, that the first configuration parameter is not applied to the second downlink control information includes: the first configuration parameter is not applied to any one of SPS PDSCHs corresponding to the second downlink control information.

In some embodiments, the method further includes:
the network device transmits SPS configuration including a second configuration parameter used for configuring the number of repetitions;
wherein, the second configuration parameter is applied to the second downlink control information.

In some embodiments, that the second configuration parameter is applied to the second downlink control information includes: the second configuration parameter is applied to one or more than one SPS PDSCH in SPS PDSCH(s) corresponding to the second downlink control information.

In some embodiments, each SPS PDSCH corresponding to the second downlink control information is repeated according to the number of times configured by the second configuration parameter, and/or, each valid SPS PDSCH corresponding to the second downlink control information is repeated according to the number of times configured by the second configuration parameter; and/or, each SPS PDSCH in SPS PDSCHs corresponding to the second downlink control information and needing to be received by a terminal equipment is repeated according to the number of times configured by the second configuration parameter; and/or, the second downlink control information only corresponds to one SPS PDSCH and the one SPS PDSCH is repeated according to the number of times configured by the second configuration parameter; and/or, the terminal equipment only receives one SPS PDSCH in SPS PDSCHs corresponding to the second downlink control information, and the one SPS PDSCH is repeated according to the number of times configured by the second configuration parameter.

The above embodiments are only illustrative for the embodiments of the present disclosure, but the present disclosure is not limited to this, appropriate modifications can be also made based on the above embodiments. For example, each of the above embodiments may be used individually, or one or more of the above embodiments may be combined.

According to the method in the embodiments of the present disclosure, scheduling of more than one PDSCH via one DCI can be supported, further, semi-static scheduling or semi-persistent scheduling of the PDSCH in a case where one DCI (or DCI format) may schedule more than one PDSCH can be supported, and dynamic retransmission for data corresponding to the semi-static scheduling or semi-persistent scheduling is supported. Moreover, for a network device, the flexibility of configuration and resource scheduling may also be improved.

### Embodiments of a Third Aspect

The embodiments of the present disclosure provide a data transmitting method, which will be described from a terminal equipment side.

FIG. 4 is a schematic diagram of a data transmitting method in the embodiments of the present disclosure. As shown in FIG. 4, the data transmitting method in the embodiments of the present disclosure includes:

401: a terminal equipment receives third downlink control information, the third downlink control information being used to schedule PUSCHs; and

402: the terminal equipment transmits one or more than one PUSCH in the PUSCHs scheduled by the third downlink control information.

According to the embodiments of the present disclosure, the terminal equipment transmits one or more than one PUSCH scheduled by the third DCI, thereby scheduling of more than one PUSCH via one DCI can be supported, further, semi-static scheduling or semi-persistent scheduling of the PUSCH in a case where one DCI (or DCI format) may schedule more than one PUSCH can be supported, and dynamic retransmission for data corresponding to the semi-static scheduling or semi-persistent scheduling is supported.

In some embodiments, in a case where the terminal equipment transmits more than one PUSCH in the PUSCHs scheduled by the third DCI, data (i.e., transport blocks (TBs)) carried by different PUSCHs in the more than one PUSCH are different. Thereby, indicating transmission of different transmission blocks via one DCI can be supported.

In some embodiments, the third DCI is DCI format 0_1, i.e., a network device schedules multiple PUSCHs via DCI format 0_1.

In some embodiments, the third DCI includes one New Data Indication (NDI) field or two NDI fields, and in a case where the third DCI includes two NDI fields, each NDI field corresponds to one TB respectively. For example, the third DCI includes a first NDI field and/or a second NDI field; the first NDI field and the second NDI field corresponding respectively to a first one of TBs and a second one of TBs in a case where the third DCI includes the first NDI field and the second NDI field. Thereby, a TB may be indicated via an NDI field.

In the above embodiments, a value/values of the first NDI field and/or the second NDI field is/are 0 or 1.

In some embodiments, in a case where CRC of the third DCI is scrambled by a CS-RNTI, the number of bits included in the first NDI field and/or the second NDI field may be determined according to at least one of the following, i.e.:
the maximum number of PUSCHs which may be scheduled by the third DCI (i.e., the maximum number of SLIVs included in a row in a TDRA table corresponding to the third DCI);
the number of PUSCHs scheduled by the third DCI (i.e., the number of SLIVs included in a row indicated by the third DCI);
the number of valid PUSCHs scheduled by the third DCI (i.e., the number of valid SLIVs included in a row indicated by the third DCI).

Thereby, the first NDI field and/or the second NDI field may include one bit, or may include more than one bit, which specifically depends on at least one of the above determining factors.

In some other embodiments, in a case where CRC of the third DCI is scrambled by a CS-RNTI, the first NDI field and/or the second NDI field only have/has one bit. For example, when two TBs are configured, the third DCI includes one NDI field which is one bit; or the third DCI includes two NDI fields, and the number of bits of the NDI field corresponding to each TB is 1. In this embodiment, the number of bits of the NDI field does not depend on the determining factors in the preceding embodiments.

In some embodiments, one row or more than one row in a TDRA table corresponding to the third DCI includes more than one SLIV, the more than one SLIV corresponding to more than one PUSCH, thereby realizing scheduling of more than one PUSCH via the third DCI.

In the above embodiments, in some implementations, the third DCI described above is not used to schedule retransmission of a CG, i.e., a terminal equipment does not expect CRC of this third DCI to be scrambled by a CS-RNTI; in some implementations, a value/values of the first NDI field and/or the second NDI field of the third DCI is/are 1; in some implementations, the third DCI schedules more than one PUSCH; in some implementations, the third DCI schedules more than one valid PUSCH; in some implementations, an NDI field (the first NDI field and/or the second NDI field) of the third DCI includes more than one bit with a value being 1; in some implementations, a HARQ process ID corresponding to more than one PUSCH scheduled by the third DCI is one of one or more than one HARQ process configured for CG configuration; in some implementations, a HARQ process ID corresponding to one or more than one PUSCH scheduled by the third DCI is not one of one or more than one HARQ process configured for CG configuration. The above implementations may be implemented separately or be combined arbitrarily.

In the above embodiments, a value/values of the first NDI field and/or the second NDI field is/are 1, which includes but is not limited to:
the first NDI field includes one bit, a value of the one bit is 1; or,
the first NDI field includes more than one bit, a value of one or more than one specific bit of the first NDI field is 1, or, a value of at least one bit of the first NDI field is 1, or, values of all bits of the first NDI field are 1; or,
the second NDI field includes one bit, a value of the one bit is 1; or,
the second NDI field includes more than one bit, a value of one or more than one specific bit of the second NDI field is 1, or, a value of at least one bit of the second NDI field is 1, or, values of all bits of the second NDI field are 1.

In the embodiments of the present disclosure, in some embodiments, CRC of the third DCI is scrambled by a CS-RNTI, the third DCI only schedules one PUSCH (i.e., the third DCI indicates row/rows with a corresponding TDRA table includes one SLIV), and a terminal equipment only transmits the one PUSCH.

For example, in a case where the TDRA table is configured for DCI format 0_1 (the third DCI), if a UE receives DCI format 0_1 with CRC scrambled by a CS-RNTI and NDI=1 (in a case of two TBs, each TB corresponds to one NDI field respectively, both being 1 or an NDI field corresponding to one of them (such as the first one of TBs) being 1), the DCI may only indicate row/rows including one SLIV, cannot indicate row/rows including multiple SLIVs. That is, the DCI may only indicate or schedule one PUSCH.

In this example, a HARQ process ID indicated in the DCI may correspond to this PUSCH. The HARQ process ID may be configured in a HARQ process group for CG configuration, but the present disclosure is not limited to this, the HARQ process ID indicated in the DCI may further have other implementations, as described for details, and the description is omitted here.

In the embodiments of the present disclosure, in some embodiments, CRC of the third DCI is scrambled by a CS-RNTI, the third DCI schedules more than one PUSCH (i.e., the third DCI indicates row/rows with a corresponding TDRA table includes more than one SLIV).

In the above embodiments, a terminal equipment may determine whether to transmit a PUSCH in more than one PUSCH scheduled by the third DCI according to at least one of the following:
a HARQ process ID to which the PUSCH corresponds;
a value of a bit to which the PUSCH corresponds in an NDI field;
whether the PUSCH collides with a semi-statically configured downlink symbol;
whether the PUSCH collides with an SSB; and
whether the PUSCH collides with CORESET #0.

For example, according to whether a PUSCH conflicts with a semi-statically configured downlink symbol, the terminal equipment only transmits one PUSCH in the more than one PUSCH.

In this example, the one PUSCH may be a first PUSCH or a last PUSCH in said more than one PUSCH, or may be the a sole valid PUSCH in said more than one PUSCH, or may be the a sole PUSCH with a value of a corresponding NDI field being 1, in said more than one PUSCH, or may be the a sole PUSCH whose corresponding HARQ process ID is one of one or HARQ process IDs configured for the CG configuration, in said more than one PUSCH. The present disclosure is not limited to this, said one PUSCH may also be other or any combination of the above.

In some embodiments, the SSB is an SSB configured via RRC signaling (such as ssb-PositionsInBurst in SIB1 or ssb-PositionsInBurst in ServingCellConfigCommon).

In some embodiments, CORECET #0 is configured via a MIB.

This example is illustrated below via specific examples.

In a case where said TDRA table is configured for DCI format 0_1 (the third DCI), if a UE receives DCI format 0_1 with CRC scrambled by a CS-RNTI and NDI=1 or ‘1’s (in a case of two TBs, each TB corresponds to one NDI field respectively, both being 1 or ‘1’s or an NDI field corresponding to one of them (such as the first one of TBs) being 1 or ‘1’s) and row/rows including multiples SLIVs is/are indicated, that is, the DCI may indicate/schedule more than one PUSCH. The UE only transmits one of PUSCHs, such as a first PUSCH or a last PUSCH in a time sequence, and/or the a sole valid PUSCH (such as a PUSCH that does not conflict with a semi-statically configured uplink symbol), and/or the a sole PUSCH whose corresponding NDI bit is 1, and/or a PUSCH whose corresponding HARQ process ID is one of one or more than HARQ process ID for CG configuration.

In this example, a HARQ process ID indicated by the third DCI may correspond to said one PUSCH (regardless of whether this PUSCH is a first PUSCH); or the HARQ process ID indicated by the third DCI corresponds to a first valid PUSCH in said more than one PUSCH, and a terminal equipment determines a HARQ process ID corresponding to said one PUSCH according to the HARQ process ID (regardless of whether this PUSCH is a first PUSCH).

In this example, the HARQ process ID corresponding to said one PUSCH may be one of one or more than one HARQ process ID for CG configuration, i.e., in a HARQ process ID group configured for the CG configuration.

In this example, said one PUSCH may be a valid PUSCH.

In this example, said first PUSCH may be a first PUSCH scheduled by the third DCI or a first valid PUSCH scheduled by the third DCI; similarly, said last PUSCH may be a last PUSCH scheduled by the third DCI or a last valid PUSCH scheduled by the third DCI. The first PUSCH scheduled by the third DCI is a PUSCH (valid PUSCH) corresponding to a first SLIV in a row indicated by the third DCI, similarly, the last PUSCH scheduled by the third DCI is a PUSCH (valid PUSCH) corresponding to a last SLIV in a row indicated by the third DCI.

In this example, for that the UE only transmits the a sole valid PUSCH, i.e., a PUSCH indicated/scheduled by the DCI may only include one valid PUSCH, that is, the UE does not expect that the DCI indicates/schedules more than one valid PUSCH. The UE only transmits the one PUSCH.

In this example, for that the UE only transmits the a sole PUSCH whose corresponding NDI bit is 1, an NDI field in the DCI only includes one bit whose value is 1, that is, the UE does not expect that the NDI field in the DCI includes more than one bit whose value is 1. The UE only transmits the one PUSCH.

In this example, the UE does not transmit an invalid PUSCH, and the invalid PUSCH does not have a corresponding HARQ process ID.

In this example, for other (valid) PUSCH (if any), the UE does not transmit it, or cancels transmission of other (valid) PUSCH. Other (valid) PUSCH corresponds to or does not correspond to a HARQ process ID (or, the UE determines or does not determine a HARQ process ID of other (valid) PUSCH).

For another example, according to a HARQ process ID corresponding to a PUSCH, the terminal equipment only transmits a PUSCH whose corresponding HARQ process ID is one of one or more than one HARQ process ID for CG configuration.

This example is illustrated below via specific examples.

In a case where said TDRA table is configured for DCI format 0_1 (the third DCI), if a UE receives DCI format 0_1 with CRC scrambled by a CS-RNTI and NDI=1 or ‘1’s (in a case of two TBs, each TB corresponds to one NDI field respectively, both being 1 or ‘1’s or an NDI field corresponding to one of them (such as the first one of TBs) being 1 or ‘1’s) and row/rows including multiples SLIVs is/are indicated, the DCI may indicate/schedule more than one PUSCH. The UE only transmits a PUSCH whose corresponding HARQ process ID is in a HARQ process group configured for CG configuration.

In this example, the HARQ process ID indicated in the DCI corresponds to a first valid PUSCH, and the UE determines a HARQ process ID of the valid PUSCH according to this indication.

In this example, the UE does not transmit a PUSCH whose corresponding HARQ process ID is not in a HARQ process group configured for CG configuration.

In this example, the UE does not transmit an invalid PUSCH, and the invalid PUSCH does not have a corresponding HARQ process ID.

For another example, according to a HARQ process ID corresponding to a PUSCH, the terminal equipment transmits all valid PUSCHs in said more than one PUSCH.

In one example, a HARQ process ID corresponding to the all valid PUSCHs must be one of one or more than one HARQ process ID for CG configuration.

This example is illustrated below via specific examples.

In a case where said TDRA table is configured for DCI format 0_1 (the third DCI), if a UE receives DCI format 0_1 with CRC scrambled by a CS-RNTI and NDI=1 or ‘1’s (in a case of two TBs, each TB corresponds to one NDI field respectively, both being 1 or ‘1’s or an NDI field corresponding to one of them (such as the first one of TBs) being 1 or ‘1’s) and row/rows including multiples SLIVs is/are indicated, the DCI may indicate/schedule more than one PUSCH. HARQ process ID(s) corresponding to valid PUSCH(s) included in more than one PUSCH indicated/scheduled by the DCI must be in a HARQ process group configured for CG configuration. That is, the UE does not expect that HARQ process ID(s) corresponding to any one valid PUSCH indicated/scheduled by the DCI is not in HARQ process group configured for CG configuration.

In another example, a PUSCH with a corresponding HARQ process ID being not one of one or more than one HARQ process ID for CG configuration and/or a value of a bit in a corresponding NDI field being 0, is initial transmission.

This example is illustrated below via specific examples.

In a case where said TDRA table is configured for DCI format 0_1 (the third DCI), if a UE receives DCI format 0_1 with CRC scrambled by a CS-RNTI and NDI=1 or ‘1’s and row/rows including multiples SLIVs is/are indicated, the DCI may indicate/schedule more than one PUSCH. The UE transmits all valid PUSCHs, and for PUSCH(s) whose corresponding HARQ process ID(s) is/are not in a HARQ process group configured for CG configuration, the UE considers it/them as initial transmission.

In this example, a HARQ process ID corresponding to a sole or at least one PUSCH in all valid PUSCHs is one of one or more than one HARQ process ID for CG configuration. That is, a sole or at least one of HARQ process ID(s) corresponding to valid PUSCH(s) included in more than one PUSCH indicated/scheduled by the DCI is in a HARQ process group configured for CG configuration. Valid PUSCH(s) corresponding to the HARQ process ID(s) is/are retransmission.

In the above two examples, the HARQ process ID indicated in the DCI corresponds to a first valid PUSCH, and the UE determines HARQ process IDs of the valid PUSCHs according to this indication.

In the above two examples, the UE transmits all valid PUSCHs.

For another example, according to a value of a bit corresponding to a PUSCH in an NDI field, a terminal equipment only transmits a PUSCH with a value of a bit in the corresponding NDI field being 1; or, the terminal equipment transmits all valid PUSCHs, and for the PUSCH with a value of a bit in the corresponding NDI field being 1, it is considered as retransmission, and for a PUSCH with a value of a bit in the corresponding NDI field being 0, it is considered as initial transmission.

This example is illustrated below via specific examples.

In a case where said TDRA table is configured for DCI format 0_1 (the third DCI), if a UE receives DCI format 0_1 with CRC scrambled by a CS-RNTI and a row including multiple SLIVs is indicated, in which an NDI bit corresponding to one or more SLIVs is 1 (in a case of two TBs, each TB corresponds to one NDI field respectively, a corresponding bit of the one or more SLIVs in two NDI fields is 1, or a corresponding bit of one of them (such as the first one of TBs) is 1), i.e., the DCI may indicate/schedule more than one PUSCH, and an NDI bit corresponding to one or more PUSCHs is 1.

In this example, the UE only transmits a PUSCH with NDI bit=1, or, the UE transmits all valid PUSCHs, and for a PUSCH with NDI bit=0, the UE considers it as initial transmission.

In this example, in an NDI field, a value of a bit corresponding to a sole or at least one PUSCH in all valid PUSCHs is 1.

In the embodiments of the present disclosure, in some embodiments, the terminal equipment may further receive PUSCH configuration (PUSCH-Config) including a third configuration parameter (such as PUSCH-AggregationFactor) used for configuring the number of repetitions, and in a case where CRC of the third DCI is scrambled by a CS-RNTI, the third configuration parameter is applied to the third DCI. That is, in a case where the TDRA table is configured for DCI format 0_1 (the third DCI), when the UE transmits a PUSCH scheduled by DCI format 0_1 with CRC scrambled by a CS-RNTI and NDI=1 or NDI=0, if the PUSCH configuration (PUSCH-Config) includes PUSCH-AggregationFactor, repetition is performed according to the number of times configured by PUSCH-AggregationFactor.

In the above embodiments, that the third configuration parameter is applied to the third DCI refers to: the third configuration parameter is applied to one or more than one PUSCH in PUSCH(s) scheduled by the third DCI.

For example, each PUSCH scheduled by the third DCI is repeated according to the number of times configured by the third configuration parameter, and/or, each valid PUSCH scheduled by the third DCI is repeated according to the number of times configured by the third configuration parameter; and/or, each PUSCH in PUSCHs scheduled by the third DCI and needing to be transmitted by a terminal equipment is repeated according to the number of times configured by the third configuration parameter; and/or, the third DCI only schedules one PUSCH and the one PUSCH is repeated according to the number of times configured by the third configuration parameter; and/or, the terminal equipment only transmits one PUSCH in PUSCHs scheduled by the third DCI, and the one PUSCH is repeated according to the number of times configured by the third configuration parameter.

In the embodiments of the present disclosure, in some embodiments, the terminal equipment may further receive PUSCH configuration (PUSCH-Config) including a third configuration parameter (such as PUSCH-AggregationFactor) used for configuring the number of repetitions, and in a case where CRC of the third DCI is scrambled by a CS-RNTI, the third configuration parameter is not applied to the third DCI.

In the above embodiments, that the third configuration parameter is not applied to the third DCI refers to: the third configuration parameter is not applied to any one of PUSCHs scheduled by the third DCI.

For example, in a case where the TDRA table is configured for DCI format 0_1 (the third DCI), when the UE transmits a PUSCH scheduled by DCI format 0_1 with CRC scrambled by a CS-RNTI and NDI=1 or NDI=0, if the PUSCH configuration (PUSCH-Config) includes PUSCH-AggregationFactor, repetition is not performed according to the number of times configured by PUSCH-AggregationFactor. If the third DCI adopts other DCI format (a TDRA table corresponding to the other format and said TDRA table are different, for example, each row in the TDRA table corresponding to the other format only includes one SLIV), such as DCI format 1_0/1_2, etc., repetition is performed according to the number of times configured by PUSCH-AggregationFactor.

In the above embodiments, in one implementation, a PUSCH scheduled by the third DCI is not repeated, regardless of whether the CG configuration includes said PUSCH-AggregationFactor.

In the above embodiments, in another implementation, if the CG configuration includes said PUSCH-AggregationFactor, a PUSCH scheduled by the third DCI is repeated according to this PUSCH-AggregationFactor.

In this implementation, the terminal equipment may receive CG configuration including a fourth configuration parameter (such as repK) used for configuring the number of repetitions; the fourth configuration parameter is applied to the third DCI.

In this implementation, that the fourth configuration parameter is applied to the third DCI refers to: the fourth configuration parameter is applied to one or more than one PUSCH in PUSCH(s) scheduled by the third DCI.

For example, each PUSCH scheduled by the third DCI is repeated according to the number of times configured by the fourth configuration parameter, and/or, each valid PUSCH scheduled by the third DCI is repeated according to the number of times configured by the fourth configuration parameter; and/or, each PUSCH in PUSCHs scheduled by the third DCI and needing to be transmitted by a terminal equipment is repeated according to the number of times configured by the fourth configuration parameter; and/or, the third DCI only schedules one PUSCH and the one PUSCH is repeated according to the number of times configured by the fourth configuration parameter; and/or, the terminal equipment only transmits one PUSCH in PUSCHs scheduled by the third DCI, and the one PUSCH is repeated according to the number of times configured by the fourth configuration parameter.

In this implementation, the CG configuration ((G-config) is CG configuration corresponding to the PUSCH (a corresponding CG PUSCH). For example, the UE is only configured with one CG-config, this CG-config is CG configuration corresponding to the PUSCH (a corresponding CG PUSCH). For another example, if the UE is only configured with and activated more than one CG configuration, the UE for example determines CG configuration corresponding to the PUSCH (a corresponding CG PUSCH) according to a HARQ process ID corresponding to the PUSCH. For a further example, in a case where the HARQ process ID corresponding to the PUSCH is shared by multiple CG configurations, said PUSCH-AggregationFactor for example refers to a maximum PUSCH-AggregationFactor included in the multiple CG configurations.

In the embodiments of the present disclosure, the CG configuration may further include an information field (or field) use for a base station to indicate/a UE to determine a corresponding range of a HARQ process ID, such as nrofHARQ-Processes, harq-ProcID-Offset, etc.

In the embodiments of the present disclosure, for aggregation/repetition of a CG PUSCH, in some embodiments, the terminal equipment may further receive PUSCH configuration (PUSCH-Config) including a first configuration parameter (such as PUSCH-AggregationFactor) used for configuring the number of repetitions; moreover, the terminal equipment may further receive fourth DCI for activating CG configuration, said third configuration parameter is applied to the fourth DCI, and one row or more than one row in a TDRA table corresponding to the fourth DCI include(s) more than one SLIV.

In the above embodiments, that the third configuration parameter is applied to the fourth DCI refers to: a CG PUSCH corresponding to the fourth DCI is repeated according to said third configuration parameter. The CG PUSCH corresponding to the fourth DCI e.g. refers to a PUSCH (CG PUSCH) scheduled by CG configuration activated by the fourth DCI, or a CG PUSCH activated by the fourth DCI.

For example, in a case where the TDRA table is configured for DCI format 0_1 (the fourth DCI), for a PUSCH (i.e., a CG PUSCH) scheduled by the CG configuration and activated by DCI format 0_1, if the PUSCH configuration (PUSCH-Config) includes PUSCH-AggregationFactor, repetition is performed according to the number of times configured by this PUSCH-AggregationFactor. The CG PUSCH has no corresponding PDCCH which is a PDCCH carrying DCI for scheduling a PUSCH.

In the embodiments of the present disclosure, for aggregation/repetition of a CG PUSCH, in some other embodiments, the terminal equipment may further receive PUSCH configuration (PUSCH-Config) including a third configuration parameter (such as PUSCH-AggregationFactor) used for configuring the number of repetitions; moreover, the terminal equipment may further receive fourth DCI for activating CG configuration, said third configuration parameter is not applied to the fourth DCI, and one row or more than one row in a TDRA table corresponding to the fourth DCI include(s) more than one SLIV.

In the above embodiments, that the third configuration parameter is not applied to the fourth DCI refers to: the third configuration parameter is not applied to any one of CG PUSCHs corresponding to the fourth DCI.

For example, in a case where the TDRA table is configured for DCI format 0_1 (the fourth DCI), for a PUSCH (i.e., a CG PUSCH) scheduled by the CG configuration and activated by DCI format 0_1, if the PUSCH configuration (PUSCH-Config) includes PUSCH-AggregationFactor, repetition is not performed according to the number of times configured by this PUSCH-AggregationFactor. The CG PUSCH has no corresponding PDCCH which is a PDCCH carrying DCI for scheduling a PUSCH. If the fourth DCI adopts other DCI format (a TDRA table corresponding to the other format and said TDRA table are different, for example, each row in the TDRA table corresponding to the other format only includes one SLIV), such as DCI format 1_0/1_2, etc., repetition is performed according to the number of times configured by PUSCH-AggregationFactor.

In the above embodiments, in one implementation, a CG PUSCH corresponding to the fourth DCI is not repeated, regardless of whether the CG configuration includes said PUSCH-AggregationFactor.

In the above embodiments, in another implementation, if the CG configuration includes said PUSCH-AggregationFactor, a CG PUSCH corresponding to the fourth DCI is repeated according to this PUSCH-AggregationFactor.

In this implementation, the terminal equipment may receive CG configuration including a fourth configuration parameter (such as repK) used for configuring the number of repetitions; the fourth configuration parameter is applied to the fourth DCI.

In this implementation, that the fourth configuration parameter is applied to the fourth DCI refers to: the fourth configuration parameter is applied to one or more than one CG PUSCH in CG PUSCH(s) corresponding to the fourth DCI.

For example, each CG PUSCH corresponding to the fourth DCI is repeated according to the number of times configured by the fourth configuration parameter, and/or, each valid CG PUSCH corresponding to the fourth DCI is repeated according to the number of times configured by the fourth configuration parameter; and/or, each CG PUSCH in CG PUSCHs corresponding to the fourth DCI and needing to be transmitted by a terminal equipment is repeated according to the number of times configured by the fourth configuration parameter; and/or, the fourth DCI only corresponds to one CG PUSCH and the one CG PUSCH is repeated according to the number of times configured by the fourth configuration parameter; and/or, the terminal equipment only transmits one CG PUSCH in CG PUSCHs corresponding to the fourth DCI, and the one CG PUSCH is repeated according to the number of times configured by the fourth configuration parameter.

The above embodiments are only illustrative for the embodiments of the present disclosure, but the present disclosure is not limited to this, appropriate modifications can be also made based on the above embodiments. For example, each of the above embodiments may be used individually, or one or more of the above embodiments may be combined.

In the embodiments of the present disclosure, the terminal equipment may further receive a PDCCH/DCI for activating/deactivating a CG, for example, the terminal equipment may confirm the validity of the PDCCH/DCI according to one or more of the following:
1. being scrambled by a CS-RNTI (more specifically, CRC of a corresponding DCI format is scrambled by a CS-RNTI);
2. an NDI field is set to be ‘0’;
3. a DFI field is set to be ‘0’ if there is a DFI field;
4. For activation, if there is a PUSCH-to-HARQ feedback timing indicator field, this field cannot provide an inapplicable value (such as −1);
5. TDRA configuration/row/row index indicated by a time domain resource assignment field includes/corresponds to a sole PUSCH/SLIV (If a TDRA table applied by a corresponding DCI format includes at least one row of TDRA configuration including more than one SLIV configuration, or DCI format 1_1).

In the embodiments of the present disclosure, for CG activation, if a sole configuration for an CG PUSCH is provided, the validity of the DCI may further depend on a HARQ process number field and a RV field.

For the RV field, if a TDRA table applied by a DCI format (such as DCI format 1_1) corresponding to the DCI includes at least one row of TDRA configuration including more than one SLIV configuration, and in a case where the TDRA configuration indicated by a time domain resource assignment field only includes/corresponds to one PDSCH, a Redundancy version field corresponding to one TB in the DCI includes 2 bits. In a case where the DCI format configures one TB, the DCI only includes one Redundancy version field, bits of the Redundancy version field are all set to ‘0’ or ‘1’. In a case where the DCI format configures two TBs, the DCI includes Redundancy version fields corresponding to the two TBs respectively (one-to-one correspondence), bits of the Redundancy version fields corresponding to the two TBs respectively are all set to ‘0’ or ‘1’; or, bits of a Redundancy version field corresponding to one TB (such as a first one of TBs) are all set to ‘O’, bits of a Redundancy version field corresponding to the other TB (such as a second one of TBs) are all set to ‘1’. For example, (in a case where a CG only supports one TB,) the first one of TBs is enabled, and the second one of TBs is disabled, bits of a Redundancy version field corresponding to the first one of TBs are all set to ‘0’, bits of a Redundancy version field corresponding to the second one of TBs are all set to ‘1’. For another example, (in a case where a CG only supports two TBs,) bits of Redundancy version fields corresponding to the two TBs respectively are all set to ‘0’ or ‘1’. As shown in the above Table 2.

In addition, if more than one configuration for the CG PUSCH are provided, the validity of the DCI further depends on a RV field. Further explanation of the RV field settings is the same as the above-mentioned activation case of a sole configuration for the CG PUSCH. As shown in the above Table 3.

On the other hand, (for a case where more than one configuration for the CG PUSCH are provided,) a HARQ process number field is used to indicate a CG configuration index activated by the DCI. The CG configuration index may associate with/correspond to one or more configurations for the CG PUSCH.

In the embodiments of the present disclosure, for CG deactivation, if a sole configuration for a CG PUSCH is provided (or, a sole CG PUSCH is configured), the validity of the DCI may further depend on a HARQ process number field, a RV field, a modulation and coding scheme field and a frequency domain resource assignment field.

For the RV field, if a TDRA table applied by a DCI format (such as DCI format 1_1) corresponding to the DCI includes at least one row of TDRA configuration including more than one SLIV configuration, and in a case where the TDRA configuration indicated in the DCI only includes/corresponds to one PDSCH, a Redundancy version field corresponding to one TB in the DCI includes 2 bits. In a case where the DCI format configures one TB, the DCI only includes one Redundancy version field, bits of the Redundancy version field are all set to ‘0’ or ‘1’. In a case where the DCI format configures two TBs, the DCI includes Redundancy version fields corresponding to the two TBs respectively (one-to-one correspondence), bits of the Redundancy version fields corresponding to the two TBs respectively are all set to ‘0’ or ‘1’. As shown in the above Table 4.

If more than one configuration for the CG PUSCH are provided, the validity of the DCI may further depend on a RV field, a modulation and coding scheme field and a frequency domain resource assignment field. Further explanation of the RV field settings is the same as the above-mentioned deactivation case of a sole configuration for the CG PUSCH. As shown in the above Table 5.

On the other hand, (for a case where more than one configuration for the CG PUSCH are provided,) a HARQ process number field is used to indicate a CG configuration index deactivated by the DCI. The CG configuration index may associate with/correspond to one or more configurations for the CG PUSCH.

According to the method in the embodiments of the present disclosure, scheduling of more than one PUSCH via one DCI can be supported, further, semi-static scheduling or semi-persistent scheduling of the PUSCH in a case where one DCI (or DCI format) may schedule more than one PUSCH can be supported, and dynamic retransmission for data corresponding to the semi-static scheduling or semi-persistent scheduling is supported.

### Embodiments of a Fourth Aspect

The embodiments of the present disclosure provide a data scheduling method, which will be described from a network device side. The method relates to processing on a network device side corresponding to the method in the embodiments of the third aspect, wherein the same contents as the embodiments of the third aspect are not repeated.

FIG. 5 is a schematic diagram of a data scheduling method in the embodiments of the present disclosure. As shown in FIG. 5, the method includes:

501: a network device transmits third downlink control information, the third downlink control information being used to schedule PUSCHs, the number of the PUSCHs being one or more.

In some embodiments, in a case where the network device receives more than one PUSCH in PUSCHs scheduled by third downlink control information, data carried by different PUSCHs in the more than one PUSCH are different.

In some embodiments, the third downlink control information is DCI format 0_1.

In some embodiments, the third downlink control information includes a first NDI field and/or a second NDI field; the first NDI field and the second NDI field corresponding respectively to a first one of TBs and a second one of TBs in a case where the third downlink control information includes the first NDI field and the second NDI field.

In some embodiments, a value/values of the first NDI field and/or the second NDI field is/are 0 or 1.

In some embodiments, the number of bits included in the first NDI field and/or the second NDI field is determined according to at least one of the following:
the maximum number of PUSCHs that can be scheduled by the third downlink control information;
the number of PUSCHs scheduled by the third downlink control information;
the number of valid PUSCHs scheduled by the third downlink control information.

In some embodiments, in a case where CRC of the third downlink control information is scrambled by a CS-RNTI, the first NDI field and/or the second NDI field include(s) one bit, or the first NDI field and/or the second NDI field include(s) more than one bit; in a case where the first NDI field and/or the second NDI field include(s) more than one bit, a sole bit is valid, or more than one bit are valid, or all bits are valid.

In some embodiments, one or more than one row in a TDRA table to which the third downlink control information corresponds include(s) more than one SLIV.

In some embodiments, the third downlink control information schedules one PUSCH, and/or, a value/values of a first NDI field and/or a second NDI field of the third downlink control information is/are 1, and/or, the third downlink control information schedules more than one PUSCH, and/or, the third downlink control information schedules more than one valid PUSCH, and/or, an NDI field of the third downlink control information includes more than one bit with a value being 1, and/or, HARQ process ID(s) corresponding to more than one PUSCH scheduled by the third downlink control information is/are one of one or more than one HARQ process ID for CG configuration, and/or, HARQ process ID(s) corresponding to one or more than one PUSCH scheduled by the third downlink control information is/are not one of one or more than one HARQ process ID for CG configuration.

In some embodiments, CRC of the third downlink control information is scrambled by a CS-RNTI, and the third downlink control information only schedules one PUSCH.

In some embodiments, CRC of the third downlink control information is scrambled by a CS-RNTI, and the third downlink control information schedules more than one PUSCH, the network device receives one PUSCH of the more than one PUSCH scheduled by the third downlink control information, or, the network device receives a PUSCH whose corresponding HARQ process ID is one of one or more than one HARQ process ID for CG configuration; or, the network device receives all valid PUSCHs in more than one PUSCH scheduled by the third downlink control information; or, the network device receives a PUSCH with a value of a bit in a corresponding NDI field being 1; or, the network device receives all valid PUSCHs, for a PUSCH with a value of a bit in a corresponding NDI field being 1, it is considered as retransmission, and for a PUSCH with a value of bit in a corresponding NDI field being 0, it is considered as initial transmission.

In some embodiments, the one PUSCH is a first PUSCH or a last PUSCH in the more than one PUSCH, and/or, the one PUSCH is the a sole valid PUSCH in the more than one PUSCH, and/or, the one PUSCH is the a sole PUSCH with a value of a corresponding NDI field being 1, in the more than one PUSCH, and/or, the one PUSCH is the a sole PUSCH whose corresponding HARQ process ID is one of one or more than one HARQ process ID for CG configuration, in the more than one PUSCH.

In some embodiments, a HARQ process ID indicated by the third downlink control information corresponds to the one PUSCH; or, a HARQ process ID indicated by the third downlink control information corresponds to a first valid PUSCH in the more than one PUSCH, and the terminal equipment determines a HARQ process ID corresponding to the one PUSCH according to the HARQ process ID.

In some embodiments, the HARQ process ID corresponding to the one PUSCH is one of one or more than one HARQ process ID for CG configuration.

In some embodiments, the one PUSCH is a valid PUSCH.

In some embodiments, the first PUSCH is a first PUSCH scheduled by the third downlink control information or a first valid PUSCH scheduled by the third downlink control information; the last PUSCH is a last PUSCH scheduled by the third downlink control information or a last valid PUSCH scheduled by the third downlink control information.

In some embodiments, a HARQ process ID corresponding to the all valid PUSCHs must be one of one or more than one HARQ process ID for CG configuration.

In some embodiments, a PUSCH with a corresponding HARQ process ID being not one of one or more than one HARQ process ID for CG configuration and/or a value of a bit in a corresponding NDI field being 0, is initial transmission.

In some embodiments, a HARQ process ID corresponding to a sole or at least one PUSCH in the all valid PUSCHs is one of one or more than one HARQ process ID for CG configuration.

In some embodiments, in an NDI field, a value of a bit corresponding to a sole or at least one PUSCH in all valid PUSCHs is 1.

In some embodiments, the method further includes:
the network device transmits PUSCH configuration including a third configuration parameter used for configuring the number of repetitions;
wherein, CRC of the third downlink control information is scrambled by a CS-RNTI, and the third configuration parameter is applied to the third downlink control information.

In some embodiments, that the third configuration parameter is applied to the third downlink control information includes: the third configuration parameter is applied to one or more than one PUSCH in PUSCH(s) scheduled by the third downlink control information.

In some embodiments, each PUSCH scheduled by the third downlink control information is repeated according to the number of times configured by the third configuration parameter, and/or, each valid PUSCH scheduled by the third downlink control information is repeated according to the number of times configured by the third configuration parameter; and/or, each PUSCH in PUSCHs scheduled by the third downlink control information and needing to be transmitted by a terminal equipment is repeated according to the number of times configured by the third configuration parameter; and/or, the third downlink control information only schedules one PUSCH and the one PUSCH is repeated according to the number of times configured by the third configuration parameter; and/or, the terminal equipment only transmits one PUSCH in PUSCHs scheduled by the third downlink control information, and the one PUSCH is repeated according to the number of times configured by the third configuration parameter.

In some embodiments, the method further includes:
the network device transmits PUSCH configuration including a third configuration parameter used for configuring the number of repetitions;
wherein, CRC of the third downlink control information is scrambled by a CS-RNTI, and the third configuration parameter is not applied to the third downlink control information.

In some embodiments, that the third configuration parameter is not applied to the third downlink control information includes: the third configuration parameter is not applied to any one of PUSCHs scheduled by the third downlink control information.

In some embodiments, the method further includes:
the network device transmits CG configuration including a fourth configuration parameter used for configuring the number of repetitions;
wherein, the fourth configuration parameter is applied to the third downlink control information.

In some embodiments, that the fourth configuration parameter is applied to the third downlink control information includes: the fourth configuration parameter is applied to one or more than one PUSCH in PUSCH(s) scheduled by the third downlink control information.

In some embodiments, each PUSCH scheduled by the third downlink control information is repeated according to the number of times configured by the fourth configuration parameter, and/or, each valid PUSCH scheduled by the third downlink control information is repeated according to the number of times configured by the fourth configuration parameter; and/or, each PUSCH in PUSCHs scheduled by the third downlink control information and needing to be transmitted by a terminal equipment is repeated according to the number of times configured by the fourth configuration parameter; and/or, the third downlink control information only schedules one PUSCH and the one PUSCH is repeated according to the number of times configured by the fourth configuration parameter; and/or, the terminal equipment only transmits one PUSCH in PUSCHs scheduled by the third downlink control information, and the one PUSCH is repeated according to the number of times configured by the fourth configuration parameter.

In some embodiments, the method further includes:
the network device transmits PUSCH configuration including a third configuration parameter used for configuring the number of repetitions; and
the network device transmits fourth downlink control information for activating CG configuration, the third configuration parameter being applied to the fourth downlink control information, and one or more than one row in a TDRA table to which the fourth downlink control information corresponds including more than one SLIV.

In some embodiments, that the third configuration parameter is applied to the fourth downlink control information includes: a CG PUSCH corresponding to the fourth downlink control information is repeated according to the third configuration parameter.

In some embodiments, the method further includes:
the network device transmits PUSCH configuration including a third configuration parameter used for configuring the number of repetitions; and
the network device transmits fourth downlink control information for activating CG configuration, the third configuration parameter being not applied to the fourth downlink control information, and one or more than one row in a TDRA table to which the fourth downlink control information corresponds including more than one SLIV.

In some embodiments, that the third configuration parameter is not applied to the fourth downlink control information includes: the third configuration parameter is not applied to any one of CG PUSCHs corresponding to the fourth downlink control information.

In some embodiments, the method further includes:
the network device transmits CG configuration including a fourth configuration parameter used for configuring the number of repetitions;
wherein, the fourth configuration parameter is applied to the fourth downlink control information.

In some embodiments, that the fourth configuration parameter is applied to the fourth downlink control information includes: the fourth configuration parameter is applied to one or more than one CG PUSCH in CG PUSCH(s) corresponding to the fourth downlink control information.

In some embodiments, each CG PUSCH corresponding to the fourth downlink control information is repeated according to the number of times configured by the fourth configuration parameter, and/or, each valid CG PUSCH corresponding to the fourth downlink control information is repeated according to the number of times configured by the fourth configuration parameter; and/or, each CG PUSCH in CG PUSCHs corresponding to the fourth downlink control information and needing to be transmitted by a terminal equipment is repeated according to the number of times configured by the fourth configuration parameter; and/or, the fourth downlink control information only corresponds to one CG PUSCH and the one CG PUSCH is repeated according to the number of times configured by the fourth configuration parameter; and/or, the terminal equipment only transmits one CG PUSCH in CG PUSCHs corresponding to the fourth downlink control information, and the one CG PUSCH is repeated according to the number of times configured by the fourth configuration parameter.

The above embodiments are only illustrative for the embodiments of the present disclosure, but the present disclosure is not limited to this, appropriate modifications can be also made based on the above embodiments. For example, each of the above embodiments may be used individually, or one or more of the above embodiments may be combined.

According to the method in the embodiments of the present disclosure, scheduling of more than one PUSCH via one DCI can be supported, further, semi-static scheduling or semi-persistent scheduling of the PUSCH in a case where one DCI (or DCI format) may schedule more than one PUSCH can be supported, and dynamic retransmission for data corresponding to the semi-static scheduling or semi-persistent scheduling is supported. Moreover, for a network device, the flexibility of configuration and resource scheduling may also be improved.

### Embodiments of a Fifth Aspect

The embodiments of the present disclosure provide a data receiving apparatus. The apparatus may, for example, be a terminal equipment, or may be one or more parts or components configured in the terminal equipment. The apparatus in the embodiments of the present disclosure corresponds to the method in the embodiments of the first aspect, the contents same as those in the embodiments of the first aspect are not repeated.

FIG. 6 is a schematic diagram of an example of a data receiving apparatus in the embodiments of the present disclosure. As shown in FIG. 6, the data receiving apparatus 600 includes:
a first receiving unit 601 configured to receive first downlink control information, the first downlink control information being used to schedule PDSCHs; and
a second receiving unit 602 configured to receive one or more than one PDSCH in the PDSCHs scheduled by the first downlink control information.

In some embodiments, in a case where the second receiving unit 602 receives more than one PDSCH in PDSCHs scheduled by first downlink control information, data carried by different PDSCHs in the more than one PDSCH are different.

In some embodiments, the first downlink control information is DCI format 1_1.

In some embodiments, the first downlink control information includes a first NDI field and/or a second NDI field; the first NDI field and the second NDI field corresponding respectively to a first one of TBs and a second one of TBs in a case where the first downlink control information includes the first NDI field and the second NDI field.

In some embodiments, a value/values of the first NDI field and/or the second NDI field is/are 0 or 1.

In some embodiments, the number of bits included in the first NDI field and/or the second NDI field is determined according to at least one of the following:
the maximum number of PDSCHs that can be scheduled by the first downlink control information;
the number of PDSCHs scheduled by the first downlink control information;
the number of valid PDSCHs scheduled by the first downlink control information.

In some embodiments, in a case where CRC of the first downlink control information is scrambled by a CS-RNTI, the first NDI field and/or the second NDI field include(s) one bit, or the first NDI field and/or the second NDI field include(s) more than one bit; in a case where the first NDI field and/or the second NDI field include(s) more than one bit, a sole bit is valid, or more than one bit are valid, or all bits are valid.

In some embodiments, one or more than one row in a TDRA table to which the first downlink control information corresponds include(s) more than one SLIV.

In some embodiments, the terminal equipment does not expect that CRC of the first downlink control information is scrambled by a CS-RNTI, and/or, a value/values of a first NDI field and/or a second NDI field of the first downlink control information is/are 1, and/or, the first downlink control information schedules more than one PDSCH, and/or, the first downlink control information schedules more than one valid PDSCH, and/or, an NDI field of the first downlink control information includes more than one bit with a value being 1, and/or, HARQ process ID(s) corresponding to more than one PDSCH scheduled by the first downlink control information is/are one of one or more than one HARQ process ID for SPS configuration, and/or, HARQ process ID(s) corresponding to one or more than one PDSCH scheduled by the first downlink control information is/are not one of one or more than one HARQ process ID for SPS configuration.

In some embodiments, CRC of the first downlink control information is scrambled by a CS-RNTI, the first downlink control information only schedules one PDSCH, and the terminal equipment receives the one PDSCH.

In some embodiments, CRC of the first downlink control information is scrambled by a CS-RNTI, and the first downlink control information schedules more than one PDSCH.

In the above embodiments, the second receiving unit 602 determines whether to receive PDSCH(s) in the more than one PDSCH scheduled by the first downlink control information according to at least one of the following:
a HARQ process ID to which the PDSCH corresponds;
a value of a bit to which the PDSCH corresponds in an NDI field; and
whether the PDSCH collides with a semi-statically configured uplink symbol.

In some embodiments, the second receiving unit 602 only receives one PDSCH in the more than one PDSCH.

For example, the one PDSCH is a first PDSCH or a last PDSCH in the more than one PDSCH, and/or, the one PDSCH is the a sole valid PDSCH in the more than one PDSCH, and/or, the one PDSCH is the a sole PDSCH with a value of a corresponding NDI field being 1, in the more than one PDSCH, and/or, the one PDSCH is the a sole PDSCH whose corresponding HARQ process ID is one of one or more than one HARQ process ID for SPS configuration, in the more than one PDSCH.

In some embodiments, a HARQ process ID indicated by the first downlink control information corresponds to the one PDSCH; or, a HARQ process ID indicated by the first downlink control information corresponds to a first valid PDSCH in the more than one PDSCH, and the terminal equipment determines a HARQ process ID corresponding to the one PDSCH according to the HARQ process ID.

In some embodiments, the HARQ process ID corresponding to the one PDSCH is one of one or more than one HARQ process ID for SPS configuration.

In some embodiments, the one PDSCH is a valid PDSCH.

In some embodiments, the first PDSCH is a first PDSCH scheduled by the first downlink control information or a first valid PDSCH scheduled by the first downlink control information; the last PDSCH is a last PDSCH scheduled by the first downlink control information or a last valid PDSCH scheduled by the first downlink control information.

In some other embodiments, the second receiving unit 602 only receives a PDSCH whose corresponding HARQ process ID is one of one or more than one HARQ process ID for SPS configuration.

In some further embodiments, the second receiving unit 602 receives all valid PDSCHs in the more than one PDSCH.

In some embodiments, a HARQ process ID corresponding to the all valid PDSCHs must be one of one or more than one HARQ process ID for SPS configuration.

In some embodiments, a PDSCH with a corresponding HARQ process ID being not one of one or more than one HARQ process ID for SPS configuration and/or a value of a bit in a corresponding NDI field being 0, is initial transmission.

In some embodiments, a HARQ process ID corresponding to a sole or at least one PDSCH in the all valid PDSCHs is one of one or more than one HARQ process ID for SPS configuration.

In some further embodiments, the second receiving unit 602 only receives a PDSCH with a value of a bit in the corresponding NDI field being 1; or, the second receiving unit 602 receives all valid PDSCHs, and for the PDSCH with a value of a bit in a corresponding NDI field being 1, it is considered as retransmission, and for a PDSCH with a value of a bit in a corresponding NDI field being 0, it is considered as initial transmission.

In some embodiments, in an NDI field, a value of a bit corresponding to a sole or at least one PDSCH in all valid PDSCHs is 1.

In some embodiments, as shown in FIG. 6, the apparatus 600 further includes:
a third receiving unit 603 configured to receive PDSCH configuration including a first configuration parameter used for configuring the number of repetitions; CRC of the first downlink control information is scrambled by a CS-RNTI, and the first configuration parameter is applied to the first downlink control information.

In some embodiments, that the first configuration parameter is applied to the first downlink control information includes: the first configuration parameter is applied to one or more than one PDSCH in PDSCH(s) scheduled by the first downlink control information.

For example, each PDSCH scheduled by the first downlink control information is repeated according to the number of times configured by the first configuration parameter, and/or, each valid PDSCH scheduled by the first downlink control information is repeated according to the number of times configured by the first configuration parameter; and/or, each PDSCH in PDSCHs scheduled by the first downlink control information and needing to be received by a terminal equipment is repeated according to the number of times configured by the first configuration parameter; and/or, the first downlink control information only schedules one PDSCH and the one PDSCH is repeated according to the number of times configured by the first configuration parameter; and/or, the terminal equipment only receives one PDSCH in PDSCHs scheduled by the first downlink control information, and the one PDSCH is repeated according to the number of times configured by the first configuration parameter.

In some embodiments, as shown in FIG. 6, the apparatus 600 further includes:
a fourth receiving unit 604 configured to receive PDSCH configuration including a first configuration parameter used for configuring the number of repetitions; CRC of the first downlink control information is scrambled by a CS-RNTI, and the first configuration parameter is not applied to the first downlink control information.

In some embodiments, that the first configuration parameter is not applied to the first downlink control information includes: the first configuration parameter is not applied to any one of PDSCHs scheduled by the first downlink control information.

In some embodiments, as shown in FIG. 6, the apparatus 600 further includes:
a fifth receiving unit 605 configured to receive SPS configuration including a second configuration parameter used for configuring the number of repetitions; the second configuration parameter is applied to the first downlink control information.

In some embodiments, that the second configuration parameter is applied to the first downlink control information includes: the second configuration parameter is applied to one or more than one PDSCH in PDSCH(s) scheduled by the first downlink control information.

For example, each PDSCH scheduled by the first downlink control information is repeated according to the number of times configured by the second configuration parameter, and/or, each valid PDSCH scheduled by the first downlink control information is repeated according to the number of times configured by the second configuration parameter; and/or, each PDSCH in PDSCHs scheduled by the first downlink control information and needing to be received by a terminal equipment is repeated according to the number of times configured by the second configuration parameter; and/or, the first downlink control information only schedules one PDSCH and the one PDSCH is repeated according to the number of times configured by the second configuration parameter; and/or, the terminal equipment only receives one PDSCH in PDSCHs scheduled by the first downlink control information, and the one PDSCH is repeated according to the number of times configured by the second configuration parameter.

In some other embodiments, as shown in FIG. 6, the apparatus 600 further includes:
a sixth receiving unit 606 configured to receive PDSCH configuration including a first configuration parameter used for configuring the number of repetitions; and
a seventh receiving unit 607 configured to receive second downlink control information for activating SPS configuration, the first configuration parameter being applied to the second downlink control information, and one or more than one row in a TDRA table to which the second downlink control information corresponds including more than one SLIV.

In some embodiments, that the first configuration parameter is applied to the second downlink control information includes: a SPS PDSCH corresponding to the second downlink control information is repeated according to the first configuration parameter.

In some further embodiments, as shown in FIG. 6, the apparatus 600 further includes:
an eighth receiving unit 608 configured to receive PDSCH configuration including a first configuration parameter used for configuring the number of repetitions; and a ninth receiving unit 609 configured to receive second downlink control information for activating SPS configuration, the first configuration parameter being not applied to the second downlink control information, and one or more rows in a TDRA table to which the second downlink control information corresponds including more than one SLIV.

In some embodiments, that the first configuration parameter is not applied to the second downlink control information includes: the first configuration parameter is not applied to any one of SPS PDSCHs corresponding to the second downlink control information.

In some embodiments, as shown in FIG. 6, the apparatus 600 further includes:
a tenth receiving unit 610 configured to receive SPS configuration including a second configuration parameter used for configuring the number of repetitions; the second configuration parameter is applied to the second downlink control information.

In some embodiments, that the second configuration parameter is applied to the second downlink control information includes: the second configuration parameter is applied to one or more than one SPS PDSCH in SPS PDSCH(s) corresponding to the second downlink control information.

For example, each SPS PDSCH corresponding to the second downlink control information is repeated according to the number of times configured by the second configuration parameter, and/or, each valid SPS PDSCH corresponding to the second downlink control information is repeated according to the number of times configured by the second configuration parameter; and/or, each SPS PDSCH in SPS PDSCHs corresponding to the second downlink control information and needing to be received by a terminal equipment is repeated according to the number of times configured by the second configuration parameter; and/or, the second downlink control information only corresponds to one SPS PDSCH and the one SPS PDSCH is repeated according to the number of times configured by the second configuration parameter; and/or, the terminal equipment only receives one SPS PDSCH in SPS PDSCHs corresponding to the second downlink control information, and the one SPS PDSCH is repeated according to the number of times configured by the second configuration parameter.

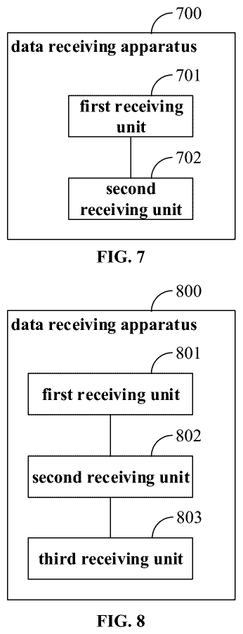

FIG. 7 is a schematic diagram of another example of a data receiving apparatus in the embodiments of the present disclosure. As shown in FIG. 7, the data receiving apparatus 700 includes:
a first receiving unit 701 configured to receive PDSCH configuration including a first configuration parameter used for configuring the number of repetitions; and
a second receiving unit 702 configured to receive second downlink control information for activating SPS configuration, the first configuration parameter being applied to the second downlink control information, and one or more than one row in a TDRA table to which the second downlink control information corresponds including more than one SLIV.

In some embodiments, that the first configuration parameter is applied to the second downlink control information includes: a SPS PDSCH corresponding to the second downlink control information is repeated according to the first configuration parameter.

FIG. 8 is a schematic diagram of a further example of a data receiving apparatus in the embodiments of the present disclosure. As shown in FIG. 8, the data receiving apparatus 800 includes:
a first receiving unit 801 configured to receive PDSCH configuration including a first configuration parameter used for configuring the number of repetitions; and
a second receiving unit 802 configured to receive second downlink control information for activating SPS configuration, the first configuration parameter being not applied to the second downlink control information, and one or more rows in a TDRA table to which the second downlink control information corresponds including more than one SLIV.

In some embodiments, that the first configuration parameter is not applied to the second downlink control information includes: the first configuration parameter is not applied to any one of SPS PDSCHs corresponding to the second downlink control information.

In some embodiments, as shown in FIG. 8, the apparatus 800 further includes:
a third receiving unit 803 configured to receive SPS configuration including a second configuration parameter used for configuring the number of repetitions; the second configuration parameter is applied to the second downlink control information.

In some embodiments, that the second configuration parameter is applied to the second downlink control information includes: the second configuration parameter is applied to one or more than one SPS PDSCH in SPS PDSCH(s) corresponding to the second downlink control information.

For example, each SPS PDSCH corresponding to the second downlink control information is repeated according to the number of times configured by the second configuration parameter, and/or, each valid SPS PDSCH corresponding to the second downlink control information is repeated according to the number of times configured by the second configuration parameter; and/or, each SPS PDSCH in SPS PDSCHs corresponding to the second downlink control information and needing to be received by a terminal equipment is repeated according to the number of times configured by the second configuration parameter; and/or, the second downlink control information only corresponds to one SPS PDSCH and the one SPS PDSCH is repeated according to the number of times configured by the second configuration parameter; and/or, the terminal equipment only receives one SPS PDSCH in SPS PDSCHs corresponding to the second downlink control information, and the one SPS PDSCH is repeated according to the number of times configured by the second configuration parameter.

The embodiments of the present disclosure further provide a data scheduling apparatus. The apparatus may, for example, be a network device, or may be one or more parts or components configured in the network device. The apparatus in the embodiments of the present disclosure corresponds to the method in the embodiments of the second aspect, the contents same as those in the embodiments of the second aspect are not repeated.

FIG. 9 is a schematic diagram of an example of a data scheduling apparatus in the embodiments of the present disclosure. As shown in FIG. 9, the data scheduling apparatus 900 includes:
a first transmitting unit 901 configured to transmit first downlink control information, the first downlink control information being used to schedule PDSCHs, the number of the PDSCHs being one or more.

In some embodiments, in a case where the network device transmits more than one PDSCH in PDSCHs scheduled by first downlink control information, data carried by different PDSCHs in the more than one PDSCH are different.

In some embodiments, the first downlink control information is DCI format 1_1.

In some embodiments, the first downlink control information includes a first NDI field and/or a second NDI field; the first NDI field and the second NDI field corresponding respectively to a first one of TBs and a second one of TBs in a case where the first downlink control information includes the first NDI field and the second NDI field.

In some embodiments, a value/values of the first NDI field and/or the second NDI field is/are 0 or 1.

In some embodiments, the number of bits included in the first NDI field and/or the second NDI field is determined according to at least one of the following:
the maximum number of PDSCHs that can be scheduled by the first downlink control information;
the number of PDSCHs scheduled by the first downlink control information;
the number of valid PDSCHs scheduled by the first downlink control information.

In some embodiments, in a case where CRC of the first downlink control information is scrambled by a CS-RNTI, the first NDI field and/or the second NDI field include(s) one bit, or the first NDI field and/or the second NDI field include(s) more than one bit; in a case where the first NDI field and/or the second NDI field include(s) more than one bit, a sole bit is valid, or more than one bit are valid, or all bits are valid.

In some embodiments, one or more than one row in a TDRA table to which the first downlink control information corresponds include(s) more than one SLIV.

In some embodiments, the first downlink control information schedules one PDSCH, and/or, a value/values of a first NDI field and/or a second NDI field of the first downlink control information is/are 1, and/or, the first downlink control information schedules more than one PDSCH, and/or, the first downlink control information schedules more than one valid PDSCH, and/or, an NDI field of the first downlink control information includes more than one bit with a value being 1, and/or, HARQ process ID(s) corresponding to more than one PDSCH scheduled by the first downlink control information is/are one of one or more than one HARQ process ID for SPS configuration, and/or, HARQ process ID(s) corresponding to one or more than one PDSCH scheduled by the first downlink control information is/are not one of one or more than one HARQ process ID for SPS configuration.

In some embodiments, CRC of the first downlink control information is scrambled by a CS-RNTI, and the first downlink control information only schedules one PDSCH.

In some embodiments, CRC of the first downlink control information is scrambled by a CS-RNTI, and the first downlink control information schedules more than one PDSCH, the network device transmits one PDSCH of the more than one PDSCH scheduled by the first downlink control information, or, the network device transmits a PDSCH whose corresponding HARQ process ID is one of one or more than one HARQ process ID for SPS configuration; or, the network device transmits all valid PDSCHs in more than one PDSCH scheduled by the first downlink control information; or, the network device transmits a PDSCH with a value of a bit in a corresponding NDI field being 1; or, the network device transmits all valid PDSCHs, for a PDSCH with a value of a bit in a corresponding NDI field being 1, it is considered as retransmission, and for a PDSCH with a value of a bit in a corresponding NDI field being 0, it is considered as initial transmission.

In some embodiments, the one PDSCH is a first PDSCH or a last PDSCH in the more than one PDSCH, and/or, the one PDSCH is the a sole valid PDSCH in the more than one PDSCH, and/or, the one PDSCH is the a sole PDSCH with a value of a corresponding NDI field being 1, in the more than one PDSCH, and/or, the one PDSCH is the a sole PDSCH whose corresponding HARQ process ID is one of one or more than one HARQ process ID for SPS configuration, in the more than one PDSCH.

In some embodiments, a HARQ process ID indicated by the first downlink control information corresponds to the one PDSCH; or, a HARQ process ID indicated by the first downlink control information corresponds to a first valid PDSCH in the more than one PDSCH, and the terminal equipment determines a HARQ process ID corresponding to the one PDSCH according to the HARQ process ID.

In some embodiments, the HARQ process ID corresponding to the one PDSCH is one of one or more than one HARQ process ID for SPS configuration.

In some embodiments, the one PDSCH is a valid PDSCH.

In some embodiments, the first PDSCH is a first PDSCH scheduled by the first downlink control information or a first valid PDSCH scheduled by the first downlink control information; the last PDSCH is a last PDSCH scheduled by the first downlink control information or a last valid PDSCH scheduled by the first downlink control information.

In some embodiments, a HARQ process ID corresponding to the all valid PDSCHs must be one of one or more than one HARQ process ID for SPS configuration.

In some embodiments, a PDSCH with a corresponding HARQ process ID being not one of one or more than one HARQ process ID for SPS configuration and/or a value of a bit in a corresponding NDI field being 0, is initial transmission.

In some embodiments, a HARQ process ID corresponding to a sole or at least one PDSCH in the all valid PDSCHs is one of one or more than one HARQ process ID for SPS configuration.

In some embodiments, in an NDI field, a value of a bit corresponding to a sole or at least one PDSCH in all valid PDSCHs is 1.

In some embodiments, as shown in FIG. 9, the apparatus 900 further includes:
a second transmitting unit 902 configured to transmit PDSCH configuration including a first configuration parameter used for configuring the number of repetitions; CRC of the first downlink control information is scrambled by a CS-RNTI, and the first configuration parameter is applied to the first downlink control information.

In some embodiments, that the first configuration parameter is applied to the first downlink control information includes: the first configuration parameter is applied to one or more than one PDSCH in PDSCH(s) scheduled by the first downlink control information.

In some embodiments, each PDSCH scheduled by the first downlink control information is repeated according to the number of times configured by the first configuration parameter, and/or, each valid PDSCH scheduled by the first downlink control information is repeated according to the number of times configured by the first configuration parameter; and/or, each PDSCH in PDSCHs scheduled by the first downlink control information and needing to be received by a terminal equipment is repeated according to the number of times configured by the first configuration parameter; and/or, the first downlink control information only schedules one PDSCH and the one PDSCH is repeated according to the number of times configured by the first configuration parameter; and/or, the terminal equipment only receives one PDSCH in PDSCHs scheduled by the first downlink control information, and the one PDSCH is repeated according to the number of times configured by the first configuration parameter.

In some embodiments, as shown in FIG. 9, the apparatus 900 further includes:
a third transmitting unit 903 configured to transmit PDSCH configuration including a first configuration parameter used for configuring the number of repetitions; CRC of the first downlink control information is scrambled by a CS-RNTI, and the first configuration parameter is not applied to the first downlink control information.

In some embodiments, that the first configuration parameter is not applied to the first downlink control information includes: the first configuration parameter is not applied to any one of PDSCHs scheduled by the first downlink control information.

In some embodiments, as shown in FIG. 9, the apparatus 900 further includes:
a fourth transmitting unit 904 configured to transmit SPS configuration including a second configuration parameter used for configuring the number of repetitions; the second configuration parameter is applied to the first downlink control information.

In some embodiments, that the second configuration parameter is applied to the first downlink control information includes: the second configuration parameter is applied to one or more than one PDSCH in PDSCH(s) scheduled by the first downlink control information.

In some embodiments, each PDSCH scheduled by the first downlink control information is repeated according to the number of times configured by the second configuration parameter, and/or, each valid PDSCH scheduled by the first downlink control information is repeated according to the number of times configured by the second configuration parameter; and/or, each PDSCH in PDSCHs scheduled by the first downlink control information and needing to be received by a terminal equipment is repeated according to the number of times configured by the second configuration parameter; and/or, the first downlink control information only schedules one PDSCH and the one PDSCH is repeated according to the number of times configured by the second configuration parameter; and/or, the terminal equipment only receives one PDSCH in PDSCHs scheduled by the first downlink control information, and the one PDSCH is repeated according to the number of times configured by the second configuration parameter.

In some embodiments, as shown in FIG. 9, the apparatus 900 further includes:
a fifth transmitting unit 905 configured to transmit PDSCH configuration including a first configuration parameter used for configuring the number of repetitions; and
a sixth transmitting unit 906 configured to transmit second downlink control information for activating SPS configuration, the first configuration parameter being applied to the second downlink control information, and one or more than one row in a TDRA table to which the second downlink control information corresponds including more than one SLIV.

In some embodiments, that the first configuration parameter is applied to the second downlink control information includes: a SPS PDSCH corresponding to the second downlink control information is repeated according to the first configuration parameter.

In some embodiments, as shown in FIG. 9, the apparatus 900 further includes:
a seventh transmitting unit 907 configured to transmit PDSCH configuration including a first configuration parameter used for configuring the number of repetitions; and
an eighth transmitting unit 908 configured to transmit second downlink control information for activating SPS configuration, the first configuration parameter being not applied to the second downlink control information, and one or more than one row in a TDRA table to which the second downlink control information corresponds including more than one SLIV.

In some embodiments, that the first configuration parameter is not applied to the second downlink control information includes: the first configuration parameter is not applied to any one of SPS PDSCHs corresponding to the second downlink control information.

In some embodiments, as shown in FIG. 9, the apparatus 900 further includes:
a ninth transmitting unit 909 configured to transmit SPS configuration including a second configuration parameter used for configuring the number of repetitions; the second configuration parameter is applied to the second downlink control information.

In some embodiments, that the second configuration parameter is applied to the second downlink control information includes: the second configuration parameter is applied to one or more than one SPS PDSCH in SPS PDSCH(s) corresponding to the second downlink control information.

In some embodiments, each SPS PDSCH corresponding to the second downlink control information is repeated according to the number of times configured by the second configuration parameter, and/or, each valid SPS PDSCH corresponding to the second downlink control information is repeated according to the number of times configured by the second configuration parameter; and/or, each SPS PDSCH in SPS PDSCHs corresponding to the second downlink control information and needing to be received by a terminal equipment is repeated according to the number of times configured by the second configuration parameter; and/or, the second downlink control information only corresponds to one SPS PDSCH and the one SPS PDSCH is repeated according to the number of times configured by the second configuration parameter; and/or, the terminal equipment only receives one SPS PDSCH in SPS PDSCHs corresponding to the second downlink control information, and the one SPS PDSCH is repeated according to the number of times configured by the second configuration parameter.

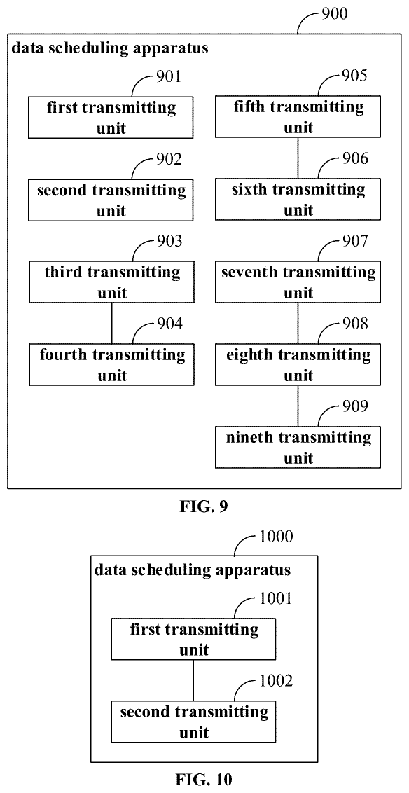

FIG. 10 is a schematic diagram of another example of a data scheduling apparatus in the embodiments of the present disclosure. As shown in FIG. 10, the data scheduling apparatus 1000 includes:
a first transmitting unit 1001 configured to transmit PDSCH configuration including a first configuration parameter used for configuring the number of repetitions; and
a second transmitting unit 1002 configured to transmit second downlink control information for activating SPS configuration, the first configuration parameter being applied to the second downlink control information, and one or more than one row in a TDRA table to which the second downlink control information corresponds including more than one SLIV.

In some embodiments, that the first configuration parameter is applied to the second downlink control information includes: a SPS PDSCH corresponding to the second downlink control information is repeated according to the first configuration parameter.

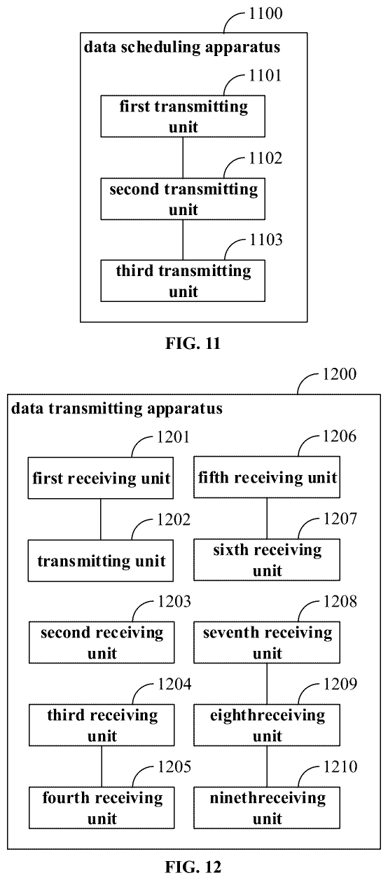

FIG. 11 is a schematic diagram of a further example of a data scheduling apparatus in the embodiments of the present disclosure. As shown in FIG. 11, the data scheduling apparatus 1100 includes:
a first transmitting unit 1101 configured to transmit PDSCH configuration including a first configuration parameter used for configuring the number of repetitions; and
a second transmitting unit 1102 configured to transmit second downlink control information for activating SPS configuration, the first configuration parameter being not applied to the second downlink control information, and one or more than one row in a TDRA table to which the second downlink control information corresponds including more than one SLIV.

In some embodiments, that the first configuration parameter is not applied to the second downlink control information includes: the first configuration parameter is not applied to any one of SPS PDSCHs corresponding to the second downlink control information.

In some embodiments, as shown in FIG. 11, the apparatus 1100 further includes:
a third transmitting unit 1103 configured to transmit SPS configuration including a second configuration parameter used for configuring the number of repetitions; the second configuration parameter is applied to the second downlink control information.

In some embodiments, that the second configuration parameter is applied to the second downlink control information includes: the second configuration parameter is applied to one or more than one SPS PDSCH in SPS PDSCH(s) corresponding to the second downlink control information.

In some embodiments, each SPS PDSCH corresponding to the second downlink control information is repeated according to the number of times configured by the second configuration parameter, and/or, each valid SPS PDSCH corresponding to the second downlink control information is repeated according to the number of times configured by the second configuration parameter; and/or, each SPS PDSCH in SPS PDSCHs corresponding to the second downlink control information and needing to be received by a terminal equipment is repeated according to the number of times configured by the second configuration parameter; and/or, the second downlink control information only corresponds to one SPS PDSCH and the one SPS PDSCH is repeated according to the number of times configured by the second configuration parameter; and/or, the terminal equipment only receives one SPS PDSCH in SPS PDSCHs corresponding to the second downlink control information, and the one SPS PDSCH is repeated according to the number of times configured by the second configuration parameter.

The above text is only illustrative for the embodiments of the present disclosure, but the present disclosure is not limited to this, appropriate modifications can be also made based on the above embodiments. For example, each of the above embodiments may be used individually, or one or more of the above embodiments may be combined.

It's worth noting that the above only describes components or modules related to the present disclosure, but the present disclosure is not limited to this. The data receiving apparatuses 600-800 and the data scheduling apparatuses 900-1100 may further include other components or modules. For detailed contents of these components or modules, relevant technologies can be referred to. Moreover, the above components or modules can be realized by a hardware facility such as a processor, a memory, a transmitter, a receiver, etc. The embodiments of the present disclosure have no limitation to this.

According to the apparatus in the embodiments of the present disclosure, scheduling of more than one PDSCH via one DCI can be supported, further, semi-static scheduling or semi-persistent scheduling of the PDSCH in a case where one DCI (or DCI format) may schedule more than one PDSCH can be supported, and dynamic retransmission for data corresponding to the semi-static scheduling or semi-persistent scheduling is supported. Moreover, for a network device, the flexibility of configuration and resource scheduling may also be improved.

### Embodiments of a Sixth Aspect

The embodiments of the present disclosure provide a data transmitting apparatus or a data scheduling apparatus. The apparatus may, for example, be a terminal equipment, or may be one or more parts or components configured in the terminal equipment. The apparatus in the embodiments of the present disclosure corresponds to the method in the embodiments of the third aspect, the contents same as those in the embodiments of the third aspect are not repeated.

FIG. 12 is a schematic diagram of an example of a data transmitting apparatus in the embodiments of the present disclosure. As shown in FIG. 12, the data transmitting apparatus 1200 includes:
a first receiving unit 1201 configured to receive third downlink control information, the third downlink control information being used to schedule PUSCHs; and
a transmitting unit 1202 configured to transmit one or more than one PUSCH in the PUSCHs scheduled by the third downlink control information.

In some embodiments, in a case where the transmitting unit 1202 transmits more than one PUSCH in the PUSCHs scheduled by third downlink control information, data carried by different PUSCHs in the more than one PUSCH are different.

In some embodiments, the third downlink control information is DCI format 0_1.

In some embodiments, the third downlink control information includes a first NDI field and/or a second NDI field; the first NDI field and the second NDI field corresponding respectively to a first one of TBs and a second one of TBs in a case where the third downlink control information includes the first NDI field and the second NDI field.

In some embodiments, a value/values of the first NDI field and/or the second NDI field is/are 0 or 1.

In some embodiments, the number of bits included in the first NDI field and/or the second NDI field is determined according to at least one of the following:
the maximum number of PUSCHs that can be scheduled by the third downlink control information;
the number of PUSCHs scheduled by the third downlink control information;
the number of valid PUSCHs scheduled by the third downlink control information.

In some embodiments, in a case where CRC of the third downlink control information is scrambled by a CS-RNTI, the first NDI field and/or the second NDI field include(s) one bit, or the first NDI field and/or the second NDI field include(s) more than one bit; in a case where the first NDI field and/or the second NDI field include(s) more than one bit, a sole bit is valid, or more than one bit are valid, or all bits are valid.

In some embodiments, one or more than one row in a TDRA table to which the third downlink control information corresponds include(s) more than one SLIV.

In the above embodiments, the terminal equipment does not expect that CRC of the third downlink control information is scrambled by a CS-RNTI, and/or, a value/values of a first NDI field and/or a second NDI field of the third downlink control information is/are 1, and/or, the third downlink control information schedules more than one PUSCH, and/or, the third downlink control information schedules more than one valid PUSCH, and/or, an NDI field of the third downlink control information includes more than one bit with a value being 1, and/or, HARQ process ID(s) corresponding to more than one PUSCH scheduled by the third downlink control information is/are one of one or more than one HARQ process ID for CG configuration, and/or, HARQ process ID(s) corresponding to one or more than one PUSCH scheduled by the third downlink control information is/are not one of one or more than one HARQ process ID for CG configuration.

In some embodiments, CRC of the third downlink control information is scrambled by a CS-RNTI, the third downlink control information only schedules one PUSCH, and the transmitting unit 1202 transmits the one PUSCH.

In some embodiments, CRC of the third downlink control information is scrambled by a CS-RNTI, and the third downlink control information schedules more than one PUSCH.

In some embodiments, the transmitting unit 1202 determines whether to transmit PUSCH(s) in the more than one PUSCH scheduled by the third downlink control information according to at least one of the following:
a HARQ process ID to which the PUSCH corresponds;
a value of a bit to which the PUSCH corresponds in an NDI field;
whether the PUSCH collides with a semi-statically configured downlink symbol;
whether the PUSCH collides with an SSB; and
whether the PUSCH collides with CORESET #0.

In some embodiments, the transmitting unit 1202 only transmits one PUSCH in the more than one PUSCH.

In the above embodiments, the one PUSCH is a first PUSCH or a last PUSCH in the more than one PUSCH, and/or, the one PUSCH is the a sole valid PUSCH in the more than one PUSCH, and/or, the one PUSCH is the a sole PUSCH with a value of a corresponding NDI field being 1, in the more than one PUSCH, and/or, the one PUSCH is the a sole PUSCH whose corresponding HARQ process ID is one of one or more than one HARQ process ID for CG configuration, in the more than one PUSCH.

In the above embodiments, in some implementations, a HARQ process ID indicated by the third downlink control information corresponds to the one PUSCH; or, a HARQ process ID indicated by the third downlink control information corresponds to a first valid PUSCH in the more than one PUSCH, and the terminal equipment determines a HARQ process ID corresponding to the one PUSCH according to the HARQ process ID.

In the above embodiments, in some implementations, the HARQ process ID corresponding to the one PUSCH is one of one or more than one HARQ process ID for CG configuration.

In the above embodiments, in some implementations, the one PUSCH is a valid PUSCH.

In the above embodiments, in some implementations, the first PUSCH is a first PUSCH scheduled by the third downlink control information or a first valid PUSCH scheduled by the third downlink control information; the last PUSCH is a last PUSCH scheduled by the third downlink control information or a last valid PUSCH scheduled by the third downlink control information.

In some other embodiments, the transmitting unit 1202 only transmits a PUSCH whose corresponding HARQ process ID is one of one or more than one HARQ process ID for CG configuration.

In some further embodiments, the transmitting unit 1202 transmits all valid PUSCHs in the more than one PUSCH.

In the above embodiments, in some implementations, a HARQ process ID corresponding to the all valid PUSCHs must be one of one or more than one HARQ process ID for CG configuration.

In the above embodiments, in some implementations, a PUSCH with a corresponding HARQ process ID being not one of one or more than one HARQ process ID for CG configuration and/or a value of a bit in a corresponding NDI field being 0, is initial transmission.

In the above embodiments, in some implementations, a HARQ process ID corresponding to a sole or at least one PUSCH in the all valid PUSCHs is one of one or more than one HARQ process ID for CG configuration.

In some further embodiments, the transmitting unit 1202 only transmits a PUSCH with a value of a bit in the corresponding NDI field being 1; or, the transmitting unit 1202 transmits all valid PUSCHs, and for the PUSCH with a value of a bit in the corresponding NDI field being 1, it is considered as retransmission, and for a PUSCH with a value of a bit in the corresponding NDI field being 0, it is considered as initial transmission.

In the above embodiments, in some implementations, in an NDI field, a value of a bit corresponding to a sole or at least one PUSCH in all valid PUSCHs is 1.

In some embodiments, as shown in FIG. 12, the apparatus 1200 further includes:
a second receiving unit 1203 configured to receive PUSCH configuration including a third configuration parameter used for configuring the number of repetitions; CRC of the third downlink control information is scrambled by a CS-RNTI, and the third configuration parameter is applied to the third downlink control information.

In the above embodiments, that the third configuration parameter is applied to the third downlink control information includes: the third configuration parameter is applied to one or more than one PUSCH in PUSCH(s) scheduled by the third downlink control information.

In the above embodiments, each PUSCH scheduled by the third downlink control information is repeated according to the number of times configured by the third configuration parameter, and/or, each valid PUSCH scheduled by the third downlink control information is repeated according to the number of times configured by the third configuration parameter; and/or, each PUSCH in PUSCHs scheduled by the third downlink control information and needing to be transmitted by a terminal equipment is repeated according to the number of times configured by the third configuration parameter; and/or, the third downlink control information only schedules one PUSCH and the one PUSCH is repeated according to the number of times configured by the third configuration parameter; and/or, the terminal equipment only transmits one PUSCH in PUSCHs scheduled by the third downlink control information, and the one PUSCH is repeated according to the number of times configured by the third configuration parameter.

In some embodiments, as shown in FIG. 12, the apparatus 1200 further includes:
a third receiving unit 1204 configured to receive PUSCH configuration including a third configuration parameter used for configuring the number of repetitions; CRC of the third downlink control information is scrambled by a CS-RNTI, and the third configuration parameter is not applied to the third downlink control information.

In the above embodiments, that the third configuration parameter is not applied to the third downlink control information includes: the third configuration parameter is not applied to any one of PUSCHs scheduled by the third downlink control information.

In the above embodiments, in some implementations, as shown in FIG. 12, the apparatus 1200 further includes:
a fourth receiving unit 1205 configured to receive CG configuration including a fourth configuration parameter used for configuring the number of repetitions; the fourth configuration parameter is applied to the third downlink control information.

In the above embodiments, that the fourth configuration parameter is applied to the third downlink control information includes: the fourth configuration parameter is applied to one or more than one PUSCH in PUSCH(s) scheduled by the third downlink control information.

In the above embodiments, each PUSCH scheduled by the third downlink control information is repeated according to the number of times configured by the fourth configuration parameter, and/or, each valid PUSCH scheduled by the third downlink control information is repeated according to the number of times configured by the fourth configuration parameter; and/or, each PUSCH in PUSCHs scheduled by the third downlink control information and needing to be transmitted by a terminal equipment is repeated according to the number of times configured by the fourth configuration parameter; and/or, the third downlink control information only schedules one PUSCH and the one PUSCH is repeated according to the number of times configured by the fourth configuration parameter; and/or, the terminal equipment only transmits one PUSCH in PUSCHs scheduled by the third downlink control information, and the one PUSCH is repeated according to the number of times configured by the fourth configuration parameter.

In some embodiments, as shown in FIG. 12, the apparatus 1200 further includes:
a fifth receiving unit 1206 configured to receive PUSCH configuration including a third configuration parameter used for configuring the number of repetitions; and
a sixth receiving unit 1207 configured to receive fourth downlink control information for activating CG configuration, the third configuration parameter being applied to the fourth downlink control information, and one or more than one row in a TDRA table to which the fourth downlink control information corresponds including more than one SLIV.

In the above embodiments, that the third configuration parameter is applied to the fourth downlink control information includes: a CG PUSCH corresponding to the fourth downlink control information is repeated according to the third configuration parameter.

In some embodiments, as shown in FIG. 12, the apparatus 1200 further includes:
a seventh receiving unit 1208 configured to receive PUSCH configuration including a third configuration parameter used for configuring the number of repetitions; and
an eighth receiving unit 1209 configured to receive fourth downlink control information for activating CG configuration, the third configuration parameter being not applied to the fourth downlink control information, and one or more rows in a TDRA table to which the fourth downlink control information corresponds including more than one SLIV.

In the above embodiments, that the third configuration parameter is not applied to the fourth downlink control information includes: the third configuration parameter is not applied to any one of CG PUSCHs corresponding to the fourth downlink control information.

In the above embodiments, in some implementations, as shown in FIG. 12, the apparatus 1200 further includes:
a ninth receiving unit 1210 configured to receive CG configuration including a fourth configuration parameter used for configuring the number of repetitions; the fourth configuration parameter is applied to the fourth downlink control information.

In the above embodiments, that the fourth configuration parameter is applied to the fourth downlink control information includes: the fourth configuration parameter is applied to one or more than one CG PUSCH in CG PUSCH(s) corresponding to the fourth downlink control information.

In the above embodiments, each CG PUSCH corresponding to the fourth downlink control information is repeated according to the number of times configured by the fourth configuration parameter, and/or, each valid CG PUSCH corresponding to the fourth downlink control information is repeated according to the number of times configured by the fourth configuration parameter; and/or, each CG PUSCH in CG PUSCHs corresponding to the fourth downlink control information and needing to be transmitted by a terminal equipment is repeated according to the number of times configured by the fourth configuration parameter; and/or, the fourth downlink control information only corresponds to one CG PUSCH and the one CG PUSCH is repeated according to the number of times configured by the fourth configuration parameter; and/or, the terminal equipment only transmits one CG PUSCH in CG PUSCHs corresponding to the fourth downlink control information, and the one CG PUSCH is repeated according to the number of times configured by the fourth configuration parameter.

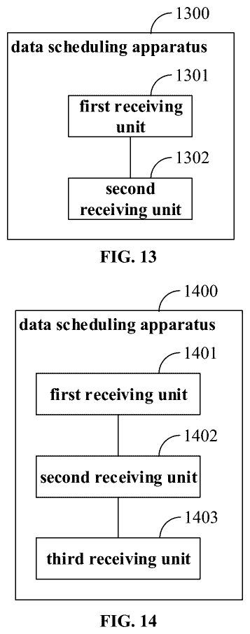

FIG. 13 is a schematic diagram of an example of a data scheduling apparatus in the embodiments of the present disclosure. As shown in FIG. 13, the data scheduling apparatus 1300 includes:
a first receiving unit 1301 configured to receive PUSCH configuration including a third configuration parameter used for configuring the number of repetitions; and
a second receiving unit 1302 configured to receive fourth downlink control information for activating CG configuration, the third configuration parameter being applied to the fourth downlink control information, and one or more than one row in a TDRA table to which the fourth downlink control information corresponds including more than one SLIV.

In some embodiments, that the third configuration parameter is applied to the fourth downlink control information includes: a CG PUSCH corresponding to the fourth downlink control information is repeated according to the third configuration parameter.

FIG. 14 is a schematic diagram of another example of a data scheduling apparatus in the embodiments of the present disclosure. As shown in FIG. 14, the data receiving apparatus 1400 includes:
a first receiving unit 1401 configured to receive PUSCH configuration including a third configuration parameter used for configuring the number of repetitions; and
a second receiving unit 1402 configured to receive fourth downlink control information for activating CG configuration, the third configuration parameter being not applied to the fourth downlink control information, and one or more rows in a TDRA table to which the fourth downlink control information corresponds including more than one SLIV.

In some embodiments, that the third configuration parameter is not applied to the fourth downlink control information includes: the third configuration parameter is not applied to any one of CG PUSCHs corresponding to the fourth downlink control information.

In some embodiments, as shown in FIG. 14, the apparatus 1400 further includes:
a third receiving unit 1403 configured to receive CG configuration including a fourth configuration parameter used for configuring the number of repetitions; the fourth configuration parameter is applied to the fourth downlink control information.

In some embodiments, that the fourth configuration parameter is applied to the fourth downlink control information includes: the fourth configuration parameter is applied to one or more than one CG PUSCH in CG PUSCH(s) corresponding to the fourth downlink control information.

For example, each CG PUSCH corresponding to the fourth downlink control information is repeated according to the number of times configured by the fourth configuration parameter, and/or, each valid CG PUSCH corresponding to the fourth downlink control information is repeated according to the number of times configured by the fourth configuration parameter; and/or, each CG PUSCH in CG PUSCHs corresponding to the fourth downlink control information and needing to be transmitted by a terminal equipment is repeated according to the number of times configured by the fourth configuration parameter; and/or, the fourth downlink control information only corresponds to one CG PUSCH and the one CG PUSCH is repeated according to the number of times configured by the fourth configuration parameter; and/or, the terminal equipment only transmits one CG PUSCH in CG PUSCHs corresponding to the fourth downlink control information, and the one CG PUSCH is repeated according to the number of times configured by the fourth configuration parameter.

The embodiments of the present disclosure further provide a data scheduling apparatus. The apparatus may, for example, be a network device, or may be one or more parts or components configured in the network device. The apparatus in the embodiments of the present disclosure corresponds to the method in the embodiments of the fourth aspect, the contents same as those in the embodiments of the fourth aspect are not repeated.

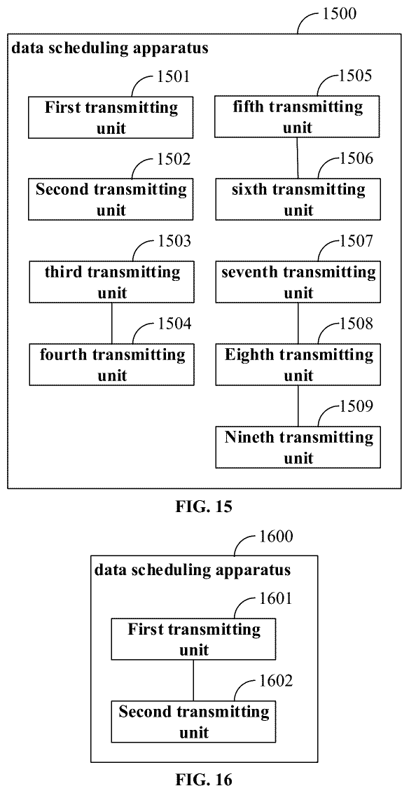

FIG. 15 is a schematic diagram of an example of a data scheduling apparatus in the embodiments of the present disclosure. As shown in FIG. 15, the data scheduling apparatus 1500 includes:
a first transmitting unit 1501 configured to transmit third downlink control information, the third downlink control information being used to schedule PUSCHs, the number of the PUSCHs being one or more.

In some embodiments, in a case where the network device receives more than one PUSCH in PUSCHs scheduled by third downlink control information, data carried by different PUSCHs in the more than one PUSCH are different.

In some embodiments, the third downlink control information is DCI format 0_1.

In some embodiments, the third downlink control information includes a first NDI field and/or a second NDI field; the first NDI field and the second NDI field corresponding respectively to a first one of TBs and a second one of TBs in a case where the third downlink control information includes the first NDI field and the second NDI field.

In some embodiments, a value/values of the first NDI field and/or the second NDI field is/are 0 or 1.

In some embodiments, the number of bits included in the first NDI field and/or the second NDI field is determined according to at least one of the following:
the maximum number of PUSCHs that can be scheduled by the third downlink control information;
the number of PUSCHs scheduled by the third downlink control information;
the number of valid PUSCHs scheduled by the third downlink control information.

In some embodiments, in a case where CRC of the third downlink control information is scrambled by a CS-RNTI, the first NDI field and/or the second NDI field include(s) one bit, or the first NDI field and/or the second NDI field include(s) more than one bit; in a case where the first NDI field and/or the second NDI field include(s) more than one bit, a sole bit is valid, or more than one bit are valid, or all bits are valid.

In some embodiments, one or more than one row in a TDRA table to which the third downlink control information corresponds include(s) more than one SLIV.

In some embodiments, the third downlink control information schedules one PUSCH, and/or, a value/values of a first NDI field and/or a second NDI field of the third downlink control information is/are 1, and/or, the third downlink control information schedules more than one PUSCH, and/or, the third downlink control information schedules more than one valid PUSCH, and/or, an NDI field of the third downlink control information includes more than one bit with a value being 1, and/or, HARQ process ID(s) corresponding to more than one PUSCH scheduled by the third downlink control information is/are one of one or more than one HARQ process ID for CG configuration, and/or, HARQ process ID(s) corresponding to one or more than one PUSCH scheduled by the third downlink control information is/are not one of one or more than one HARQ process ID for CG configuration.

In some embodiments, CRC of the third downlink control information is scrambled by a CS-RNTI, and the third downlink control information only schedules one PUSCH.

In some embodiments, CRC of the third downlink control information is scrambled by a CS-RNTI, and the third downlink control information schedules more than one PUSCH, the network device receives one PUSCH of the more than one PUSCH scheduled by the third downlink control information, or, the network device receives a PUSCH whose corresponding HARQ process ID is one of one or more than one HARQ process ID for CG configuration; or, the network device receives all valid PUSCHs in more than one PUSCH scheduled by the third downlink control information; or, the network device receives a PUSCH with a value of a bit in a corresponding NDI field being 1; or, the network device receives all valid PUSCHs, for a PUSCH with a value of a bit in a corresponding NDI field being 1, it is considered as retransmission, and for a PUSCH with a value of a bit in a corresponding NDI field being 0, it is considered as initial transmission.

In some embodiments, the one PUSCH is a first PUSCH or a last PUSCH in the more than one PUSCH, and/or, the one PUSCH is the a sole valid PUSCH in the more than one PUSCH, and/or, the one PUSCH is the a sole PUSCH with a value of a corresponding NDI field being 1, in the more than one PUSCH, and/or, the one PUSCH is the a sole PUSCH whose corresponding HARQ process ID is one of one or more than one HARQ process ID for CG configuration, in the more than one PUSCH.

In some embodiments, a HARQ process ID indicated by the third downlink control information corresponds to the one PUSCH; or, a HARQ process ID indicated by the third downlink control information corresponds to a first valid PUSCH in the more than one PUSCH, and the terminal equipment determines a HARQ process ID corresponding to the one PUSCH according to the HARQ process ID.

In some embodiments, the HARQ process ID corresponding to the one PUSCH is one of one or more than one HARQ process ID for CG configuration.

In some embodiments, the one PUSCH is a valid PUSCH.

In some embodiments, the first PUSCH is a first PUSCH scheduled by the third downlink control information or a first valid PUSCH scheduled by the third downlink control information; the last PUSCH is a last PUSCH scheduled by the third downlink control information or a last valid PUSCH scheduled by the third downlink control information.

In some embodiments, a HARQ process ID corresponding to the all valid PUSCHs must be one of one or more than one HARQ process ID for CG configuration.

In some embodiments, a PUSCH with a corresponding HARQ process ID being not one of one or more than one HARQ process ID for CG configuration and/or a value of a bit in a corresponding NDI field being 0, is initial transmission.

In some embodiments, a HARQ process ID corresponding to a sole or at least one PUSCH in the all valid PUSCHs is one of one or more than one HARQ process ID for CG configuration.

In some embodiments, in an NDI field, a value of a bit corresponding to a sole or at least one PUSCH in all valid PUSCHs is 1.

In some embodiments, as shown in FIG. 15, the apparatus 1500 further includes:
a second transmitting unit 1502 configured to transmit PUSCH configuration including a third configuration parameter used for configuring the number of repetitions; CRC of the third downlink control information is scrambled by a CS-RNTI, and the third configuration parameter is applied to the third downlink control information.

In some embodiments, that the third configuration parameter is applied to the third downlink control information includes: the third configuration parameter is applied to one or more than one PUSCH in PUSCH(s) scheduled by the third downlink control information.

In some embodiments, each PUSCH scheduled by the third downlink control information is repeated according to the number of times configured by the third configuration parameter, and/or, each valid PUSCH scheduled by the third downlink control information is repeated according to the number of times configured by the third configuration parameter; and/or, each PUSCH in PUSCHs scheduled by the third downlink control information and needing to be transmitted by a terminal equipment is repeated according to the number of times configured by the third configuration parameter; and/or, the third downlink control information only schedules one PUSCH and the one PUSCH is repeated according to the number of times configured by the third configuration parameter; and/or, the terminal equipment only transmits one PUSCH in PUSCHs scheduled by the third downlink control information, and the one PUSCH is repeated according to the number of times configured by the third configuration parameter.

In some embodiments, as shown in FIG. 15, the apparatus 1500 further includes:
a third transmitting unit 1503 configured to transmit PUSCH configuration including a third configuration parameter used for configuring the number of repetitions; CRC of the third downlink control information is scrambled by a CS-RNTI, and the third configuration parameter is not applied to the third downlink control information.

In some embodiments, that the third configuration parameter is not applied to the third downlink control information includes: the third configuration parameter is not applied to any one of PUSCHs scheduled by the third downlink control information.

In some embodiments, as shown in FIG. 15, the apparatus 1500 further includes:
a fourth transmitting unit 1504 configured to transmit CG configuration including a fourth configuration parameter used for configuring the number of repetitions; the fourth configuration parameter is applied to the third downlink control information.

In some embodiments, that the fourth configuration parameter is applied to the third downlink control information includes: the fourth configuration parameter is applied to one or more than one PUSCH in PUSCH(s) scheduled by the third downlink control information.

In some embodiments, each PUSCH scheduled by the third downlink control information is repeated according to the number of times configured by the fourth configuration parameter, and/or, each valid PUSCH scheduled by the third downlink control information is repeated according to the number of times configured by the fourth configuration parameter; and/or, each PUSCH in PUSCHs scheduled by the third downlink control information and needing to be transmitted by a terminal equipment is repeated according to the number of times configured by the fourth configuration parameter; and/or, the third downlink control information only schedules one PUSCH and the one PUSCH is repeated according to the number of times configured by the fourth configuration parameter; and/or, the terminal equipment only transmits one PUSCH in PUSCHs scheduled by the third downlink control information, and the one PUSCH is repeated according to the number of times configured by the fourth configuration parameter.

In some embodiments, as shown in FIG. 15, the apparatus 1500 further includes:
a fifth transmitting unit 1505 configured to transmit PUSCH configuration including a third configuration parameter used for configuring the number of repetitions; and
a sixth transmitting unit 1506 configured to transmit fourth downlink control information for activating CG configuration, the third configuration parameter being applied to the fourth downlink control information, and one or more than one row in a TDRA table to which the fourth downlink control information corresponds including more than one SLIV.

In some embodiments, that the third configuration parameter is applied to the fourth downlink control information includes: a CG PUSCH corresponding to the fourth downlink control information is repeated according to the third configuration parameter.

In some embodiments, as shown in FIG. 15, the apparatus 1500 further includes:
a seventh transmitting unit 1507 configured to transmit PUSCH configuration including a third configuration parameter used for configuring the number of repetitions; and
an eighth transmitting unit 1508 configured to transmit fourth downlink control information for activating CG configuration, the third configuration parameter being not applied to the fourth downlink control information, and one or more than one row in a TDRA table to which the fourth downlink control information corresponds including more than one SLIV.

In some embodiments, that the third configuration parameter is not applied to the fourth downlink control information includes: the third configuration parameter is not applied to any one of CG PUSCHs corresponding to the fourth downlink control information.

In some embodiments, as shown in FIG. 15, the apparatus 1500 further includes:
a ninth transmitting unit 1509 configured to transmit CG configuration including a fourth configuration parameter used for configuring the number of repetitions; the fourth configuration parameter is applied to the fourth downlink control information.

In some embodiments, that the fourth configuration parameter is applied to the fourth downlink control information includes: the fourth configuration parameter is applied to one or more than one CG PUSCH in CG PUSCH(s) corresponding to the fourth downlink control information.

In some embodiments, each CG PUSCH corresponding to the fourth downlink control information is repeated according to the number of times configured by the fourth configuration parameter, and/or, each valid CG PUSCH corresponding to the fourth downlink control information is repeated according to the number of times configured by the fourth configuration parameter; and/or, each CG PUSCH in CG PUSCHs corresponding to the fourth downlink control information and needing to be transmitted by a terminal equipment is repeated according to the number of times configured by the fourth configuration parameter; and/or, the fourth downlink control information only corresponds to one CG PUSCH and the one CG PUSCH is repeated according to the number of times configured by the fourth configuration parameter; and/or, the terminal equipment only transmits one CG PUSCH in CG PUSCHs corresponding to the fourth downlink control information, and the one CG PUSCH is repeated according to the number of times configured by the fourth configuration parameter.

FIG. 16 is a schematic diagram of another example of a data scheduling apparatus in the embodiments of the present disclosure. As shown in FIG. 16, the data scheduling apparatus 1600 includes:
a first transmitting unit 1601 configured to transmit PUSCH configuration including a third configuration parameter used for configuring the number of repetitions; and
a second transmitting unit 1602 configured to transmit fourth downlink control information for activating CG configuration, the third configuration parameter being applied to the fourth downlink control information, and one or more than one row in a TDRA table to which the fourth downlink control information corresponds including more than one SLIV.

In some embodiments, that the third configuration parameter is applied to the fourth downlink control information includes: a CG PUSCH corresponding to the fourth downlink control information is repeated according to the third configuration parameter.

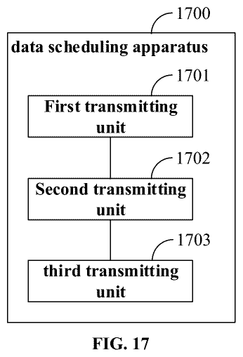

FIG. 17 is a schematic diagram of a further example of a data scheduling apparatus in the embodiments of the present disclosure. As shown in FIG. 17, the data scheduling apparatus 1700 includes:
a first transmitting unit 1701 configured to transmit PUSCH configuration including a third configuration parameter used for configuring the number of repetitions; and
a second transmitting unit 1702 configured to transmit fourth downlink control information for activating CG configuration, the third configuration parameter being not applied to the fourth downlink control information, and one or more than one row in a TDRA table to which the fourth downlink control information corresponds including more than one SLIV.

In some embodiments, that the third configuration parameter is not applied to the fourth downlink control information includes: the third configuration parameter is not applied to any one of CG PUSCHs corresponding to the fourth downlink control information.

In some embodiments, as shown in FIG. 17, the apparatus 1700 further includes:
a third transmitting unit 1703 configured to transmit CG configuration including a fourth configuration parameter used for configuring the number of repetitions; the fourth configuration parameter is applied to the fourth downlink control information.

In some embodiments, that the fourth configuration parameter is applied to the fourth downlink control information includes: the fourth configuration parameter is applied to one or more than one CG PUSCH in CG PUSCH(s) corresponding to the fourth downlink control information.

In some embodiments, each CG PUSCH corresponding to the fourth downlink control information is repeated according to the number of times configured by the fourth configuration parameter, and/or, each valid CG PUSCH corresponding to the fourth downlink control information is repeated according to the number of times configured by the fourth configuration parameter; and/or, each CG PUSCH in CG PUSCHs corresponding to the fourth downlink control information and needing to be transmitted by a terminal equipment is repeated according to the number of times configured by the fourth configuration parameter; and/or, the fourth downlink control information only corresponds to one CG PUSCH and the one CG PUSCH is repeated according to the number of times configured by the fourth configuration parameter; and/or, the terminal equipment only transmits one CG PUSCH in CG PUSCHs corresponding to the fourth downlink control information, and the one CG PUSCH is repeated according to the number of times configured by the fourth configuration parameter.

The above text is only illustrative for the embodiments of the present disclosure, but the present disclosure is not limited to this, appropriate modifications can be also made based on the above embodiments. For example, each of the above embodiments may be used individually, or one or more of the above embodiments may be combined.

It's worth noting that the above only describes components or modules related to the present disclosure, but the present disclosure is not limited to this. The data transmitting apparatus 1200 and the data scheduling apparatuses 1300-1700 may further include other components or modules. For detailed contents of these components or modules, relevant technologies can be referred to. Moreover, the above components or modules can be realized by a hardware facility such as a processor, a memory, a transmitter, a receiver, etc. The embodiments of the present disclosure have no limitation to this.

According to the apparatus in the embodiments of the present disclosure, scheduling of more than one PUSCH via one DCI can be supported, further, semi-static scheduling or semi-persistent scheduling of the PUSCH in a case where one DCI (or DCI format) may schedule more than one PUSCH can be supported, and dynamic retransmission for data corresponding to the semi-static scheduling or semi-persistent scheduling is supported. Moreover, for a network device, the flexibility of configuration and resource scheduling may also be improved.

### Embodiments of a Seventh Aspect

The embodiments of the present disclosure further provide a communication system, including a network device and a terminal equipment.

In some embodiments, the terminal equipment is configured to perform the method described in the embodiments of the first aspect, and the network device is configured to perform the method described in the embodiments of the second aspect.

In some embodiments, the terminal equipment is configured to perform the method described in the embodiments of the third aspect, and the network device is configured to perform the method described in the embodiments of the fourth aspect.

Since each method has been described in details in the embodiments of the first to fourth aspects, its contents are incorporated here and are not repeated.

The embodiments of the present disclosure further provide a terminal equipment, the terminal equipment for example may be a UE, but the present disclosure is not limited to this, it may also be other terminal equipment.

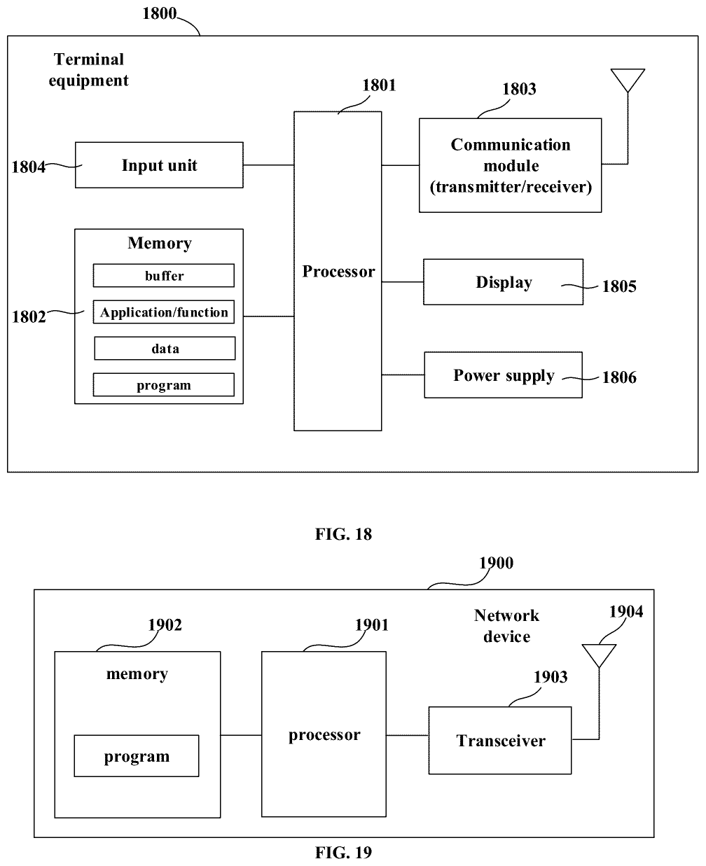

FIG. 18 is a schematic diagram of a terminal equipment in the embodiments of the present disclosure. As shown in FIG. 18, the terminal equipment 1800 may include a processor 1801 and a memory 1802; the memory 1802 stores data and programs, and is coupled to the processor 1801. It's worth noting that this figure is exemplary; other types of structures can also be used to supplement or replace this structure, so as to realize a telecommunication function or other functions.

For example, the processor 1801 may be configured to execute a program to implement the method described in the embodiments of the first aspect or the third aspect.

As shown in FIG. 18, the terminal equipment 1800 may further include: a communication module 1803, an input unit 1804, a display 1805 and a power supply 1806. The functions of said components are similar to related arts, which are not repeated here. It's worth noting that the terminal equipment 1800 does not have to include all the components shown in FIG. 18, said components are not indispensable. Moreover, the terminal equipment 1800 may also include components not shown in FIG. 18, related arts can be referred to.

The embodiments of the present disclosure further provide a network device, the network device for example may be a base station, but the present disclosure is not limited to this, it may also be other network device.

FIG. 19 is a composition schematic diagram of a network device in the embodiments of the present disclosure. As shown in FIG. 19, the network device 1900 may include: a processor 1901 and a memory 1902; the memory 1902 is coupled to the processor 1901. The memory 1902 may store various data; moreover, also stores a program for information processing, and executes the program under the control of the processor 1901.

For example, the processor 1901 can be configured to execute a program to implement the method described in the embodiments of the second aspect or the fourth aspect.

In addition, as shown in FIG. 19, the network device 1900 may further include: transceivers 1903 and antenna 1904. The functions of said components are similar to related arts, which are not repeated here. It's worth noting that the network device 1900 does not have to include all the components shown in FIG. 19. Moreover, the network device 1900 may also include components not shown in FIG. 19, relevant arts can be referred to.

The embodiments of the present disclosure further provide a computer program, wherein when a terminal equipment executes the program, the program enables the terminal equipment to execute the method described in the embodiments of the first aspect or the third aspect.

The embodiments of the present disclosure further provide a storage medium in which a computer program is stored, wherein the computer program enables a terminal equipment to execute the method described in the embodiments of the first aspect or the third aspect.

The embodiments of the present disclosure further provide a computer program, wherein when a network device executes the program, the program enables the network device to execute the method described in the embodiments of the second aspect or the fourth aspect.

The embodiments of the present disclosure further provide a storage medium in which a computer program is stored, wherein the computer program enables a network device to execute the method described in the embodiments of the second aspect or the fourth aspect.

The apparatus and method in the present disclosure can be realized by hardware, or can be realized by combining hardware with software. The present disclosure relates to such a computer readable program, when the program is executed by a logic component, the computer readable program enables the logic component to realize the apparatus described in the above text or a constituent component, or enables the logic component to realize various methods or steps described in the above text. The present disclosure also relates to a storage medium storing the program, such as a hard disk, a magnetic disk, an optical disk, a DVD, a flash memory and the like.

By combining with the method/apparatus described in the embodiments of the present disclosure, it can be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules can be realized by solidifying these software modules e.g. using a field-programmable gate array (FPGA).

A software module can be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module can be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module can be stored in the MEGA-SIM card or the flash memory apparatus with a large capacity.

One or more in the functional block diagram or one or more combinations in the functional block diagram as described in the drawings can be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings can be also implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art can make various variations and modifications to the present disclosure according to the principle of the present disclosure, these variations and modifications are also within the scope of the present disclosure.

As for the implementations including the above embodiments, the following supplements are further disclosed:

1. A data receiving method, the method including:
a terminal equipment receives first downlink control information, the first downlink control information being used to schedule PDSCHs; and
the terminal equipment receives one or more than one PDSCH in the PDSCHs scheduled by the first downlink control information.

2. The method according to Supplement 1, wherein in a case where the terminal equipment receives more than one PDSCH in PDSCHs scheduled by first downlink control information, data carried by different PDSCHs in the more than one PDSCH are different.

3. The method according to Supplement 1, wherein the first downlink control information is DCI format 1_1.

4. The method according to Supplement 1, wherein the first downlink control information includes a first NDI field and/or a second NDI field; the first NDI field and the second NDI field corresponding respectively to a first one of TBs and a second one of TBs in a case where the first downlink control information includes the first NDI field and the second NDI field.

5. The method according to Supplement 4, wherein a value/values of the first NDI field and/or the second NDI field is/are 0 or 1.

6. The method according to Supplement 4, wherein the number of bits included in the first NDI field and/or the second NDI field is determined according to at least one of the following:
the maximum number of PDSCHs that can be scheduled by the first downlink control information;
the number of PDSCHs scheduled by the first downlink control information;
the number of valid PDSCHs scheduled by the first downlink control information.

7. The method according to Supplement 4 or 6, wherein in a case where CRC of the first downlink control information is scrambled by a CS-RNTI, the first NDI field and/or the second NDI field include(s) one bit, or the first NDI field and/or the second NDI field include(s) more than one bit;
in a case where the first NDI field and/or the second NDI field include(s) more than one bit, a sole bit is valid, or more than one bit are valid, or all bits are valid.

8. The method according to Supplement 1, wherein one or more than one row in a TDRA table to which the first downlink control information corresponds include(s) more than one SLIV.

9. The method according to Supplement 8, wherein
the terminal equipment does not expect that CRC of the first downlink control information is scrambled by a CS-RNTI, and/or,
a value/values of the first NDI field and/or the second NDI field of the first downlink control information is/are 1, and/or,
the first downlink control information schedules more than one PDSCH, and/or,
the first downlink control information schedules more than one valid PDSCH, and/or,
an NDI field of the first downlink control information includes more than one bit with a value being 1, and/or,
HARQ process ID(s) corresponding to more than one PDSCH scheduled by the first downlink control information is one of one or more than one HARQ process ID for SPS configuration, and/or,
HARQ process ID(s) corresponding to one or more than one PDSCH scheduled by the first downlink control information is not one of one or more than one HARQ process ID for SPS configuration.

10. The method according to any one of Supplements 1 to 9, wherein
CRC of the first downlink control information is scrambled by a CS-RNTI, the first downlink control information only schedules one PDSCH, and the terminal equipment receives the one PDSCH.

11. The method according to any one of Supplements 1 to 9, wherein
CRC of the first downlink control information is scrambled by a CS-RNTI, and the first downlink control information schedules more than one PDSCH.

12. The method according to Supplement 11, wherein the terminal equipment determines whether to receive PDSCH(s) in the more than one PDSCH scheduled by the first downlink control information according to at least one of the following:
a HARQ process ID to which the PDSCH corresponds;
a value of a bit to which the PDSCH corresponds in an NDI field; and
whether the PDSCH collides with a semi-statically configured uplink symbol.

13. The method according to Supplement 11, wherein
the terminal equipment only receives one PDSCH in the more than one PDSCH.

14. The method according to Supplement 13, wherein
the one PDSCH is a first PDSCH or a last PDSCH in the more than one PDSCH, and/or
the one PDSCH is a sole valid PDSCH in the more than one PDSCH, and/or
the one PDSCH is a sole PDSCH with a value of a corresponding NDI field being 1, in the more than one PDSCH, and/or,
the one PDSCH is a sole PDSCH with a corresponding HARQ process ID being one of one or more than one HARQ process ID for SPS configuration, in the more than one PDSCH.

15. The method according to Supplement 14, wherein
a HARQ process ID indicated by the first downlink control information corresponds to the one PDSCH; or,
a HARQ process ID indicated by the first downlink control information corresponds to a first valid PDSCH in the more than one PDSCH, and the terminal equipment determines a HARQ process ID corresponding to the one PDSCH according to the HARQ process ID.

16. The method according to Supplement 14, wherein
the HARQ process ID corresponding to the one PDSCH is one of one or more than one HARQ process ID for SPS configuration.

17. The method according to Supplement 14, wherein
the one PDSCH is a valid PDSCH.

18. The method according to Supplement 14, wherein
the first PDSCH is a first PDSCH scheduled by the first downlink control information or a first valid PDSCH scheduled by the first downlink control information; and
the last PDSCH is a last PDSCH scheduled by the first downlink control information or a last valid PDSCH scheduled by the first downlink control information.

19. The method according to Supplement 11, wherein
the terminal equipment only receives a PDSCH whose corresponding HARQ process ID is one of one or more than one HARQ process ID for SPS configuration.

20. The method according to Supplement 11, wherein
the terminal equipment receives all valid PDSCHs in the more than one PDSCH.

21. The method according to Supplement 20, wherein a HARQ process ID corresponding to the all valid PDSCHs must be one of one or more than one HARQ process ID for SPS configuration.

22. The method according to Supplement 20, wherein
a PDSCH with a corresponding HARQ process ID being not one of one or more than one HARQ process ID for SPS configuration and/or a value of a bit in a corresponding NDI field being 0, is initial transmission.

23. The method according to Supplement 20, wherein
a HARQ process ID corresponding to a sole or at least one PDSCH in the all valid PDSCHs is one of one or more than one HARQ process ID for SPS configuration.

24. The method according to Supplement 11, wherein
the terminal equipment only receives a PDSCH with a value of a bit in a corresponding NDI field being 1; or,
the terminal equipment receives all valid PDSCHs, and for the PDSCH with a value of a bit in the corresponding NDI field being 1, it is considered as retransmission, and for a PDSCH with a value of a bit in the corresponding NDI field being 0, it is considered as initial transmission.

25. The method according to Supplement 24, wherein in an NDI field, a value of a bit corresponding to a sole or at least one PDSCH in all valid PDSCHs is 1.

26. The method according to Supplement 1, wherein the method further includes:
the terminal equipment receives PDSCH configuration including a first configuration parameter used for configuring the number of repetitions;
wherein, CRC of the first downlink control information is scrambled by a CS-RNTI, and the first configuration parameter is applied to the first downlink control information.

27. The method according to Supplement 26, wherein that the first configuration parameter is applied to the first downlink control information includes: the first configuration parameter is applied to one or more than one PDSCH in PDSCH(s) scheduled by the first downlink control information.

28. The method according to Supplement 26 or 27, wherein
each PDSCH scheduled by the first downlink control information is repeated according to the number of times configured by the first configuration parameter; and/or,
each valid PDSCH scheduled by the first downlink control information is repeated according to the number of times configured by the first configuration parameter; and/or,
each PDSCH in PDSCHs scheduled by the first downlink control information and needing to be received by the terminal equipment is repeated according to the number of times configured by the first configuration parameter; and/or,
the first downlink control information only schedules one PDSCH and the one PDSCH is repeated according to the number of times configured by the first configuration parameter; and/or,
in PDSCHs scheduled by the first downlink control information, the terminal equipment only receives one PDSCH, and the one PDSCH is repeated according to the number of times configured by the first configuration parameter.

29. The method according to Supplement 1, wherein the method further includes:
the terminal equipment receives PDSCH configuration including a first configuration parameter used for configuring the number of repetitions;
wherein, CRC of the first downlink control information is scrambled by a CS-RNTI, and the first configuration parameter is not applied to the first downlink control information.

30. The method according to Supplement 29, wherein
that the first configuration parameter is not applied to the first downlink control information includes: the first configuration parameter is not applied to any one of PDSCHs scheduled by the first downlink control information.

31. The method according to Supplement 29, wherein the method further includes:
the terminal equipment receives SPS configuration including a second configuration parameter used for configuring the number of repetitions;
wherein, the second configuration parameter is applied to the first downlink control information.

32. The method according to Supplement 31, wherein that the second configuration parameter is applied to the first downlink control information includes: the second configuration parameter is applied to one or more than one PDSCH in PDSCH(s) scheduled by the first downlink control information.

33. The method according to Supplement 31 or 32, wherein
each PDSCH scheduled by the first downlink control information is repeated according to the number of times configured by the second configuration parameter; and/or,
each valid PDSCH scheduled by the first downlink control information is repeated according to the number of times configured by the second configuration parameter; and/or,
each PDSCH in PDSCHs scheduled by the first downlink control information and needing to be received by the terminal equipment is repeated according to the number of times configured by the second configuration parameter; and/or,
the first downlink control information only schedules one PDSCH and the one PDSCH is repeated according to the number of times configured by the second configuration parameter; and/or,
in PDSCHs scheduled by the first downlink control information, the terminal equipment only receives one PDSCH, and the one PDSCH is repeated according to the number of times configured by the second configuration parameter.

34. The method according to Supplement 1, wherein the method further includes:
the terminal equipment receives PDSCH configuration including a first configuration parameter used for configuring the number of repetitions; and
the terminal equipment receives second downlink control information used for activating SPS configuration,
wherein, the first configuration parameter is applied to the second downlink control information, and one or more than one row in a TDRA table to which the second downlink control information corresponds includes more than one SLIV.

35. The method according to Supplement 34, wherein that the first configuration parameter is applied to the second downlink control information includes that:
a SPS PDSCH to which the second downlink control information corresponds is repeated according to the first configuration parameter.

36. The method according to Supplement 1, wherein the method further includes:
the terminal equipment receives PDSCH configuration including a first configuration parameter used for configuring the number of repetitions; and
the terminal equipment receives second downlink control information used for activating SPS configuration;
wherein, the first configuration parameter is not applied to the second downlink control information, and one or more rows in a TDRA table to which the second downlink control information corresponds includes more than one SLIV.

37. The method according to Supplement 36, wherein
that the first configuration parameter is not applied to the second downlink control information includes:
the first configuration parameter is not applied to any one of SPS PDSCHs corresponding to the second downlink control information.

38. The method according to Supplement 36, wherein the method further includes:
the terminal equipment receives SPS configuration including a second configuration parameter used for configuring the number of repetitions;
wherein, the second configuration parameter is applied to the second downlink control information.

39. The method according to Supplement 38, wherein
that the second configuration parameter is applied to the second downlink control information includes: the second configuration parameter is applied to one or more than one SPS PDSCH in SPS PDSCH(s) corresponding to the second downlink control information.

40. The method according to Supplement 36 or 39, wherein
each SPS PDSCH corresponding to the second downlink control information is repeated according to the number of times configured by the second configuration parameter; and/or,
each valid SPS PDSCH corresponding to the second downlink control information is repeated according to the number of times configured by the second configuration parameter; and/or,
each SPS PDSCH in SPS PDSCHs corresponding to the second downlink control information and needing to be received by the terminal equipment is repeated according to the number of times configured by the second configuration parameter; and/or,
the second downlink control information only corresponds to one SPS PDSCH and the one SPS PDSCH is repeated according to the number of times configured by the second configuration parameter; and/or,
in SPS PDSCHs corresponding to the second downlink control information, the terminal equipment only receives one SPS PDSCH, and the one SPS PDSCH is repeated according to the number of times configured by the second configuration parameter.

41. A data receiving method, wherein the method includes:
a terminal equipment receives PDSCH configuration including a first configuration parameter used for configuring the number of repetitions; and
the terminal equipment receives second downlink control information used for activating SPS configuration,
the first configuration parameter being applied to the second downlink control information, and one or more than one row in a TDRA table to which the second downlink control information corresponds including more than one SLIV.

42. The method according to Supplement 41, wherein that the first configuration parameter is applied to the second downlink control information includes that:
a SPS PDSCH to which the second downlink control information corresponds is repeated according to the first configuration parameter.

43. A data receiving method, wherein the method includes:
a terminal equipment receives PDSCH configuration including a first configuration parameter used for configuring the number of repetitions; and
the terminal equipment receives second downlink control information used for activating SPS configuration;
wherein, the first configuration parameter is not applied to the second downlink control information, and one or more rows in a TDRA table to which the second downlink control information corresponds includes more than one SLIV.

44. The method according to Supplement 43, wherein
that the first configuration parameter is not applied to the second downlink control information includes:

the first configuration parameter is not applied to any one of SPS PDSCHs corresponding to the second downlink control information.

45. The method according to Supplement 43, wherein the method further includes:
the terminal equipment receives SPS configuration including a second configuration parameter used for configuring the number of repetitions;
wherein, the second configuration parameter is applied to the second downlink control information.

46. The method according to Supplement 45, wherein
that the second configuration parameter is applied to the second downlink control information includes: the second configuration parameter is applied to one or more than one SPS PDSCH in SPS PDSCH(s) corresponding to the second downlink control information.

47. The method according to Supplement 43 or 46, wherein
each SPS PDSCH corresponding to the second downlink control information is repeated according to the number of times configured by the second configuration parameter; and/or,
each valid SPS PDSCH corresponding to the second downlink control information is repeated according to the number of times configured by the second configuration parameter; and/or,
each SPS PDSCH in SPS PDSCHs corresponding to the second downlink control information and needing to be received by the terminal equipment is repeated according to the number of times configured by the second configuration parameter; and/or,
the second downlink control information only corresponds to one SPS PDSCH and the one SPS PDSCH is repeated according to the number of times configured by the second configuration parameter; and/or,
in SPS PDSCHs corresponding to the second downlink control information, the terminal equipment only receives one SPS PDSCH, and the one SPS PDSCH is repeated according to the number of times configured by the second configuration parameter.

1A. A data scheduling method, the method including:
a network device transmits first downlink control information, the first downlink control information being used to schedule PDSCHs, the number of the PDSCHs being one or more.

2A. The method according to Supplement 1A, wherein
in a case where the network device transmits more than one PDSCH in PDSCHs scheduled by first downlink control information, data carried by different PDSCHs in the more than one PDSCH are different.

3A. The method according to Supplement 1A, wherein
the first downlink control information is DCI format 1_1.

4A. The method according to Supplement 1A, wherein
the first downlink control information includes a first NDI field and/or a second NDI field; the first NDI field and the second NDI field corresponding respectively to a first one of TBs and a second one of TBs in a case where the first downlink control information includes the first NDI field and the second NDI field.

5A. The method according to Supplement 4A, wherein a value/values of the first NDI field and/or the second NDI field is/are 0 or 1.

6A. The method according to Supplement 4A, wherein the number of bits included in the first NDI field and/or the second NDI field is determined according to at least one of the following:
the maximum number of PDSCHs that can be scheduled by the first downlink control information;
the number of PDSCHs scheduled by the first downlink control information;
the number of valid PDSCHs scheduled by the first downlink control information.

7A. The method according to Supplement 4A or 6A, wherein in a case where CRC of the first downlink control information is scrambled by a CS-RNTI, the first NDI field and/or the second NDI field include(s) one bit, or the first NDI field and/or the second NDI field include(s) more than one bit;
in a case where the first NDI field and/or the second NDI field include(s) more than one bit, a sole bit is valid, or more than one bit are valid, or all bits are valid.

8A. The method according to Supplement 1A, wherein one or more than one row in a TDRA table to which the first downlink control information corresponds include(s) more than one SLIV.

9A. The method according to Supplement 8A, wherein
the first downlink control information schedules one PDSCH, and/or,
a value/values of the first NDI field and/or the second NDI field of the first downlink control information is/are 1, and/or,
the first downlink control information schedules more than one PDSCH, and/or,
the first downlink control information schedules more than one valid PDSCH, and/or,
an NDI field of the first downlink control information includes more than one bit with a value being 1, and/or,
HARQ process ID(s) corresponding to more than one PDSCH scheduled by the first downlink control information is one of one or more than one HARQ process ID for SPS configuration, and/or,
HARQ process ID(s) corresponding to one or more than one PDSCH scheduled by the first downlink control information is not one of one or more than one HARQ process ID for SPS configuration.

10A. The method according to Supplement 1A, wherein
CRC of the first downlink control information is scrambled by a CS-RNTI, and the first downlink control information only schedules one PDSCH.

11A. The method according to Supplement 1A, wherein
CRC of the first downlink control information is scrambled by a CS-RNTI, and the first downlink control information schedules more than one PDSCH,
the network device transmits one PDSCH in the more than one PDSCH scheduled by the first downlink control information; or,
the network device transmits a PDSCH whose corresponding HARQ process ID is one of one or more than one HARQ process ID for SPS configuration; or,
the network device transmits all valid PDSCHs in the more than one PDSCH scheduled by the first downlink control information; or,
the network device transmits a PDSCH with a value of a bit in a corresponding NDI field being 1; or,
the network device transmits all valid PDSCHs, and for a PDSCH with a value of a bit in the corresponding NDI field being 1, it is considered as retransmission, and for a PDSCH with a value of a bit in the corresponding NDI field being 0, it is considered as initial transmission.

12A. The method according to Supplement 11A, wherein
the one PDSCH is a first PDSCH or a last PDSCH in the more than one PDSCH, and/or
the one PDSCH is a sole valid PDSCH in the more than one PDSCH, and/or
the one PDSCH is a sole PDSCH with a value of a corresponding NDI field being 1, in the more than one PDSCH, and/or,
the one PDSCH is a sole PDSCH with a corresponding HARQ process ID being one of one or more than one HARQ process ID for SPS configuration, in the more than one PDSCH.

13A. The method according to Supplement 12A, wherein
a HARQ process ID indicated by the first downlink control information corresponds to the one PDSCH; or,
a HARQ process ID indicated by the first downlink control information corresponds to a first valid PDSCH in the more than one PDSCH, and the terminal equipment determines a HARQ process ID corresponding to the one PDSCH according to the HARQ process ID.

14A. The method according to Supplement 12A, wherein
the HARQ process ID corresponding to the one PDSCH is one of one or more than one HARQ process ID for SPS configuration.

15A. The method according to Supplement 12A, wherein
the one PDSCH is a valid PDSCH.

16A. The method according to Supplement 12A, wherein
the first PDSCH is a first PDSCH scheduled by the first downlink control information or a first valid PDSCH scheduled by the first downlink control information; and
the last PDSCH is a last PDSCH scheduled by the first downlink control information or a last valid PDSCH scheduled by the first downlink control information.

17A. The method according to Supplement 11A, wherein
a HARQ process ID corresponding to the all valid PDSCHs must be one of one or more than one HARQ process ID for SPS configuration.

18A. The method according to Supplement 11A, wherein
a PDSCH with a corresponding HARQ process ID being not one of one or more than one HARQ process ID for SPS configuration and/or a value of a bit in a corresponding NDI field being 0, is initial transmission.

19A. The method according to Supplement 11A, wherein
a HARQ process ID corresponding to a sole or at least one PDSCH in the all valid PDSCHs is one of one or more than one HARQ process ID for SPS configuration.

20A. The method according to Supplement 11A, wherein
in an NDI field, a value of a bit corresponding to a sole or at least one PDSCH in all valid PDSCHs is 1.

21A. The method according to Supplement 1A, wherein the method further includes:
the network device transmits PDSCH configuration including a first configuration parameter used for configuring the number of repetitions;
wherein, CRC of the first downlink control information is scrambled by a CS-RNTI, and the first configuration parameter is applied to the first downlink control information.

22A. The method according to Supplement 21A, wherein that the first configuration parameter is applied to the first downlink control information includes: the first configuration parameter is applied to one or more than one PDSCH in PDSCH(s) scheduled by the first downlink control information.

23A. The method according to Supplement 21A or 22A, wherein
each PDSCH scheduled by the first downlink control information is repeated according to the number of times configured by the first configuration parameter; and/or,
each valid PDSCH scheduled by the first downlink control information is repeated according to the number of times configured by the first configuration parameter; and/or,
each PDSCH in PDSCHs scheduled by the first downlink control information and needing to be received by the terminal equipment is repeated according to the number of times configured by the first configuration parameter; and/or,
the first downlink control information only schedules one PDSCH and the one PDSCH is repeated according to the number of times configured by the first configuration parameter; and/or,
in PDSCHs scheduled by the first downlink control information, the terminal equipment only receives one PDSCH, and the one PDSCH is repeated according to the number of times configured by the first configuration parameter.

24A. The method according to Supplement 1A, wherein the method further includes:
the network device transmits PDSCH configuration including a first configuration parameter used for configuring the number of repetitions;
wherein, CRC of the first downlink control information is scrambled by a CS-RNTI, and the first configuration parameter is not applied to the first downlink control information.

25A. The method according to Supplement 24A, wherein
that the first configuration parameter is not applied to the first downlink control information includes: the first configuration parameter is not applied to any one of PDSCHs scheduled by the first downlink control information.

26A. The method according to Supplement 24A, wherein the method further includes:
the network device transmits SPS configuration including a second configuration parameter used for configuring the number of repetitions;
wherein, the second configuration parameter is applied to the first downlink control information.

27A. The method according to Supplement 26A, wherein that the second configuration parameter is applied to the first downlink control information includes: the second configuration parameter is applied to one or more than one PDSCH in PDSCH(s) scheduled by the first downlink control information.

28A. The method according to Supplement 26A or 27A, wherein
each PDSCH scheduled by the first downlink control information is repeated according to the number of times configured by the second configuration parameter; and/or,
each valid PDSCH scheduled by the first downlink control information is repeated according to the number of times configured by the second configuration parameter; and/or,
each PDSCH in PDSCHs scheduled by the first downlink control information and needing to be received by the terminal equipment is repeated according to the number of times configured by the second configuration parameter; and/or,
the first downlink control information only schedules one PDSCH and the one PDSCH is repeated according to the number of times configured by the second configuration parameter; and/or,
in PDSCHs scheduled by the first downlink control information, the terminal equipment only receives one PDSCH, and the one PDSCH is repeated according to the number of times configured by the second configuration parameter.

29A. The method according to Supplement 1A, wherein the method further includes:
the network device transmits PDSCH configuration including a first configuration parameter used for configuring the number of repetitions; and
the network device transmits second downlink control information for activating SPS configuration, the first configuration parameter being applied to the second downlink control information, and one or more than one row in a TDRA table to which the second downlink control information corresponds including more than one SLIV.

30A. The method according to Supplement 29A, wherein that the first configuration parameter is applied to the second downlink control information includes: a SPS PDSCH corresponding to the second downlink control information is repeated according to the first configuration parameter.

31A. The method according to Supplement 1A, wherein the method further includes:
the network device transmits PDSCH configuration including a first configuration parameter used for configuring the number of repetitions; and
the network device transmits second downlink control information for activating SPS configuration, the first configuration parameter being not applied to the second downlink control information, and one or more than one row in a TDRA table to which the second downlink control information corresponds including more than one SLIV.

32A. The method according to Supplement 31A, wherein
that the first configuration parameter is not applied to the second downlink control information includes: the first configuration parameter is not applied to any one of SPS PDSCHs corresponding to the second downlink control information.

33A. The method according to Supplement 31A, wherein the method further includes:
the network device transmits SPS configuration including a second configuration parameter used for configuring the number of repetitions;
wherein, the second configuration parameter is applied to the second downlink control information.

34A. The method according to Supplement 33A, wherein
that the second configuration parameter is applied to the second downlink control information includes: the second configuration parameter is applied to one or more than one SPS PDSCH in SPS PDSCH(s) corresponding to the second downlink control information.

35A. The method according to Supplement 31A or 34A, wherein
each SPS PDSCH corresponding to the second downlink control information is repeated according to the number of times configured by the second configuration parameter; and/or,
each valid SPS PDSCH corresponding to the second downlink control information is repeated according to the number of times configured by the second configuration parameter; and/or,
each SPS PDSCH in SPS PDSCHs corresponding to the second downlink control information and needing to be received by the terminal equipment is repeated according to the number of times configured by the second configuration parameter; and/or,
the second downlink control information only corresponds to one SPS PDSCH and the one SPS PDSCH is repeated according to the number of times configured by the second configuration parameter; and/or,
in SPS PDSCHs corresponding to the second downlink control information, the terminal equipment only receives one SPS PDSCH, and the one SPS PDSCH is repeated according to the number of times configured by the second configuration parameter.

36A. A data scheduling method, wherein the method includes:
a network device transmits PDSCH configuration including a first configuration parameter used for configuring the number of repetitions; and
the network device transmits second downlink control information for activating SPS configuration, the first configuration parameter being applied to the second downlink control information, and one or more than one row in a TDRA table to which the second downlink control information corresponds including more than one SLIV.

37A. The method according to Supplement 36A, wherein that the first configuration parameter is applied to the second downlink control information includes: a SPS PDSCH corresponding to the second downlink control information is repeated according to the first configuration parameter.

38A. A data scheduling method, wherein the method includes:
a network device transmits PDSCH configuration including a first configuration parameter used for configuring the number of repetitions; and
the network device transmits second downlink control information for activating SPS configuration, the first configuration parameter being not applied to the second downlink control information, and one or more than one row in a TDRA table to which the second downlink control information corresponds including more than one SLIV.

39A. The method according to Supplement 38A, wherein
that the first configuration parameter is not applied to the second downlink control information includes: the first configuration parameter is not applied to any one of SPS PDSCHs corresponding to the second downlink control information.

40A. The method according to Supplement 38A, wherein the method further includes:
the network device transmits SPS configuration including a second configuration parameter used for configuring the number of repetitions;
wherein, the second configuration parameter is applied to the second downlink control information.

41A. The method according to Supplement 40A, wherein
that the second configuration parameter is applied to the second downlink control information includes: the second configuration parameter is applied to one or more than one SPS PDSCH in SPS PDSCH(s) corresponding to the second downlink control information.

42A. The method according to Supplement 38A or 41A, wherein
each SPS PDSCH corresponding to the second downlink control information is repeated according to the number of times configured by the second configuration parameter; and/or,
each valid SPS PDSCH corresponding to the second downlink control information is repeated according to the number of times configured by the second configuration parameter; and/or,
each SPS PDSCH in SPS PDSCHs corresponding to the second downlink control information and needing to be received by the terminal equipment is repeated according to the number of times configured by the second configuration parameter; and/or,
the second downlink control information only corresponds to one SPS PDSCH and the one SPS PDSCH is repeated according to the number of times configured by the second configuration parameter; and/or,
in SPS PDSCHs corresponding to the second downlink control information, the terminal equipment only receives one SPS PDSCH, and the one SPS PDSCH is repeated according to the number of times configured by the second configuration parameter.

1C. A data transmitting method, the method including:
a terminal equipment receives third downlink control information, the third downlink control information being used to schedule PUSCHs; and
the terminal equipment transmits one or more than one PUSCH in the PUSCHs scheduled by the third downlink control information.

2C. The method according to Supplement 1C, wherein in a case where the terminal equipment transmits more than one PUSCH in PUSCHs scheduled by the third downlink control information, data carried by different PUSCHs in the more than one PUSCH are different.

3C. The method according to Supplement 1C, wherein the third downlink control information is DCI format 0_1.

4C. The method according to Supplement 1C, wherein the third downlink control information includes a first NDI field and/or a second NDI field; the first NDI field and the second NDI field corresponding respectively to a first one of TBs and a second one of TBs in a case where the third downlink control information includes the first NDI field and the second NDI field.

5C. The method according to Supplement 4C, wherein a value/values of the first NDI field and/or the second NDI field is/are 0 or 1.

6C. The method according to Supplement 4C, wherein the number of bits included in the first NDI field and/or the second NDI field is determined according to at least one of the following:
the maximum number of PUSCHs that can be scheduled by the third downlink control information;
the number of PUSCHs scheduled by the third downlink control information;
the number of valid PUSCHs scheduled by the third downlink control information.

7C. The method according to Supplement 4C or 6C, wherein in a case where CRC of the third downlink control information is scrambled by a CS-RNTI, the first NDI field and/or the second NDI field include(s) one bit, or the first NDI field and/or the second NDI field include(s) more than one bit;
in a case where the first NDI field and/or the second NDI field include(s) more than one bit, a sole bit is valid, or more than one bit are valid, or all bits are valid.

8C. The method according to Supplement 1C, wherein one or more than one row in a TDRA table to which the third downlink control information corresponds include(s) more than one SLIV.

9C. The method according to Supplement 8C, wherein
the terminal equipment does not expect that CRC of the third downlink control information is scrambled by a CS-RNTI, and/or,
a value/values of the first NDI field and/or the second NDI field of the third downlink control information is/are 1, and/or,
the third downlink control information schedules more than one PUSCH, and/or,
the third downlink control information schedules more than one valid PUSCH, and/or,
an NDI field of the third downlink control information includes more than one bit with a value being 1, and/or,
HARQ process ID(s) corresponding to more than one PUSCH scheduled by the third downlink control information is one of one or more than one HARQ process ID for CG configuration, and/or,
HARQ process ID(s) corresponding to one or more than one PUSCH scheduled by the third downlink control information is not one of one or more than one HARQ process ID for CG configuration.

10C. The method according to any one of Supplements 1C to 9C, wherein
CRC of the third downlink control information is scrambled by a CS-RNTI, the third downlink control information only schedules one PUSCH, and the terminal equipment transmits the one PUSCH.

11C. The method according to any one of Supplements 1C to 9C, wherein
CRC of the third downlink control information is scrambled by a CS-RNTI, and the third downlink control information schedules more than one PUSCH.

12C. The method according to Supplement 11C, wherein the terminal equipment determines whether to transmit PUSCH(s) in the more than one PUSCH scheduled by the third downlink control information according to at least one of the following:
a HARQ process ID to which the PUSCH corresponds;
a value of a bit to which the PUSCH corresponds in an NDI field;
whether the PUSCH collides with a semi-statically configured downlink symbol;
whether the PUSCH collides with an SSB; and
whether the PUSCH collides with CORESET #0.

13C. The method according to Supplement 11C, wherein
the terminal equipment only transmits one PUSCH in the more than one PUSCH.

14C. The method according to Supplement 13C, wherein
the one PUSCH is a first PUSCH or a last PUSCH in the more than one PUSCH, and/or
the one PUSCH is a sole valid PUSCH in the more than one PUSCH, and/or
the one PUSCH is a sole PUSCH with a value of a corresponding NDI field being 1, in the more than one PUSCH, and/or,
the one PUSCH is a sole PUSCH with a corresponding HARQ process ID being one of one or more than one HARQ process ID for CG configuration, in the more than one PUSCH.

15C. The method according to Supplement 14C, wherein
a HARQ process ID indicated by the third downlink control information corresponds to the one PUSCH; or,
a HARQ process ID indicated by the third downlink control information corresponds to a first valid PUSCH in the more than one PUSCH, and the terminal equipment determines a HARQ process ID corresponding to the one PUSCH according to the HARQ process ID.

16C. The method according to Supplement 14C, wherein
the HARQ process ID corresponding to the one PUSCH is one of one or more than one HARQ process ID for CG configuration.

17C. The method according to Supplement 14C, wherein
the one PUSCH is a valid PUSCH.

18C. The method according to Supplement 14C, wherein
the first PUSCH is a first PUSCH scheduled by the third downlink control information or a first valid PUSCH scheduled by the third downlink control information;
the last PUSCH is a last PUSCH scheduled by the third downlink control information or a last valid PUSCH scheduled by the third downlink control information.

19C. The method according to Supplement 11C, wherein
the terminal equipment only transmits a PUSCH whose corresponding HARQ process ID is one of one or more than one HARQ process ID for CG configuration.

20C. The method according to Supplement 11C, wherein
the terminal equipment transmits all valid PUSCHs in the more than one PUSCH.

21C. The method according to Supplement 20C, wherein a HARQ process ID corresponding to the all valid PUSCHs must be one of one or more than one HARQ process ID for CG configuration.

22C. The method according to Supplement 20C, wherein
a PUSCH with a corresponding HARQ process ID being not one of one or more than one HARQ process ID for CG configuration and/or a value of a bit in a corresponding NDI field being 0, is initial transmission.

23C. The method according to Supplement 20C, wherein
a HARQ process ID corresponding to a sole or at least one PUSCH in the all valid PUSCHs is one of one or more than one HARQ process ID for CG configuration.

24C. The method according to Supplement 11C, wherein
the terminal equipment only transmits a PUSCH with a value of a bit in a corresponding NDI field being 1; or,
the terminal equipment transmits all valid PUSCHs, and for the PUSCH with a value of a bit in the corresponding NDI field being 1, it is considered as retransmission, and for a PUSCH with a value of a bit in the corresponding NDI field being 0, it is considered as initial transmission.

25C. The method according to Supplement 24C, wherein in an NDI field, a value of a bit corresponding to a sole or at least one PUSCH in all valid PUSCHs is 1.

26C. The method according to Supplement 1C, wherein the method further includes:
the terminal equipment receives PUSCH configuration including a third configuration parameter used for configuring the number of repetitions;
wherein, CRC of the third downlink control information is scrambled by a CS-RNTI, and the third configuration parameter is applied to the third downlink control information.

27C. The method according to Supplement 26C, wherein that the third configuration parameter is applied to the third downlink control information includes: the third configuration parameter is applied to one or more than one PUSCH in the PUSCH(s) scheduled by the third downlink control information.

28C. The method according to Supplement 26C or 27C, wherein
each PUSCH scheduled by the third downlink control information is repeated according to the number of times configured by the third configuration parameter; and/or,
each valid PUSCH scheduled by the third downlink control information is repeated according to the number of times configured by the third configuration parameter; and/or,
each PUSCH in PUSCHs scheduled by the third downlink control information and needing to be transmitted by the terminal equipment is repeated according to the number of times configured by the third configuration parameter; and/or,
the third downlink control information only schedules one PUSCH and the one PUSCH is repeated according to the number of times configured by the third configuration parameter; and/or,
in PUSCHs scheduled by the third downlink control information, the terminal equipment only transmits one PUSCH, and the one PUSCH is repeated according to the number of times configured by the third configuration parameter.

29C. The method according to Supplement 1C, wherein the method further includes:
the terminal equipment receives PUSCH configuration including a third configuration parameter used for configuring the number of repetitions;
wherein, CRC of the third downlink control information is scrambled by a CS-RNTI, and the third configuration parameter is not applied to the third downlink control information.

30C. The method according to Supplement 29C, wherein
that the third configuration parameter is not applied to the third downlink control information includes: the third configuration parameter is not applied to any one of PUSCHs scheduled by the third downlink control information.

31C. The method according to Supplement 29C, wherein the method further includes:
the terminal equipment receives CG configuration including a fourth configuration parameter used for configuring the number of repetitions;
wherein, the fourth configuration parameter is applied to the third downlink control information.

32C. The method according to Supplement 31C, wherein that the fourth configuration parameter is applied to the third downlink control information includes: the fourth configuration parameter is applied to one or more than one PUSCH in PUSCH(s) scheduled by the third downlink control information.

33C. The method according to Supplement 31C or 32C, wherein
each PUSCH scheduled by the third downlink control information is repeated according to the number of times configured by the fourth configuration parameter; and/or,
each valid PUSCH scheduled by the third downlink control information is repeated according to the number of times configured by the fourth configuration parameter; and/or,
each PUSCH in PUSCHs scheduled by the third downlink control information and needing to be transmitted by the terminal equipment is repeated according to the number of times configured by the fourth configuration parameter; and/or,
the third downlink control information only schedules one PUSCH and the one PUSCH is repeated according to the number of times configured by the fourth configuration parameter; and/or,
in PUSCHs scheduled by the third downlink control information, the terminal equipment only transmits one PUSCH, and the one PUSCH is repeated according to the number of times configured by the fourth configuration parameter.

34C. The method according to Supplement 1C, wherein the method further includes:
the terminal equipment receives PUSCH configuration including a third configuration parameter used for configuring the number of repetitions; and
the terminal equipment receives fourth downlink control information used for activating CG configuration,
wherein, the third configuration parameter is applied to the fourth downlink control information, and one or more than one row in a TDRA table to which the fourth downlink control information corresponds includes more than one SLIV.

35C. The method according to Supplement 34C, wherein that the third configuration parameter is applied to the fourth downlink control information includes that:
a CG PUSCH to which the fourth downlink control information corresponds is repeated according to the third configuration parameter.

36C. The method according to Supplement 1C, wherein the method further includes:
the terminal equipment receives PUSCH configuration including a third configuration parameter used for configuring the number of repetitions; and
the terminal equipment receives fourth downlink control information used for activating CG configuration;
wherein, the third configuration parameter is not applied to the fourth downlink control information, and one or more rows in a TDRA table to which the fourth downlink control information corresponds includes more than one SLIV.

37C. The method according to Supplement 36C, wherein
that the third configuration parameter is not applied to the fourth downlink control information includes:
the third configuration parameter is not applied to any one of CG PUSCHs corresponding to the fourth downlink control information.

38C. The method according to Supplement 36C, wherein the method further includes:
the terminal equipment receives CG configuration including a fourth configuration parameter used for configuring the number of repetitions;
wherein, the fourth configuration parameter is applied to the fourth downlink control information.

39C. The method according to Supplement 38C, wherein
that the fourth configuration parameter is applied to the fourth downlink control information includes: the fourth configuration parameter is applied to one or more than one CG PUSCH in CG PUSCH(s) corresponding to the fourth downlink control information.

40C. The method according to Supplement 36C or 39C, wherein
each CG PUSCH corresponding to the fourth downlink control information is repeated according to the number of times configured by the fourth configuration parameter; and/or,
each valid CG PUSCH corresponding to the fourth downlink control information is repeated according to the number of times configured by the fourth configuration parameter; and/or,
each CG PUSCH in CG PUSCHs corresponding to the fourth downlink control information and needing to be transmitted by the terminal equipment is repeated according to the number of times configured by the fourth configuration parameter; and/or,
the fourth downlink control information only corresponds to one CG PUSCH and the one CG PUSCH is repeated according to the number of times configured by the fourth configuration parameter; and/or,
in CG PUSCHS corresponding to the fourth downlink control information, the terminal equipment only transmits one CG PUSCH, and the one CG PUSCH is repeated according to the number of times configured by the fourth configuration parameter.

41C. A data scheduling method, wherein the method includes:
a terminal equipment receives PUSCH configuration including a third configuration parameter used for configuring the number of repetitions; and
the terminal equipment receives fourth downlink control information used for activating CG configuration,
wherein, the third configuration parameter is applied to the fourth downlink control information, and one or more than one row in a TDRA table to which the fourth downlink control information corresponds includes more than one SLIV.

42C. The method according to Supplement 41C, wherein that the third configuration parameter is applied to the fourth downlink control information includes that:
a CG PUSCH to which the fourth downlink control information corresponds is repeated according to the third configuration parameter.

43C. A data scheduling method, wherein the method includes:
a terminal equipment receives PUSCH configuration including a third configuration parameter used for configuring the number of repetitions; and
the terminal equipment receives fourth downlink control information used for activating CG configuration;
wherein, the third configuration parameter is not applied to the fourth downlink control information, and one or more rows in a TDRA table to which the fourth downlink control information corresponds includes more than one SLIV.

44C. The method according to Supplement 43C, wherein
that the third configuration parameter is not applied to the fourth downlink control information includes:
the third configuration parameter is not applied to any one of CG PUSCHs corresponding to the fourth downlink control information.

45C. The method according to Supplement 43C, wherein the method further includes:
the terminal equipment receives CG configuration including a fourth configuration parameter used for configuring the number of repetitions;
wherein, the fourth configuration parameter is applied to the fourth downlink control information.

46C. The method according to Supplement 45C, wherein
that the fourth configuration parameter is applied to the fourth downlink control information includes: the fourth configuration parameter is applied to one or more than one CG PUSCH in CG PUSCH(s) corresponding to the fourth downlink control information.

47C. The method according to Supplement 43C or 46C, wherein
each CG PUSCH corresponding to the fourth downlink control information is repeated according to the number of times configured by the fourth configuration parameter; and/or,
each valid CG PUSCH corresponding to the fourth downlink control information is repeated according to the number of times configured by the fourth configuration parameter; and/or,
each CG PUSCH in CG PUSCHs corresponding to the fourth downlink control information and needing to be transmitted by the terminal equipment is repeated according to the number of times configured by the fourth configuration parameter; and/or,
the fourth downlink control information only corresponds to one CG PUSCH and the one CG PUSCH is repeated according to the number of times configured by the fourth configuration parameter; and/or,
in CG PUSCHS corresponding to the fourth downlink control information, the terminal equipment only transmits one CG PUSCH, and the one CG PUSCH is repeated according to the number of times configured by the fourth configuration parameter.

1D. A data scheduling method, the method including:
a network device transmits third downlink control information, the third downlink control information being used to schedule PUSCHs, the number of the PUSCHs being one or more.

2D. The method according to Supplement 1D, wherein
in a case where the network device receives more than one PUSCH in PUSCHs scheduled by third downlink control information, data carried by different PUSCHs in the more than one PUSCH are different.

3D. The method according to Supplement 1D, wherein
the third downlink control information is DCI format 0_1.

4D. The method according to Supplement 1D, wherein
the third downlink control information includes a first NDI field and/or a second NDI field; the first NDI field and the second NDI field corresponding respectively to a first one of TBs and a second one of TBs in a case where the third downlink control information includes the first NDI field and the second NDI field.

5D. The method according to Supplement 4D, wherein a value/values of the first NDI field and/or the second NDI field is/are 0 or 1.

6D. The method according to Supplement 4D, wherein the number of bits included in the first NDI field and/or the second NDI field is determined according to at least one of the following:
the maximum number of PUSCHs that can be scheduled by the third downlink control information;
the number of PUSCHs scheduled by the third downlink control information;
the number of valid PUSCHs scheduled by the third downlink control information.

7D. The method according to Supplement 4D or 6D, wherein in a case where CRC of the third downlink control information is scrambled by a CS-RNTI, the first NDI field and/or the second NDI field include(s) one bit, or the first NDI field and/or the second NDI field include(s) more than one bit;
in a case where the first NDI field and/or the second NDI field include(s) more than one bit, a sole bit is valid, or more than one bit are valid, or all bits are valid.

8D. The method according to Supplement 1D, wherein one or more than one row in a TDRA table to which the third downlink control information corresponds include(s) more than one SLIV.

9D. The method according to Supplement 8D, wherein
the third downlink control information schedules one PUSCH, and/or,
a value/values of the first NDI field and/or the second NDI field of the third downlink control information is/are 1, and/or,
the third downlink control information schedules more than one PUSCH, and/or,
the third downlink control information schedules more than one valid PUSCH, and/or,
an NDI field of the third downlink control information includes more than one bit with a value being 1, and/or,
HARQ process ID(s) corresponding to more than one PUSCH scheduled by the third downlink control information is one of one or more than one HARQ process ID for CG configuration, and/or,
HARQ process ID(s) corresponding to one or more than one PUSCH scheduled by the third downlink control information is not one of one or more than one HARQ process ID for CG configuration.

10D. The method according to Supplement 1D, wherein
CRC of the third downlink control information is scrambled by a CS-RNTI, and the third downlink control information only schedules one PUSCH.

11D. The method according to Supplement 1D, wherein
CRC of the third downlink control information is scrambled by a CS-RNTI, and the third downlink control information schedules more than one PUSCH,
the network device receives one PUSCH in the more than one PUSCH scheduled by the third downlink control information; or,
the network device receives a PUSCH whose corresponding HARQ process ID is one of one or more than one HARQ process ID for CG configuration; or,
the network device receives all valid PUSCHs in the more than one PUSCH scheduled by the third downlink control information; or,
the network device receives a PUSCH with a value of a bit in a corresponding NDI field being 1; or,
the network device receives all valid PUSCHs, and for the PUSCH with a value of a bit in the corresponding NDI field being 1, it is considered as retransmission, and for a PUSCH with a value of a bit in the corresponding NDI field being 0, it is considered as initial transmission.

12D. The method according to Supplement 11D, wherein
the one PUSCH is a first PUSCH or a last PUSCH in the more than one PUSCH, and/or
the one PUSCH is a sole valid PUSCH in the more than one PUSCH, and/or
the one PUSCH is a sole PUSCH with a value of a corresponding NDI field being 1, in the more than one PUSCH, and/or,
the one PUSCH is a sole PUSCH with a corresponding HARQ process ID being one of one or more than one HARQ process ID for CG configuration, in the more than one PUSCH.

13D. The method according to Supplement 12D, wherein
a HARQ process ID indicated by the third downlink control information corresponds to the one PUSCH; or,
a HARQ process ID indicated by the third downlink control information corresponds to a first valid PUSCH in the more than one PUSCH, and the terminal equipment determines a HARQ process ID corresponding to the one PUSCH according to the HARQ process ID.

14D. The method according to Supplement 12D, wherein
the HARQ process ID corresponding to the one PUSCH is one of one or more than one HARQ process ID for CG configuration.

15D. The method according to Supplement 12D, wherein
the one PUSCH is a valid PUSCH.

16D. The method according to Supplement 12D, wherein
the first PUSCH is a first PUSCH scheduled by the third downlink control information or a first valid PUSCH scheduled by the third downlink control information;
the last PUSCH is a last PUSCH scheduled by the third downlink control information or a last valid PUSCH scheduled by the third downlink control information.

17D. The method according to Supplement 11D, wherein
a HARQ process ID corresponding to the all valid PUSCHs must be one of one or more than one HARQ process ID for CG configuration.

18D. The method according to Supplement 11D, wherein
a PUSCH with a corresponding HARQ process ID being not one of one or more than one HARQ process ID for CG configuration and/or a value of a bit in a corresponding NDI field being 0, is initial transmission.

19D. The method according to Supplement 11D, wherein
a HARQ process ID corresponding to a sole or at least one PUSCH in the all valid PUSCHs is one of one or more than one HARQ process ID for CG configuration.

20D. The method according to Supplement 11D, wherein
in an NDI field, a value of a bit corresponding to a sole or at least one PUSCH in all valid PUSCHs is 1.

21D. The method according to Supplement 1D, wherein the method further includes:
the network device transmits PUSCH configuration including a third configuration parameter used for configuring the number of repetitions;
wherein, CRC of the third downlink control information is scrambled by a CS-RNTI, and the third configuration parameter is applied to the third downlink control information.

22D. The method according to Supplement 21D, wherein that the third configuration parameter is applied to the third downlink control information includes: the third configuration parameter is applied to one or more than one PUSCH in PUSCH(s) scheduled by the third downlink control information.

23D. The method according to Supplement 21D or 22D, wherein
each PUSCH scheduled by the third downlink control information is repeated according to the number of times configured by the third configuration parameter; and/or,
each valid PUSCH scheduled by the third downlink control information is repeated according to the number of times configured by the third configuration parameter; and/or,
each PUSCH in PUSCHs scheduled by the third downlink control information and needing to be transmitted by the terminal equipment is repeated according to the number of times configured by the third configuration parameter; and/or,
the third downlink control information only schedules one PUSCH and the one PUSCH is repeated according to the number of times configured by the third configuration parameter; and/or,
in PUSCHs scheduled by the third downlink control information, the terminal equipment only transmits one PUSCH, and the one PUSCH is repeated according to the number of times configured by the third configuration parameter.

24D. The method according to Supplement 1D, wherein the method further includes:
the network device transmits PUSCH configuration including a third configuration parameter used for configuring the number of repetitions;
wherein, CRC of the third downlink control information is scrambled by a CS-RNTI, and the third configuration parameter is not applied to the third downlink control information.

25D. The method according to Supplement 24D, wherein
that the third configuration parameter is not applied to the third downlink control information includes: the third configuration parameter is not applied to any one of PUSCHs scheduled by the third downlink control information.

26D. The method according to Supplement 24D, wherein the method further includes:
the network device transmits CG configuration including a fourth configuration parameter used for configuring the number of repetitions;
wherein, the fourth configuration parameter is applied to the third downlink control information.

27D. The method according to Supplement 26D, wherein that the fourth configuration parameter is applied to the third downlink control information includes: the fourth configuration parameter is applied to one or more than one PUSCH in PUSCH(s) scheduled by the third downlink control information.

28D. The method according to Supplement 26D or 27D, wherein
each PUSCH scheduled by the third downlink control information is repeated according to the number of times configured by the fourth configuration parameter; and/or,
each valid PUSCH scheduled by the third downlink control information is repeated according to the number of times configured by the fourth configuration parameter; and/or,
each PUSCH in PUSCHs scheduled by the third downlink control information and needing to be transmitted by the terminal equipment is repeated according to the number of times configured by the fourth configuration parameter; and/or,
the third downlink control information only schedules one PUSCH and the one PUSCH is repeated according to the number of times configured by the fourth configuration parameter; and/or,
in PUSCHs scheduled by the third downlink control information, the terminal equipment only transmits one PUSCH, and the one PUSCH is repeated according to the number of times configured by the fourth configuration parameter.

29D. The method according to Supplement 1D, wherein the method further includes:
the network device transmits PUSCH configuration including a third configuration parameter used for configuring the number of repetitions; and
the network device transmits fourth downlink control information for activating CG configuration, the third configuration parameter being applied to the fourth downlink control information, and one or more than one row in a TDRA table to which the fourth downlink control information corresponds including more than one SLIV.

30D. The method according to Supplement 29D, wherein that the third configuration parameter is applied to the fourth downlink control information includes: a CG PUSCH corresponding to the fourth downlink control information is repeated according to the third configuration parameter.

31D. The method according to Supplement 1D, wherein the method further includes:
the network device transmits PUSCH configuration including a third configuration parameter used for configuring the number of repetitions; and
the network device transmits fourth downlink control information for activating CG configuration, the third configuration parameter being not applied to the fourth downlink control information, and one or more than one row in a TDRA table to which the fourth downlink control information corresponds including more than one SLIV.

32D. The method according to Supplement 31D, wherein
that the third configuration parameter is not applied to the fourth downlink control information includes: the third configuration parameter is not applied to any one of CG PUSCHs corresponding to the fourth downlink control information.

33D. The method according to Supplement 31D, wherein the method further includes:
the network device transmits CG configuration including a fourth configuration parameter used for configuring the number of repetitions;
wherein, the fourth configuration parameter is applied to the fourth downlink control information.

34D. The method according to Supplement 33D, wherein
that the fourth configuration parameter is applied to the fourth downlink control information includes: the fourth configuration parameter is applied to one or more than one CG PUSCH in CG PUSCH(s) corresponding to the fourth downlink control information.

35D. The method according to Supplement 31D or 34D, wherein
each CG PUSCH corresponding to the fourth downlink control information is repeated according to the number of times configured by the fourth configuration parameter; and/or,
each valid CG PUSCH corresponding to the fourth downlink control information is repeated according to the number of times configured by the fourth configuration parameter; and/or,
each CG PUSCH in CG PUSCHs corresponding to the fourth downlink control information and needing to be transmitted by the terminal equipment is repeated according to the number of times configured by the fourth configuration parameter; and/or,
the fourth downlink control information only corresponds to one CG PUSCH and the one CG PUSCH is repeated according to the number of times configured by the fourth configuration parameter; and/or,
in CG PUSCHS corresponding to the fourth downlink control information, the terminal equipment only transmits one CG PUSCH, and the one CG PUSCH is repeated according to the number of times configured by the fourth configuration parameter.

36D. A data scheduling method, wherein the method includes:
a network device transmits PUSCH configuration including a third configuration parameter used for configuring the number of repetitions; and
the network device transmits fourth downlink control information for activating CG configuration, the third configuration parameter being applied to the fourth downlink control information, and one or more than one row in a TDRA table to which the fourth downlink control information corresponds including more than one SLIV.

37D. The method according to Supplement 36D, wherein that the third configuration parameter is applied to the fourth downlink control information includes: a CG PUSCH corresponding to the fourth downlink control information is repeated according to the third configuration parameter.

38D. A data scheduling method, wherein the method includes:
a network device transmits PUSCH configuration including a third configuration parameter used for configuring the number of repetitions; and
the network device transmits fourth downlink control information for activating CG configuration, the third configuration parameter being not applied to the fourth downlink control information, and one or more than one row in a TDRA table to which the fourth downlink control information corresponds including more than one SLIV.

39D. The method according to Supplement 38D, wherein
that the third configuration parameter is not applied to the fourth downlink control information includes: the third configuration parameter is not applied to any one of CG PUSCHs corresponding to the fourth downlink control information.

40D. The method according to Supplement 38D, wherein the method further includes:
the network device transmits CG configuration including a fourth configuration parameter used for configuring the number of repetitions;
wherein, the fourth configuration parameter is applied to the fourth downlink control information.

41D. The method according to Supplement 40D, wherein
that the fourth configuration parameter is applied to the fourth downlink control information includes: the fourth configuration parameter is applied to one or more than one CG PUSCH in CG PUSCH(s) corresponding to the fourth downlink control information.

42D. The method according to Supplement 38D or 41D, wherein
each CG PUSCH corresponding to the fourth downlink control information is repeated according to the number of times configured by the fourth configuration parameter; and/or,
each valid CG PUSCH corresponding to the fourth downlink control information is repeated according to the number of times configured by the fourth configuration parameter; and/or,
each CG PUSCH in CG PUSCHs corresponding to the fourth downlink control information and needing to be transmitted by the terminal equipment is repeated according to the number of times configured by the fourth configuration parameter; and/or,
the fourth downlink control information only corresponds to one CG PUSCH and the one CG PUSCH is repeated according to the number of times configured by the fourth configuration parameter; and/or,
in CG PUSCHS corresponding to the fourth downlink control information, the terminal equipment only transmits one CG PUSCH, and the one CG PUSCH is repeated according to the number of times configured by the fourth configuration parameter.

1E. A terminal equipment, including a memory and a processor, the memory storing a computer program, and the processor being configured to execute the computer program to implement the method according to any one of Supplements 1 to 47 and 1C to 47C.

1F. A network device, including a memory and a processor, the memory storing a computer program, and the processor being configured to execute the method according to any one of Supplements 1A to 42A and 1D to 42D.

1G. A communication system, including the network device according to Supplement 1F and the terminal equipment according to Supplement 1E.

1. A data receiving and transmitting apparatus, configured in a terminal equipment, the apparatus comprising:
a first receiver configured to receive first downlink control information and/or third downlink control information, the first downlink control information being used to schedule PDSCHs (Physical downlink shared channel), the third downlink control information being used to schedule PUSCH (Physical uplink shared channel) s; and
a second receiver configured to receive one or more than one PDSCH in the PDSCHs scheduled by the first downlink control information, and/or,
a transmitter configured to transmit one or more than one PUSCH in the PUSCHs scheduled by the third downlink control information, and
a third receiver configured to receive a PDSCH configuration including a first configuration parameter used for configuring the number of repetitions and/or a SPS (Semi-persistent scheduling) configuration including a second configuration parameter used for configuring the number of repetitions, and
wherein, the first configuration parameter is not applied to the first downlink control information and/or the second configuration parameter is applied to the first downlink control information.

2. The apparatus according to claim 1, wherein the first downlink control information is DCI (Downlink control information) format 1_1, and/or, the third downlink control information is DCI format 0_1.

3. The apparatus according to claim 1, wherein the first downlink control information and/or the third downlink control information comprises a first NDI (New Data Indicator) field and/or a second NDI field, the first NDI field and the second NDI field corresponding respectively to a first one of TBs (Transport Block) and a second one of TBs in a case where the first downlink control information comprises the first NDI field and the second NDI field.

4. The apparatus according to claim 3, wherein a value/values of the first NDI field and/or the second NDI field is/are 0 or 1.

5. The apparatus according to claim 3, wherein the number of bits in the first NDI field and/or the second NDI field in the first downlink control information is determined according to the number of PDSCHs scheduled by the first downlink control information, and/or
the number of bits in the first NDI field and/or the second NDI field in the third downlink control information is determined according to the number of PUSCHs scheduled by the third downlink control information.

6. The apparatus according to claim 3, wherein, CRC (Cyclic redundancy check) of the first downlink control information is scrambled by a CS-RNTI (Configured scheduling Radio Network Temporary Identifier), and the first NDI field and/or the second NDI field in the first downlink control information includes one bit respectively, and/or,
CRC of the third downlink control information is scrambled by a CS-RNTI, and the first NDI field and/or the second NDI field in the third downlink control information includes one bit respectively.

7. The apparatus according to claim 1, wherein one or more than one row in a TDRA (Time-Domain Resource Allocation) table to which the first downlink control information corresponds include(s) more than one SLIV (Start and length indicator value), and/or one or more than one row in a TDRA table to which the third downlink control information corresponds include(s) more than one SLIV.

8. The apparatus according to claim 1, wherein,
CRC (Cyclic redundancy check) of the first downlink control information is scrambled by a CS-RNTI (Configured scheduling Radio Network Temporary Identifier), the first downlink control information only schedules one PDSCH, and the second receiver receives the one PDSCH, and/or,
CRC of the third downlink control information is scrambled by a CS-RNTI, the third downlink control information only schedules one PUSCH, and the transmitter transmits the one PUSCH.

9. The apparatus according to claim 1, wherein,
CRC (Cyclic redundancy check) of the first downlink control information is scrambled by a CS-RNTI (Configured scheduling Radio Network Temporary Identifier), and the first downlink control information schedules more than one PDSCH,
CRC of the third downlink control information is scrambled by a CS-RNTI, and the third downlink control information schedules more than one PUSCH.

10. The apparatus according to claim 1, wherein,
the second receiver determines whether to receive a PDSCH in the PDSCHs scheduled by the first downlink control information according to at least one of the following:
a HARQ process ID to which the PDSCH corresponds;
a value of a bit to which the PDSCH corresponds in an NDI (New Data Indicator) field; and
whether the PDSCH overlaps with a configured uplink symbol,
and/or,
the transmitter determines whether to transmit a PUSCH in the PUSCHs scheduled by the third downlink control information according to at least one of the following:
a HARQ (Hybrid Automatic Repeat reQuest) process ID to which the PUSCH corresponds;
a value of a bit to which the PUSCH corresponds in an NDI field; and
whether the PUSCH overlaps with a configured downlink symbol and/or a symbol of an SSB (Synchronization Signals/Physical Broadcast CHannel Block) and/or CORESET #0.

11. The apparatus according to claim 9, wherein,
the second receiver only receives one PDSCH in the more than one PDSCH, and/or,
the transmitter only transmits one PUSCH in the more than one PUSCH.

12. The apparatus according to claim 11, wherein,
the one PDSCH is a first PDSCH or a last PDSCH in the more than one PDSCH, and/or
the one PDSCH is a sole valid PDSCH in the more than one PDSCH, and/or
the one PDSCH is a sole PDSCH in the more than one PDSCH with a value of a corresponding bit in an NDI field being 1, and/or,
the one PDSCH is a sole PDSCH in the more than one PDSCH with a corresponding HARQ process ID being one of one or more than one HARQ process IDs for SPS configuration,
and/or,
the one PUSCH is a first PUSCH or a last PUSCH in the more than one PUSCH, and/or
the one PUSCH is a sole valid PUSCH in the more than one PUSCH, and/or
the one PUSCH is a sole PUSCH in the more than one PUSCH with a value of a corresponding NDI field being 1, and/or,
the one PUSCH is a sole PUSCH in the more than one PUSCH with a corresponding HARQ process ID that is one of one or more than one HARQ process IDs for CG configuration.

13. The apparatus according to claim 12, wherein,
the first PDSCH is a first PDSCH scheduled by the first downlink control information or a first valid PDSCH scheduled by the first downlink control information;
and the last PDSCH is a last PDSCH scheduled by the first downlink control information or a last valid PDSCH scheduled by the first downlink control information;
the first PUSCH is a first PUSCH scheduled by the third downlink control information or a first valid PUSCH scheduled by the third downlink control information;
and the last PUSCH is a last PUSCH scheduled by the third downlink control information or a last valid PUSCH scheduled by the third downlink control information.

14. The apparatus according to claim 9, wherein,
the second receiver receives all valid PDSCHs in the more than one PDSCH and/or,
the transmitter transmits all valid PUSCHs in the more than one PUSCH.

15. The apparatus according to claim 1, wherein,
CRC (Cyclic redundancy check) of the first downlink control information is scrambled by a CS-RNTI (Configured scheduling Radio Network Temporary Identifier), and/or, the first downlink control information is used for activating SPS (Semi-persistent scheduling) configuration or indicating retransmission of PDSCH corresponding to a SPS.

16. The apparatus according to claim 1, wherein the second configuration parameter applied to the first downlink control information comprises:
a SPS (Semi-persistent scheduling) PDSCH to which the first downlink control information corresponds and/or a PDSCH scheduled by the first downlink control information is repeated according to the second configuration parameter.

17. The apparatus according to claim 1, the apparatus further comprising:
a fourth receiver configured to:
receive a PUSCH configuration including a third configuration parameter used for configuring the number of repetitions and/or a CG (Configured Grant) configuration including a fourth configuration parameter used for configuring the number of repetitions,
wherein, the third configuration parameter is not applied to the third downlink control information and/or the fourth configuration parameter is applied to the third downlink control information.

18. The apparatus according to claim 1, wherein, CRC (Cyclic redundancy check) of the third downlink control information is scrambled by a CS-RNTI (Configured scheduling Radio Network Temporary Identifier), and/or, the third downlink control information is used for activating CG (Configured Grant) configuration or indicating retransmission of PUSCH corresponding to a CG.

19. The apparatus according to claim 17, wherein the fourth configuration parameter applied to the third downlink control information comprises:
a CG PUSCH to which the third downlink control information corresponds or a PUSCH scheduled by the third downlink control information is repeated according to the fourth configuration parameter.
